(19) United States
(12) Patent Application Publication
(10) Pub. No.: US 2024/0393753 A1
(43) Pub. Date: Nov. 28, 2024

(54) BUILDING MANAGEMENT SYSTEM WITH SUSTAINABILITY IMPROVEMENT

(71) Applicant: Tyco Fire & Security GmbH, Neuhausen am Rheinfall (CH)

(72) Inventors: James Young, Cork (IE); Gregory A. Makowski, Los Altos, CA (US); Michael J. Wenzel, Grafton, WI (US); Prashanthi Sudhakar, San Francisco, CA (US); Vineet Binodshanker Sinha, Brookfield, WI (US); Trent M. Swanson, Wellington, FL (US); Miguel Galvez, Westford, MA (US)

(21) Appl. No.: 18/673,172

(22) Filed: May 23, 2024

Related U.S. Application Data
(60) Provisional application No. 63/468,675, filed on May 24, 2023.

(51) Int. Cl. G05B 13/02; G06N 3/0895

(52) U.S. Cl. CPC G05B 13/027; G06N 3/0895

(57) ABSTRACT

Systems and methods are disclosed relating to building management systems with sustainability improvement for a building. For example, a system can include at least one machine learning model configured using training data that includes at least one of unstructured data or structured data regarding sustainability of buildings. The system can provide inputs, such as prompts, to the at least one machine learning model regarding a sustainability performance of the building, and generate, according to the inputs, responses regarding the sustainability performance of the building, such as responses for detecting factors and/or sources contributing to the sustainability performance of the building.

### CROSS-REFERENCE TO RELATED PATENT APPLICATIONS

This application claims the benefit of and priority to U.S. Provisional Patent Application No. 63/468,675, filed on May 24, 2023, the entirety of which is incorporated by reference herein.

### BACKGROUND

This application relates generally to a building system of a building. This application relates more particularly to systems for managing and processing data of the building system.

### SUMMARY

At least one embodiment is directed to a method. The method can include receiving, by one or more processors, data relating to a sustainability performance of a building. The building can include a plurality of pieces of building equipment configured to control an indoor environment of the building. The method can include generating, by the one or more processors, a plurality of recommendations for improving the sustainability performance of the building using an AI model. The plurality of recommendations can include new recommendations not preexisting prior to generation of the plurality of recommendations by the AI model. The AI model can autonomously generate at least a portion of the plurality of recommendations without manual user intervention. The method can include receiving, by the one or more processors, an indication to accept a first recommendation of the plurality of recommendations. The method can include implementing, responsive to receiving the indication to accept the first recommendation of the plurality of recommendations, by the one or more processors, one or more actions associated with the first recommendation of the plurality of recommendations.

In some embodiments, the AI model can include a generative large language model (LLM).

In some embodiments, the generative LLM can include a generative pretrained transformer model.

In some embodiments, the data can include unstructured data conforming to a plurality of different predetermined formats and/or not conforming to a predetermined format. The generative LLM can generate the plurality of recommendations from the unstructured data.

In some embodiments, the method can include generating, by the one or more processors, a natural language summary of the plurality of recommendations for presentation to a user. The generative LLM can dynamically generate the natural language summary without requiring manual user intervention.

In some embodiments, the generative LLM can dynamically generate the natural language summary based on one or more of an identity of the user, a role of the user, the plurality of pieces of building equipment, the plurality of recommendations, or other data and/or characteristics pertaining to the building and/or the plurality of pieces of building equipment.

In some embodiments, the data can include one or more of a building information model (BIM) of the building, a building specification for the building, or specifications of building materials of the building.

In some embodiments, generating the plurality of recommendations can include determining, by the one or more processors using the generative LLM, a plurality of improvements to the sustainability performance of the building that are predicted by the generative LLM to be achievable for the building based on the data.

In some embodiments, the building can include a planned building. At least one recommendation of the plurality of recommendations can provide an adjustment to a construction plan for the planned building. Implementation of the adjustment to the construction plan for the planned building can result in a sustainability improvement for the planned building.

In some embodiments, at least a portion of the building can be under construction. At least one recommendation of the plurality of recommendations can provide an adjustment to the at least a portion of the building. Implementation of the adjustment results in a sustainability improvement for the at least a portion of the building.

In some embodiments, the building can include operational data. At least one recommendation of the plurality of recommendations can provide an adjustment to at least one operation of the building included in the operational data. Implementation of the adjustment can result in a sustainability improvement for the at least one operation of the building.

In some embodiments, the method can include receiving, by the one or more processors, a plurality of first unstructured sustainability improvement recommendations corresponding to a plurality of first sustainability requests for improving sustainability performances of one or more buildings. The unstructured sustainability improvement recommendations can conform to a plurality of different predetermined formats and/or comprising unstructured data not conforming to a predetermined format. The method can include training, by the one or more processors, the generative LLM using the plurality of first unstructured sustainability improvement recommendations.

At least one embodiment relates to one or more computer-readable storage media. The one or more computer-readable storage media can store instructions thereon. The instructions can, when executed by one or more processors, cause the one or more processors to perform operations. The operations can include receiving a plurality of first unstructured sustainability improvement recommendations corresponding to a plurality of first sustainability requests for improving a sustainability performance of one or more buildings. The unstructured sustainability improvement recommendations can conform to a plurality of different predetermined formats and/or comprising unstructured data not conforming to a predetermined format. The operations can include training a generative AI model using the plurality of first unstructured sustainability improvement recommendations. The operations can include performing, using the generative AI model, one or more actions with respect to one or more sustainability requests subsequent to training the generative AI model.

In some embodiments, the operations can include receiving data relating to a sustainability request for a building. The building can include a plurality of pieces of building equipment configured to control an indoor environment of the building. The operations can include generating, using the generative AI model, a plurality of recommendations corresponding to the sustainability request. The plurality of recommendations can include new recommendations not preexisting prior to generation of the plurality of recommendations by the generative AI model. The generative AI model can autonomously generate at least a portion of the plurality of recommendations without manual user intervention. The operations can include receiving an indication to accept a first recommendation of the plurality of recommendations. The operations can include implementing, responsive to receiving the indication to accept the first recommendation of the plurality of recommendations, one or more actions associated with the first recommendation of the plurality of recommendations.

In some embodiments, the operations can include detecting, responsive to implementing the one or more actions associated with the first recommendation, a change to a carbon emission level of the building. The operations can include retraining the generative AI model based on the change to the carbon emission level of the building.

In some embodiments, the operations can include generating a natural language summary of the plurality of recommendations for presentation to a user. The generative AI model can dynamically generate the natural language summary without requiring manual user intervention.

In some embodiments, the generative AI model can dynamically generate the natural language summary based on one or more of an identity of the user, a role of the user, a plurality of pieces of building equipment, the plurality of recommendations, or other data and/or characteristics pertaining to a building and/or the plurality of pieces of building equipment.

At least one embodiment relates to a system. The system can include one or more memory devices. The one or more memory devices can store instructions thereon. The instructions can, when executed by one or more processors, cause the one or more processors to receive data relating to a sustainability performance of a building. The building can include a plurality of pieces of building equipment configured to control an indoor environment of the building. The instructions can cause the one or more processors to generate a plurality of recommendations for improving the sustainability performance of the building using an AI model. The plurality of recommendations can include recommendations not preexisting prior to generation of the plurality of recommendations by the AI model. The AI model can autonomously generate at least a portion of the plurality of recommendations without manual user intervention. The instructions can cause the one or more processors to receive an indication to accept a first recommendation of the plurality of recommendations. The instructions can cause the one or more processors to implement, responsive to receiving the indication to accept the first recommendation of the plurality of recommendations, one or more actions associated with the first recommendation of the plurality of recommendations.

In some embodiments, the AI model can include a generative large language model (LLM). The generative LLM can include a generative pretrained transformer model.

In some embodiments, the instructions can cause the one or more processors to generate a natural language summary of the plurality of recommendations for presentation to a user. The generative LLM can dynamically generate the natural language summary without requiring manual user intervention. The generative LLM can dynamically generate the natural language summary based on one or more of an identity of the user, a role of the user, the plurality of pieces of building equipment, the plurality of recommendations, or other data and/or characteristics pertaining to the building and/or the plurality of pieces of building equipment.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a heating, ventilation, and/or air conditioning (HVAC) system, according to an exemplary embodiment.

FIG. 2 is a block diagram of a building automation system (BAS) that may be used to monitor and/or control the building of FIG. 1, according to an exemplary embodiment.

FIG. 3 is a block diagram of a system for energy conservation, according to an exemplary embodiment.

FIG. 4 is a block diagram of a sustainability component of the system of FIG. 3, according to an exemplary embodiment.

FIG. 5 is a user interface displaying a setup window for facility improvement measures, according to an exemplary embodiment.

FIG. 6 is a user interface displaying an improvement measures plan dashboard, according to an exemplary embodiment.

FIG. 7 is a user interface displaying an improvement measures plan dashboard, according to an exemplary embodiment.

FIG. 8 is a user interface displaying an improvement measures plan dashboard, according to an exemplary embodiment.

FIG. 9 is a user interface displaying an energy conservation measure window, according to an exemplary embodiment.

FIG. 10 is a user interface displaying an energy conservation measure window, according to an exemplary embodiment.

FIG. 11 is a user interface displaying an energy conservation measure window, according to an exemplary embodiment.

FIG. 12 is a user interface displaying an energy conservation measure window, according to an exemplary embodiment.

FIG. 13 is a user interface displaying a description window that pertains to an energy conservation measure, according to an exemplary embodiment.

FIG. 14 is a user interface displaying a description window that pertains to an energy conservation measure, according to an exemplary embodiment.

FIG. 15 is a user interface displaying a customization window that pertains to an improvement plan, according to an exemplary embodiment.

FIG. 16 is a user interface displaying a customization window that pertains to an improvement plan, according to an exemplary embodiment.

FIG. 17 is a user interface displaying an improvement measures plan dashboard, according to an exemplary embodiment.

FIG. 18 is a user interface displaying an improvement measures plan dashboard, according to an exemplary embodiment.

FIG. 19 is a user interface displaying an improvement measures plan dashboard, according to an exemplary embodiment.

FIG. 20 is a user interface displaying an improvement measures plan dashboard, according to an exemplary embodiment.

FIG. 21 is a user interface displaying an improvement measures plan dashboard, according to an exemplary embodiment.

FIG. 22 is a user interface displaying an improvement measures plan dashboard, according to an exemplary embodiment.

FIG. 23 is a user interface displaying an improvement measures plan dashboard, according to an exemplary embodiment.

FIG. 24 is a user interface displaying an improvement measures plan dashboard, according to an exemplary embodiment.

FIG. 25 is a user interface displaying an improvement measures plan dashboard, according to an exemplary embodiment.

FIG. 26A is a user interface displaying a graphical representation of energy conservation measures tracking, according to an exemplary embodiment.

FIG. 26B is a user interface displaying a graphical representation of energy conservation measures tracking, according to an exemplary embodiment.

FIG. 27 is a user interface displaying an improvement measures plan dashboard, according to an exemplary embodiment.

FIG. 28 is a user interface displaying an improvement measures plan dashboard, according to an exemplary embodiment.

FIG. 29 is a user interface displaying an improvement measures plan dashboard, according to an exemplary embodiment.

FIG. 30 is a user interface displaying an improvement measures plan dashboard, according to an exemplary embodiment.

FIG. 31 is a user interface displaying an energy conservation window, according to an exemplary embodiment.

FIG. 32 is a user interface displaying an improvement measures plan dashboard, according to an exemplary embodiment.

FIG. 33 is a user interface displaying an improvement measures plan dashboard, according to an exemplary embodiment.

FIG. 34 is a user interface displaying an improvement measures plan dashboard, according to an exemplary embodiment.

FIG. 35 is a user interface displaying an energy conservation measure window, according to an exemplary embodiment.

FIG. 36 is a user interface displaying an energy conservation measure window, according to an exemplary embodiment.

FIG. 37 is a user interface displaying an energy conservation measure window, according to an exemplary embodiment.

FIG. 38 is a user interface displaying an energy conservation measure window, according to an exemplary embodiment.

FIG. 39 is a user interface displaying an energy conservation measure window, according to an exemplary embodiment.

FIG. 40A is a user interface displaying an energy conservation measure window, according to an exemplary embodiment.

FIG. 40B is a user interface displaying an energy conservation measure window, according to an exemplary embodiment.

FIG. 41 is a user interface displaying an energy conservation measure window, according to an exemplary embodiment.

FIG. 42 is a user interface displaying an improvement measures plan dashboard, according to an exemplary embodiment.

FIG. 43 is a user interface displaying an improvement measures plan dashboard, according to an exemplary embodiment.

FIG. 44 is a user interface displaying an improvement measures plan dashboard, according to an exemplary embodiment.

FIG. 45A is a user interface displaying a graphical representation of energy conservation measure tracking, according to an exemplary embodiment.

FIG. 45B is a user interface displaying a table including a number of energy conservation measures, according to an exemplary embodiment.

FIG. 46 is a block diagram of a process for reducing carbon emissions, according to an exemplary embodiment.

FIG. 47 is a block diagram of an example of a machine learning model-based system for building sustainability improvement applications.

FIG. 48 is a block diagram of an example of a language model-based system for building sustainability improvement applications.

FIG. 49 is a block diagram of an example of the system of FIG. 48 including user application session components.

FIG. 50 is a block diagram of an example of the system of FIG. 48 including feedback training components.

FIG. 51 is a block diagram of an example of the system of FIG. 48 including data filters.

FIG. 52 is a block diagram of an example of the system of FIG. 48 including data validation components.

FIG. 53 is a block diagram of an example of the system of FIG. 48 including expert review and intervention components.

FIG. 54 is a flow diagram of a process of implementing sustainability improvements for a building.

FIG. 55 is a flow diagram of a process of training a machine learning model for sustainability improvements of a building.

FIG. 56 is a flow chart of a process for generating sustainability improvements for a building.

### DETAILED DESCRIPTION

Referring generally to the FIGURES, systems and methods are provided for sustainability assessment and/or improvement for one or more buildings, according to various exemplary embodiments. A sustainability optimization system can be configured to collect various pieces of information regarding a building, e.g., energy supply data, on-site energy generation systems, demand data, indications of building equipment, etc. The sustainability optimization system can be configured to run an optimization on the collected data to identify improvements for the building that result in sustainable operation of the building. For example, the optimization can optimize for various metrics of the building, e.g., carbon footprint, energy usage, etc. The result of the optimization could be to retrofit certain pieces of building equipment, install on-site solar panels, obtain renewable energy credits (RECs), generate a building control plan, etc. In some implementations, the system can additionally or alternatively provide an assessment of historical, present, and/or future sustainability performance of the building, spaces of the building, occupants of the building, equipment of the building, etc., either with or without recommendations for improving the performance.

The optimization can, in some embodiments, result in building planning that causes the building to meet a sustainability goal in a particular timeline. For example, the user may have a goal for their building to reach net-zero carbon emissions (or a predefined and/or user-defined level of carbon emissions) over a certain timeframe (e.g., the next thirty years). The optimization can run periodically, e.g., every year, to optimize over an optimization period (e.g., the next five years) and to meet the goal over the total planning period (e.g., the next thirty years). In some embodiments, the optimization can additionally or alternatively be run on request/demand of a user, upon the occurrence of certain events/targets, etc.

In some embodiments, the optimization described herein can be based on, and/or can utilize, the techniques described in U.S. patent application Ser. No. 16/518,314 filed Jul. 22, 2019, the entirety of which is incorporated by reference herein.

### Building Management System and HVAC System

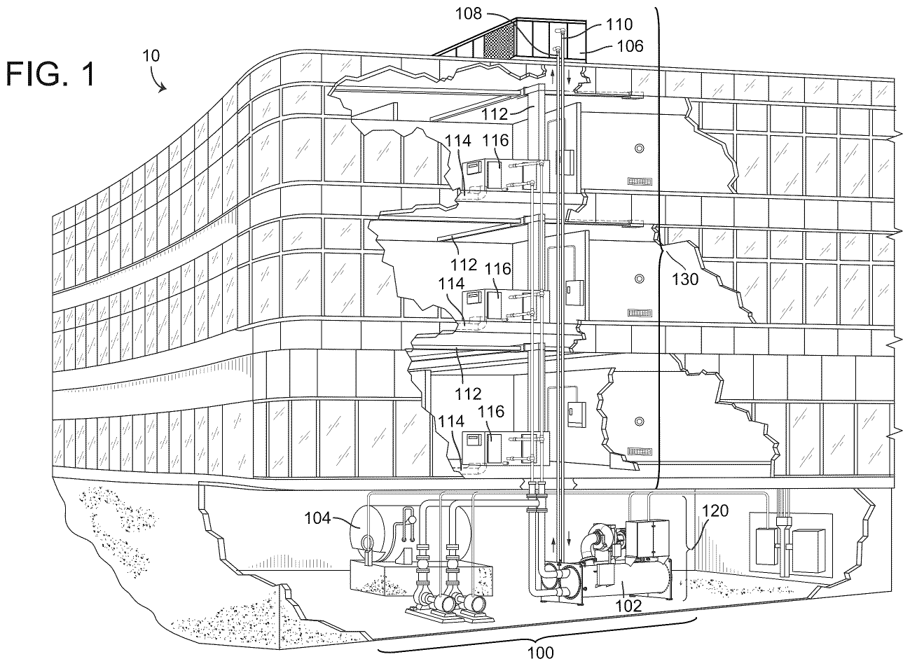

Referring now to FIG. 1, an exemplary building management system (BMS) and HVAC system in which the systems and methods of the present invention can be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, and/or any other system that is capable of managing building functions or devices, or any combination thereof.

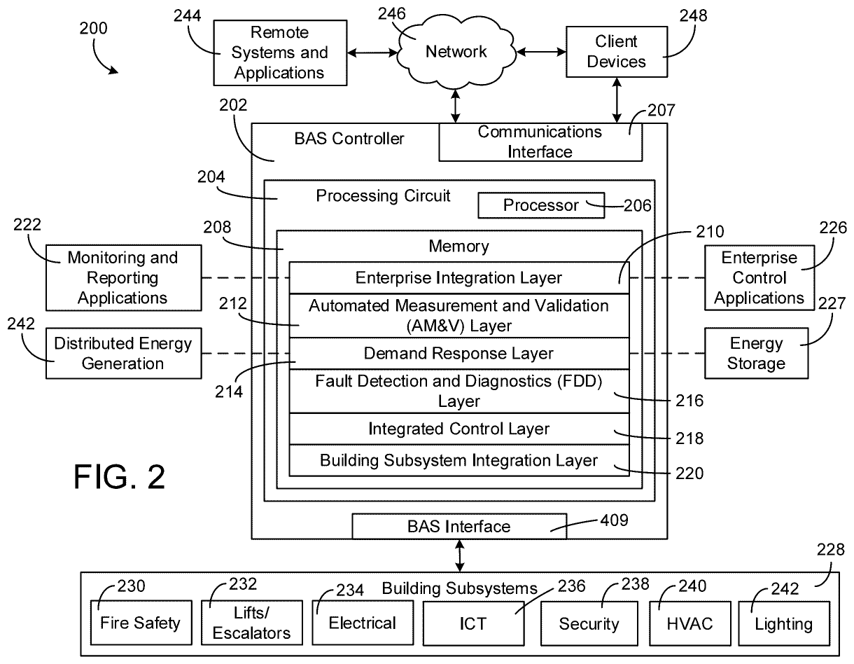

The BMS that serves building 10 includes an HVAC system 100. HVAC system 100 can include HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 is described in greater detail with reference to FIG. 2.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

Referring now to FIG. 2, a block diagram of a building automation system (BAS) 200 is shown, according to an exemplary embodiment. BAS 200 can be implemented in building 10 to automatically monitor and control various building functions. BAS 200 is shown to include BAS controller 202 and building subsystems 228. Building subsystems 228 are shown to include a building electrical subsystem 234, an information communication technology (ICT) subsystem 236, a security subsystem 238, a HVAC subsystem 240, a lighting subsystem 242, a lift/escalators subsystem 232, and a fire safety subsystem 230. In various embodiments, building subsystems 228 can include fewer, additional, or alternative subsystems. For example, building subsystems 228 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 228 include a waterside system and/or an airside system. A waterside system and an airside system are described with further reference to U.S. patent application Ser. No. 15/631,830 filed Jun. 23, 2017, the entirety of which is incorporated by reference herein.

Each of building subsystems 228 can include any number of devices, controllers, and connections for completing its individual functions and control activities. HVAC subsystem 240 can include many of the same components as HVAC system 100, as described with reference to FIG. 1. For example, HVAC subsystem 240 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 242 can include any number of light fixtures, ballasts, lighting sensors, dimmers, or other devices configured to controllably adjust the amount of light provided to a building space. Security subsystem 238 can include occupancy sensors, video surveillance cameras, digital video recorders, video processing servers, intrusion detection devices, access control devices and servers, or other security-related devices.

Still referring to FIG. 2, BAS controller 202 is shown to include a communications interface 207 and a BAS interface 209. Interface 207 can facilitate communications between BAS controller 202 and external applications (e.g., monitoring and reporting applications 222, enterprise control applications 226, remote systems and applications 244, applications residing on client devices 248, etc.) for allowing user control, monitoring, and adjustment to BAS controller 202 and/or subsystems 228. Interface 207 can also facilitate communications between BAS controller 202 and client devices 248. BAS interface 209 can facilitate communications between BAS controller 202 and building subsystems 228 (e.g., HVAC, lighting security, lifts, power distribution, business, etc.).

Interfaces 207, 209 can be or include wired or wireless communications interfaces (e.g., jacks, antennas, transmitters, receivers, transceivers, wire terminals, etc.) for conducting data communications with building subsystems 228 or other external systems or devices. In various embodiments, communications via interfaces 207, 209 can be direct (e.g., local wired or wireless communications) or via a communications network 246 (e.g., a WAN, the Internet, a cellular network, etc.). For example, interfaces 207, 209 can include an Ethernet card and port for sending and receiving data via an Ethernet-based communications link or network. In another example, interfaces 207, 209 can include a Wi-Fi transceiver for communicating via a wireless communications network. In another example, one or both of interfaces 207, 209 can include cellular or mobile phone communications transceivers. In one embodiment, communications interface 207 is a power line communications interface and BAS interface 209 is an Ethernet interface. In other embodiments, both communications interface 207 and BAS interface 209 are Ethernet interfaces or are the same Ethernet interface.

Still referring to FIG. 2, BAS controller 202 is shown to include a processing circuit 204 including a processor 206 and memory 208. Processing circuit 204 can be communicably connected to BAS interface 209 and/or communications interface 207 such that processing circuit 204 and the various components thereof can send and receive data via interfaces 207, 209. Processor 206 can be implemented as a general purpose processor, an application specific integrated circuit (ASIC), one or more field programmable gate arrays (FPGAs), a group of processing components, or other suitable electronic processing components.

Memory 208 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 208 can be or include volatile memory or non-volatile memory. Memory 208 can include database components, object code components, script components, or any other type of information structure for supporting the various activities and information structures described in the present application. According to an exemplary embodiment, memory 208 is communicably connected to processor 206 via processing circuit 204 and includes computer code for executing (e.g., by processing circuit 204 and/or processor 206) one or more processes described herein.

In some embodiments, BAS controller 202 is implemented within a single computer (e.g., one server, one housing, etc.). In various other embodiments BAS controller 202 can be distributed across multiple servers or computers (e.g., that can exist in distributed locations). Further, while FIG. 2 shows applications 222 and 226 as existing outside of BAS controller 202, in some embodiments, applications 222 and 226 can be hosted within BAS controller 202 (e.g., within memory 208).

Still referring to FIG. 2, memory 208 is shown to include an enterprise integration layer 210, an automated measurement and validation (AM&V) layer 212, a demand response (DR) layer 214, a fault detection and diagnostics (FDD) layer 216, an integrated control layer 218, and a building subsystem integration later 220. Layers 210-220 is configured to receive inputs from building subsystems 228 and other data sources, determine optimal control actions for building subsystems 228 based on the inputs, generate control signals based on the optimal control actions, and provide the generated control signals to building subsystems 228 in some embodiments. The following paragraphs describe some of the general functions performed by each of layers 210-220 in BAS 200.

Enterprise integration layer 210 can be configured to serve clients or local applications with information and services to support a variety of enterprise-level applications. For example, enterprise control applications 226 can be configured to provide subsystem-spanning control to a graphical user interface (GUI) or to any number of enterprise-level business applications (e.g., accounting systems, user identification systems, etc.). Enterprise control applications 226 can also or alternatively be configured to provide configuration GUIs for configuring BAS controller 202. In yet other embodiments, enterprise control applications 226 can work with layers 210-220 to optimize building performance (e.g., efficiency, energy use, comfort, or safety) based on inputs received at interface 207 and/or BAS interface 209.

Building subsystem integration layer 220 can be configured to manage communications between BAS controller 202 and building subsystems 228. For example, building subsystem integration layer 220 can receive sensor data and input signals from building subsystems 228 and provide output data and control signals to building subsystems 228. Building subsystem integration layer 220 can also be configured to manage communications between building subsystems 228. Building subsystem integration layer 220 translate communications (e.g., sensor data, input signals, output signals, etc.) across multi-vendor/multi-protocol systems.

Demand response layer 214 can be configured to optimize resource usage (e.g., electricity use, natural gas use, water use, etc.) and/or the monetary of such resource usage in response to satisfy the demand of building 10. The optimization can be based on time-of-use prices, curtailment signals, energy availability, or other data received from utility providers, distributed energy generation systems 224, from energy storage 227, or from other sources. Demand response layer 214 can receive inputs from other layers of BAS controller 202 (e.g., building subsystem integration layer 220, integrated control layer 218, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an exemplary embodiment, demand response layer 214 includes control logic for responding to the data and signals it receives. These responses can include communicating with the control algorithms in integrated control layer 218, changing control strategies, changing setpoints, or activating/deactivating building equipment or subsystems in a controlled manner. Demand response layer 214 can also include control logic configured to determine when to utilize stored energy. For example, demand response layer 214 can determine to begin using energy from energy storage 227 just prior to the beginning of a peak use hour.

In some embodiments, demand response layer 214 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 214 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 214 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable setpoint adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 218 can be configured to use the data input or output of building subsystem integration layer 220 and/or demand response later 214 to make control decisions. Due to the subsystem integration provided by building subsystem integration layer 220, integrated control layer 218 can integrate control activities of the subsystems 228 such that the subsystems 228 behave as a single integrated supersystem. In an exemplary embodiment, integrated control layer 218 includes control logic that uses inputs and outputs from building subsystems to provide greater comfort and energy savings relative to the comfort and energy savings that separate subsystems could provide alone. For example, integrated control layer 218 can be configured to use an input from a first subsystem to make an energy-saving control decision for a second subsystem. Results of these decisions can be communicated back to building subsystem integration layer 220.

Integrated control layer 218 is shown to be logically below demand response layer 214. Integrated control layer 218 can be configured to enhance the effectiveness of demand response layer 214 by enabling building subsystems 228 and their respective control loops to be controlled in coordination with demand response layer 214. This configuration can reduce disruptive demand response behavior relative to conventional systems. For example, integrated control layer 218 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 218 can be configured to provide feedback to demand response layer 214 so that demand response layer 214 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 218 is also logically below fault detection and diagnostics layer 216 and automated measurement and validation layer 212. Integrated control layer 218 can be configured to provide calculated inputs (e.g., aggregations) to these higher levels based on outputs from more than one building subsystem.

Automated measurement and validation (AM&V) layer 212 can be configured to verify that control strategies commanded by integrated control layer 218 or demand response layer 214 are working properly (e.g., using data aggregated by AM&V layer 212, integrated control layer 218, building subsystem integration layer 220, FDD layer 216, or otherwise). The calculations made by AM&V layer 212 can be based on building system energy models and/or equipment models for individual BAS devices or subsystems. For example, AM&V layer 212 can compare a model-predicted output with an actual output from building subsystems 228 to determine an accuracy of the model.

Fault detection and diagnostics (FDD) layer 216 can be configured to provide on-going fault detection for building subsystems 228, building subsystem devices (i.e., building equipment), and control algorithms used by demand response layer 214 and integrated control layer 218. FDD layer 216 can receive data inputs from integrated control layer 218, directly from one or more building subsystems or devices, or from another data source. FDD layer 216 can automatically diagnose and respond to detected faults. The responses to detected or diagnosed faults can include providing an alarm message to a user, a maintenance scheduling system, or a control algorithm configured to attempt to repair the fault or to work-around the fault.

FDD layer 216 can be configured to output a specific identification of the faulty component or cause of the fault (e.g., loose damper linkage) using detailed subsystem inputs available at building subsystem integration layer 220. In other exemplary embodiments, FDD layer 216 is configured to provide “fault” events to integrated control layer 218 which executes control strategies and policies in response to the received fault events. According to an exemplary embodiment, FDD layer 216 (or a policy executed by an integrated control engine or business rules engine) can shut-down systems or direct control activities around faulty devices or systems to reduce energy waste, extend equipment life, or assure proper control response.

FDD layer 216 can be configured to store or access a variety of different system data stores (or data points for live data). FDD layer 216 can use some content of the data stores to identify faults at the equipment level (e.g., specific chiller, specific AHU, specific terminal unit, etc.) and other content to identify faults at component or subsystem levels. For example, building subsystems 228 can generate temporal (i.e., time-series) data indicating the performance of BAS 200 and the various components thereof. The data generated by building subsystems 228 can include measured or calculated values that exhibit statistical characteristics and provide information about how the corresponding system or process (e.g., a temperature control process, a flow control process, etc.) is performing in terms of error from its setpoint. These processes can be examined by FDD layer 216 to expose when the system begins to degrade in performance and alarm a user to repair the fault before it becomes more severe.

### Energy Conservation Measures

The systems and methods described herein can include and/or be implemented by an Energy Conservation Measure (ECM) manager. The ECM manager can be or included in the BMS described herein. The ECM manager can generate at least one ECM. The ECMs can be or included in at least one energy conservation protocol. The ECMs can include at least one action that can be taken or executed by or in relation to the building served by the ECM manager. The actions included in the ECMs can be single actions (e.g., replace a piece of building equipment) and/or the ECMs can be continual or semi continual actions (e.g., control strategies that pertain to building operations).

A company, business, firm, organization, corporation, agency, establishment, or any other possible entity can decide that they want to reduce emissions and/or improve the sustainability of at least one building that corresponds to the company. However, companies struggle to actually reduce emissions and/or improve the sustainability of their buildings as the sustainability of a building is an ever changing scenario.

The ECM manager provides a seamless process that improves a buildings ability to reduce emissions and/or increase the sustainability of the company. This technical solution provides the ability for a company to establish actions that can achieve the sustainability goals (e.g., reduce emissions, increase sustainability, etc.) that the company has decided to create. Additionally, the ECM manager can track the progress made towards the sustainability goals, detect additional data that suggests previously absent sustainability factors are now impacting the sustainability of the building and generate actions that can correct the newly determined sustainability factors. Additionally, this technical solution provides a flexible and dynamic process that can address the ever changing and evolving nature of the sustainability of buildings. The sustainability of a building is not properly and effectively achieved by just establishing a goal.

The ECM manager can obtain at least one sustainability goal. The sustainability goal can pertain to the sustainability of a building. For example, the sustainability goal can pertain to the sustainability of the building 10. The sustainability goal can be, include and/or pertain to at least one of a company goal, a location goal and/or a building goal. The company goal can be or include at least one of a company goal, a company level goal a portfolio goal and/or a portfolio level goal. The sustainability goals can be, include and/or pertain to at least one sustainability category. The sustainability categories can be or include emissions, energy consumption, water and/or waste. The emissions category can pertain to at least one of carbon emissions, greenhouse gas emissions, emission that pertain to energy sources (e.g., natural gas, electricity, propane, butane, etc.). The energy consumption category can pertain to at least one of total energy consumption, energy use intensity, resource consumption, steam consumption, etc. The water category can pertain to the amount of water that is consumed, used, or otherwise associated with a building. The waste category can pertain to garbage production, paper waste, electronic components, etc. The sustainability categories described herein can pertain to at least one of, at least one company that includes at least one location and the locations include at least one building, at least one location and the locations include at least one building, and/or at least one building that can pertain to at least one location and/or company.

The sustainability goal can be to reduce emissions for the building 10. For example, the sustainability goal can be to reduce carbon emission for the building 10 by a certain percentage and/or value. Similarly, the sustainability goal can be to reduce energy consumption for the building 10. For example, the sustainability goal can be to reduce energy consumption from a power grid and/or increase an amount of solar generated energy. Examples of the goals described herein can be found in U.S. Provisional Patent Application No. 63/336,935 filed Apr. 29, 2022, the entirety of which is incorporate herein by reference. The ECM manager can determine, detect, or otherwise identify that the goals pertain to at least one sustainability categories. The sustainability categories can be or include at least one emissions.

The ECM manager can, responsive to obtaining the sustainability goal, determine a target sustainability level for the building. The ECM manager can determine the target sustainability level for the building using a baseline sustainability performance and the sustainability goal. The baseline sustainability performances can be or include at least one baseline level for at least one sustainability category and/or a baseline value for at least one source that impacts at least one of the sustainability categories. For example, the baseline sustainability performance can be a baseline emission level. The baseline sustainability performance can also be a baseline energy consumption level and/or a baseline electricity consumption level for the building.

The ECM manager can generate at least one energy conservation protocol. The ECM manager can generate the energy conservation protocols using the baseline sustainability performance the target sustainability level. The energy conservation protocols can include at least one action that can meet at least a portion of the sustainability goal. For example, a first action included in at least one energy conservation protocol can be to replace an HVAC system with an HVAC that is more energy efficient. A second action can be to retrofit the building 10 with solar photovoltaic (PV) cells, fuel cells, energy storage, etc. The actions including the energy conservation protocols can meet at least one of the sustainability goal and/or the target sustainability level. For example, the sustainability goal can be for the building 10 to consume 40% of its total electricity consumption from electricity that is generated from solar. In this example, the energy conservation protocol can be or include at least one action that involves retrofitting, over a period of time, a certain amount of PV cells so that the building 10 can consume 40% of its total electricity consumption from electricity that is generated from solar. Similarly, the energy conservation protocol can include control actions that can be implemented to decrease the amount of electricity that the building 10 consumes from the grid. In doing so the building 10 could increase its percentage of electricity consumption from electricity that is generated from solar by decreasing the amount of electricity consumed from the grid.

The ECM manager can receive an indication to accept a subset of the plurality of actions included in at least one energy conservation protocol. For example, the ECM manager can provide the energy conservation protocols to a user via the user device 318. The user device 318 can provide, present, show, create or otherwise display a user interface that includes the energy conservation protocols. The user can select, via an icon included in the user interface, at least one energy conservation protocol and/or at least one action included in the energy conservation protocols. The ECM manager can receive, responsive to the user selecting the icon, the subset of the plurality of actions included in the energy conservation protocols.

The ECM manager can implement the subset of the plurality of actions included in the energy conservation protocols. The ECM manager can implement the subset of the plurality of actions included in the energy conservation protocols by generating, providing and or executing the actions included in the energy conservation protocols. For example, the ECM manager can provide, to pieces of building equipment included in and/or that service the building 10, control signals to control the pieces of building equipment. The controlling of the pieces of building equipment can cause the building 10 to move towards the target sustainability level. For example, the control actions can be modifying and maintaining a setpoint for a piece of equipment. Maintaining the setpoint can reduce an amount of energy that is consumed by the piece of equipment, and reducing the amount of energy consumed by the piece of building equipment can reduce the amount of energy consumption (e.g., a sustainability goal) for the building 10.

The ECM manager can, responsive to controlling pieces of building equipment, detect that the building 10 has moved towards the target sustainability level. For example, the sustainability goal can be to reduce the amount of electricity that is consumed from the power grid. The ECM manager can, using utility information for the building 10, determine that the electricity consumption for the building 10 from the power grid has decreased. Similarly, the ECM manager can also determine that an amount of energy consumed from electricity generated by solar has increased. The reducing of the amount of electricity consumed from the power grid and the increasing of the amount of electricity consumed from solar generated electricity can both indicate that the building 10 has moved towards the target sustainability level.

The sustainability categories described herein can have at least one source. For example, the energy consumption can include the amount of electricity that a building consumes, uses, or otherwise receives. The ECM manager can generate ECMs that can target at least one source that impacts at least one of the sustainability categories. For example, the ECM manager can identify an ECM that will impact the butane usage associated with a building. Additionally, the ECM manager can organize the generated ECMs and provide them to the company. For example, the ECM manager can organize the generate ECMs by highest reduction (e.g., the ECM that reduces the source by the highest amount is listed first), shortest payback (e.g., the ECM that provides the fastest return is listed first) and/or lowest amount (e.g., the ECM that has the lowest implementation amount is listed first).

The ECM manager organizing the generated ECMs provides companies with the ability to easily and seamlessly view ECMs that improve the sustainability of the buildings while also allowing the companies to have additional priorities (e.g., highest reduction, shortest payback, lowest amount).

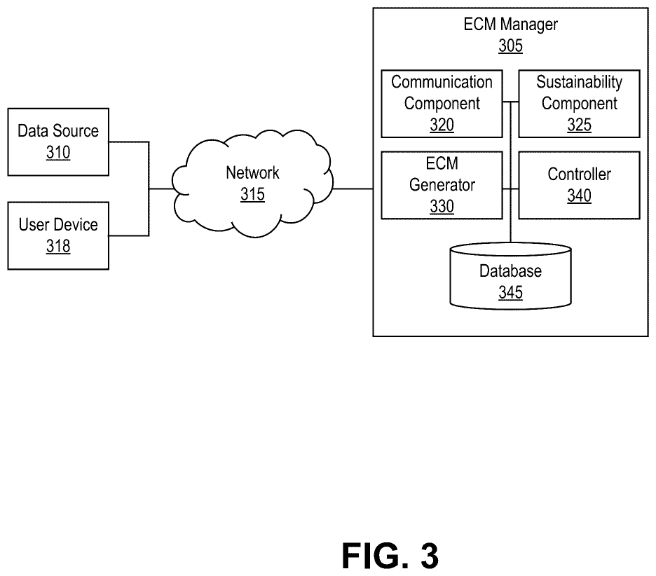

Referring now to FIG. 3, a block diagram of a system 300 for energy conservation is shown, according to an exemplary embodiment. The system 300 can include an Energy Conservation Measure (ECM) manager 305 (e.g., the ECM manager described herein), at least one data source 310, at least one network 315, and the user device 318. The ECM manager 305 can include at least one communication component 320, at least one sustainability component 325, at least one ECM generator 330, at least one controller 335 and at least one database 340. The ECM manager 305 can perform similar functionality to that of the BAS 200 and/or the ECM manager 305 can include components that are similar to the components of the BAS 200. Similarly, the ECM manager 305 can perform similar functionality to that of at least one component described herein.

The data source 310 can be or include at least one of the building subsystems 228, a digital twin, collected data associated with one or more systems or subsystems of the building 10, utility information (e.g., energy consumption, water consumption, etc.), metadata for building systems, operating settings for the building systems, runtime data for the building systems, energy usage, or any other possible data source that may provide data to the ECM manager 305. In some embodiments, the data source 310 can be a separate component that receives the various types of data and/or information described herein. The data provided by the data source 310, to the ECM manager 305, can be or include information that describes a building facility, identifies a use of a building, includes a name of the building, includes a building layout, indicates goals regarding sustainability (e.g., energy reduction, carbon creation, carbon footprint, water usage reduction, switching the renewable energy, etc.), and/or indicates credential to access utility information for a building.

In some embodiments, the data source 310 can provide data that includes data similar to that described in U.S. Provisional Patent Application No. 63/336,935 filed Apr. 29, 2022, the entirety of which is incorporated herein by reference. For example, the ECM manager 305 can receive data that pertains to the business goal and/or the business level goal, the location level goal, the building level goal, or the building sub-target goal. Similarly, the data that is received by the ECM manager 305 can be or include operational data that pertains to at least one piece of building equipment that is included in and/or that serves the building 10. For example, the data can be operational data that pertains to and/or that includes the building subsystems 228 and/or pieces of building equipment thereof. The business level goals, the location level goals, the building level goal, and/or the building sub-target goal can be or include at least one sustainability goal. In some embodiments, the ECM manager 305 can perform similar functionality to that of the sustainability manager and/or the ECM manager 305 can include components that are similar to the component of the sustainability manager described in U.S. Provisional Patent Application No. 63/336,935 filed Apr. 29, 2022. The data provided by the data source 310 can pertain to at least one building (e.g., building 10) and the building 10 can be included in at least one location and the location and the building 10 can be included in at least one company and/or business.

The communication component 320, via the network 315, can interact with, interface with, or otherwise communicate with at least one of the data source 310 or the user device 318. For example, the communication component 320 can communicate with the data source 310 and the data source 310 can provide data (e.g., building information, utility information, energy consumption, etc.) that pertains to a building (e.g., building 10) to the communication component 320. Similarly, the user device 318 can provide data the pertains to at least one of user settings, user preferences, user selections, configuration data, sustainability targets and/or sustainability goals (e.g., the business level goals and/or targets, the location level goals and/or targets, the building level goals and/or targets or the building sub-target goals) and/or customizations that pertain to the sustainability targets.

The sustainability component 325 can obtain, from the communication component 320, the data received from the data source 310 and/or the user device 318. For example, the sustainability component 325 can obtain a sustainability target (e.g., a sustainability goal) that was established for a building. The sustainability target can include a parameter that pertains to the sustainability of the building. For example, the sustainability target can be to reduce the emissions (e.g., the parameter) of the building by 90%. The parameters can be and/or include the sustainability performances described herein. The parameter can be or include at least one of at least one emission parameter (e.g., carbon emission, greenhouse gas emission or any other possible emission), at least one energy parameter (e.g., energy consumption, energy usage intensity or any other possible), at least one water parameter (e.g., water usage, water consumption or any other possible water metric) and/or at least one waste parameter (e.g., waste production, recycle rate).

In some embodiments, the sustainability component 325 can, using data that pertains to the building, determine a baseline value for the parameter (e.g., a baseline sustainability performance). For example, the baseline value can be the total carbon emissions of the building in the previous year. The sustainability component 325 can, using the baseline value for the parameter and the sustainability target, determine a target value for the parameter (e.g., a target sustainability level). For example, the parameter can be water consumption, the baseline value for water consumption of the building can be 10,000 gallons and the sustainability target can be to reduce the yearly water consumption of the building by 80%. The sustainability component 325, using the baseline value (10,000 gallons) and the sustainability target (reduce water consumption by 80%) can determine that the target value is 2,000 gallons of yearly water consumption. The sustainability component 325 can, responsive to determining the target value of the parameter, communicate with the ECM generator 330. The sustainability component 325 can provide, to the ECM generator 330, at least one of the sustainability target, the baseline value of the parameter, the target value of the parameter or any other possible information that pertains to the sustainability target.

The sustainability component 325 can determine the target value for the parameter (e.g., the target sustainability level) by determining a difference between the baseline sustainability performance and the sustainability goal. For example, the building 10 can have a sustainability goal pertaining to carbon emissions and the baseline sustainability performance for the building 10 can be 8,000 tCO2e/yr. The sustainability component 325 can determine that the sustainability goal is to reduce carbon emissions by 60% and the sustainability component 325 can use the baseline sustainability performance of 8,000 tCO2e/yr. and the carbon reduction goal of 60% to determine a difference. For example, the sustainability component 325 can determine that a reduction (e.g., a difference) of carbon emissions by 4,800 tCO2e/yr. can result in the sustainability goal being reached.

In some embodiments, the sustainability component 325 can use the difference between the baseline sustainability performance and the sustainability goal to generate a sustainability value. The sustainability value can be a value that meets the sustainability goal. For example, the sustainability component 325 can use the baseline sustainability performance of 8,000 tCO2e/yr. and the difference of 4,800 tCO2e/yr. to generate a sustainability value of 3,200 tCO2e/yr. In this non-limiting example, the sustainability component 325 can determine that the building reaching a carbon emission value of 3,200 tCO2e/yr. can result in the building 10 meeting the sustainability goal (e.g., reduce carbon emissions by 60%). The sustainability component 325 can then determine an amount of time to reach the sustainability value. For example, the sustainability goal can establish an amount of time to reach the sustainability goal (e.g., reduce carbon emissions by 60% in the next 15 years). The sustainability component 325 can use the amount of time to reach the sustainability value when tracking and/or monitoring the progress made towards the sustainability goal.

In some embodiments, the ECM generator 330 can, responsive to communicating with the sustainability component 325, generate at least one energy conservation protocol. The energy conservation protocols can include at least one energy conservation measure (ECM). The ECMs can be or include at least one action that can be taken or executed where in response to the actions being taken or executed the sustainability target can be reached, achieved, satisfied, accomplished, or otherwise met. The actions can be at least one of building improvements (e.g., FIMs), control strategies (e.g., temperature settings, lighting settings, HVAC settings, circulation settings, ventilation settings, etc.) and/or employee actions (e.g., carpool schedules, work-from-home schedules, incentive programs or any other possible action that can be used to achieve the sustainability target. The ECM generator 330 can, in response to generating the energy conservation protocols, communicate with the communication component 320. The ECM generator 330 can provide, to the communication component 320, the energy conservation protocols.

In some embodiments, the communication component 320 can, in response to receiving the energy conservation protocols, provide, to at least one of the data source 310 or the user device 318, the energy conservation protocols. The communication component 320 providing the energy conservation protocols to the user device 318 can cause the user device 318 to display, via a user interface associated with the user device 318, at least a portion of the energy conservation measures. For example, the user interface displayed by the user device 318 can display, show, present or otherwise include the energy conservation protocols and the actions included in the energy conservation protocols.

The operator of the user device 318 can interact with, interface with, or otherwise engage with the user interface displayed by the user device 318. For example, the operator of the user device 318 can view the energy conservation protocols and the actions included in the energy conservation protocols. The operator of the user device 318 can accept, decline and/or customize at least one of the energy conservation protocols, the actions included in the energy conservation protocols and/or a subset of the actions included in the energy conservation protocols. For example, the actions included in the energy conservation protocols can be or include at least one of a control strategy for the HVAC system of the building that can decrease the energy consumption of the building, a FIM (e.g., replace the HVAC system) that pertains to the HVAC system and/or a building setpoint (e.g., a temperature setting). Additionally, the subset of the actions included in the energy conservation protocols can be at least one of the actions included in the energy conservation protocols. For example, the subset of the actions included in the energy conservation protocols can be the control strategy for the HVAC system. The operator can accept the subset of the actions included in the energy conservation protocols by hovering over, selecting, or otherwise interacting with an icon included in the user interface displayed by the user device 318.

In some embodiments, the communication component 320 can, in response to the operator of the user device 318 selecting the icon to accept the subset of the actions included in the energy conservation protocols, receive an indication. The indication can be an indication to accept the subset of the actions included in the energy conservation protocols. For example, the user device 318 can, in response to the operator selecting the icon to accept the subset of the actions included in the energy conservation protocols, provide, to the communication component 320, a signal. The signal provided to the communication component 320 can include the indication to accept the subset of the actions included in the energy conservation protocols. The indication can also be an indication that the operator of the user device 318 has accepted the entire energy conservation protocols and/or an indication that the energy conservation protocols have been customized by the operator. The indication can also be an indication that the operator of the user device 318 has provided a user defined energy conservation protocol. The communication component 320 can, in response to receiving the indication, provide, to the ECM generator 330, the indication. For example, the ECM generator 330 can be provided the indication to accept the subset of the actions included in the energy conservation protocols.

The ECM generator 330 can, using the indication provided by the communication component 320, implement, establish, modify, update, change or otherwise proceed with the energy conservation protocols. For example, the indication can be an indication to accept a subset of the actions included in the energy conservation protocols and the ECM generator 330 can use the indication to update the energy conservation protocols. The ECM generator 330 can update the energy conservation protocols to reflect the subset of the actions included in the indication. For example, the ECM generator 330 can update the energy conservation protocols to include the subset of the actions that were included in the indication and remove, from the energy conservation protocols, the actions not included in the indication. The ECM generator 330 can, in response to receiving the indication provided by the communication component 320 and/or in response to updating the energy conservation protocols, provide, establish the energy conservation protocols. The ECM generator 330 can establish the energy conservation protocols by providing, to the database 340, the energy conservation protocols and the database 340 can store, maintain, or otherwise hold the energy conservation protocols. The ECM generator 330 can provide, to the communication component 320, the sustainability component 325 and the controller 335, an indication that the energy conservation protocols have been established.

In some embodiments, the controller 335 can, in response to receiving the indication that the energy conservation protocols have been established, implement the energy conservation protocols and/or the actions included in the energy conservation protocols. The controller 335 can control and/or operate at least one piece of building equipment. For example, the controller 335 can provide a signal to a HVAC system that pertains to a building (e.g., the building 10) that causes the ventilation rate of the HVAC system to be adjusted. As described herein the energy conservation protocols can include control strategies and the controller 335 can, using the control strategies, control the pieces of building equipment. For example, the control strategy can be to have a lighting system produce a certain amount of light at a particular time of day and the controller 335 can provide a signal, to the lighting system, that causes the certain amount of light to be produced.

The communication component 320 can, in response to receiving the indication that the energy conservation protocols have been established, provide, to the data source 310 and/or the user device 318, the indication that the energy conservation protocols have been established. The communication component 320 providing, to the user device 318, the indication that the energy conservation protocols have been established can cause the user device 318 to display a user interface that includes a notice that the energy conservation protocols have been established.

In some embodiments, the sustainability component 325 can, in response to receiving the indication that the energy conservation protocols have been established, monitor and/or implement the energy conservation protocols. For example, the sustainability component 325 can determine that the energy conservation protocols include a FIM and the sustainability component 325 can determine, using the FIM, a person, entity or object that can implement and/or is impacted by the FIM. For example, the FIM can be replacing a boiler and the sustainability component 325 can determine the location of the boiler (e.g., the location of the boiler in the building), a person or company that can replace the boiler and/or employees that can be impacted by the boiler being replaced.

In some embodiments, the sustainability component 325 can, in response to determining the person, entity or object, implement the energy conservation protocols. The sustainability component 325 can implement the energy conservation protocols by providing, to the company that can perform the FIM, a work order request and the sustainability component 325 can schedule when the FIM will be executed. For example, the sustainability component 325 can determine a device (e.g., the user device 318) that is associated with the company that can perform the FIM and the sustainability component 325 can provide, to the user device 318, a signal that causes the user device 318 to display a work order request. The work order request can include what piece of equipment will be replaced and an identifier (e.g., a serial number) of the piece of equipment that will replace the previous piece. The sustainability component 325 can provide, in the work order request, a time (e.g., Monday at 7:00) where the FIM can be performed.

The ECMs can include at least one ECM saving category, and the ECM savings categories can include at least one of projects, actions, steps and/or measures that can be implemented. The ECM savings categories can include lighting savings, air handler savings, boiler/heat savings, chiller savings, pumping savings, zone savings, and floor zones. The example ECM saving categories are not limiting in any way and there can be several other ECM saving categories. The energy conservations protocols, the ECM saving categories and/or the ECMs can be stored, located, and/or otherwise maintained in the database 340.

The lighting savings category actions can include adjusting lighting operation hours, adjusting lighting operation parameters and/or setpoints, adjusting an amount of lights activated, and/or among other possible actions. The air handler savings category actions can include initiating a night setback and shutdown protocol (e.g., the air handler runtime frequency is setback at night), developing an optimum start time for the air handler, detecting low leakage dampers (e.g., air is escaping the ventilation resulting in air handler runtime increasing) and correcting the low leakage dampers, reduce an amount of ventilation, install high efficiency motors, install high efficiency Air Handler Unit (AHU) motors, install Variable Frequency Drives (VFDs) on Variable Air Volume (VAV) systems, perform a supply air reset, perform a cold deck reset, perform a hot deck reset, convert Multi zone (MZ)/Dual Duct (DD) to VAV's, and/or install an air-to-air economizer. The boiler/heat savings category actions can include initiating and/or performing a hot water reset, initiating and/or performing a steam reset, initiating and/or performing boiler replacement, initiating and/or performing a boiler maintenance routine, replacing burners, updating controls, initiating and/or performing an electric to heat pump conversion, and/or among other possible boiler/heat actions. The chiller savings category actions can include initiating and/or performing a chilled water reset, initiating and/or performing a condenser water rest, replacing a chiller, and/or among other possible chiller actions. The pumping savings category actions can include installing and/or using a VSD chilled water pump, installing and/or using a VSD heating water pump, installing and/or using high efficiency CHW/CW pump motors, installing and/or using high efficiency HW pump motors, and/or among other possible pumping actions.

The database 340 can store, keep, hold and/or otherwise maintain the different types of data described herein. For example, the database 340 can store operational data and utility data. The database 340 can also store data that pertains to the building 10. The data that pertains to the building 10 can include at least one of operational metrics, building metrics, occupancy metrics, equipment inventory, maintenance records, building improvement records, building upkeep information, and/or among other possible data that can pertain to the building 10. The database 340 can also store weather data, weather predictions, weather impact information, and/or among other possible data pertaining to the weather around the building 10. The database 340 can also store data pertaining to equipment standards, equipment protocols, equipment efficiency metrics, equipment energy consumption, equipment performance metrics, and/or among other possible equipment information. The database 340 can also store data pertaining to amounts associated with equipment retrofits, equipment maintenance, and/or among other possible amounts associated with equipment.

The data stored by the database 340 can be at least one of building specific data (e.g., the entire building), floor specific data (e.g., the building is divided into a number of floors in the building and the data is separated based on the respective floors), zone specific data (e.g., a floor is divided into a number of zones and the data is separated based on the respective zones), room specific data (e.g., a zone is divided into a number of rooms and the data is separated based on the respective rooms), equipment category specific data (e.g., chiller data is separated from air handler data, lighting data is separated from boiler data, etc.), and/or equipment specific data (e.g., chiller data is separated to each respective unit that contributed to the chiller data, lighting data is separated to each respective unit that contributed to the lighting data, etc.).

The data pertaining to the operational metrics can be and/or include at least one of operational times for pieces of equipment, number of cycles performed by the pieces of equipment, equipment setpoints, a number of heating weeks, a number of cooling weeks, and/or among other possible operational data. For example, the data pertaining to the operational metrics can include that the HVAC systems runs for 50 hours each week, that the interior lights of the building 10 are on for 60 hours each week, and that the average heating temperature is 72 degrees fahrenheit. The data pertaining to the building metrics can be add/or include at least one of total square footage of the building, number of windows in the building, number of floors in the building, a floor to floor height of the building, an energy transfer rate of the building, and/or among other possible building metrics data. For example, the data pertaining to the building metrics can include that the building is 100,000 square feet and that the windows have an average shading coefficient of 0.8.

The data pertaining to the occupancy metrics of the building can be and/or include at least one of a number of hours that the building is occupied, a number of days that the building is occupied, a number of occupants in the building, and/or among other possible occupancy metrics. For example, the data pertaining to the occupancy metrics can include that the building is occupied for 65 hours/week and that the building is occupied six days/week.

The data pertaining to the equipment inventory can be and/or include at least one of a number of chillers, a number of lighting units, a number of heating of systems, and/or among other possible equipment inventory data. The data pertaining to the maintenance records can be and/or include at least one of dates, times, frequency and/or actions that were taken to performance maintenance on the building and/or equipment of the building. For example, the data pertaining to the maintenance records can include that the air filters are replaced every three months.

The data pertaining to the building improvement records can be and/or include at least one of equipment replacements, equipment additions, equipment retrofits, building remodeling, building repair and/or among other possible building improvement records. For example, the building improvement records can include that the windows of the building were recently replaced.

The data pertaining to weather predictions and/or weather impact information can be and/or include an average temperature for each day of the year, an average number of sunlight for each day of the year, an average air quality for each day of the year, a predicted temperature for a given day of the year, a predicted number of sunlight for a given day of the year, a predicted air quality for a given day of the year, and/or among other possible weather data. For example, the weather data can include an average outside air temperature during heating weeks and an average number of sunlight during cooling weeks.

The data pertaining to equipment protocols, equipment efficiency metrics, equipment energy consumption, and/or equipment performance metrics can be and/or include at least one of a shading factor for windows, an insulation rating for windows, a wattage rating for lighting units, an efficiency rating for equipment motors, and/or among other possible equipment metric information. For example, the equipment efficiency metrics can include that a first type of light fixture has a wattage rating of 200 watts and that a second type of light fixture has a wattage ratting of 100 watts.

The ECM generator 330 can generate the energy conservations protocols by retrieving, from the database 340, operational data pertaining to at least one piece of building equipment of the plurality of pieces of building equipment. For example, the ECM generator 330 can retrieve operational data pertaining to boilers. The ECM generator 330 can then determine, using the operational data pertaining to the at least one piece of building equipment of the plurality of pieces of building equipment, a role in the baseline sustainability performance for the at least one piece of building equipment of the plurality of pieces of building equipment. For example, the ECM generator 330 can determine an amount of carbon emissions contributed to the at least one piece of building equipment. The ECM generator 330 can then retrieve, from the database 340, predetermined operational metrics pertaining to the at least one piece of building equipment. For example, the predetermined operational metrics can include an amount of runtime cycles (e.g., how many times the pieces of equipment execute a run cycle). The ECM generator 330 can then detect, using the predetermined operational metrics pertaining to the at least one piece of building equipment and the operational data pertaining to the at least one piece of building equipment, a difference between the predetermined operational metrics and the operational data. For example, the ECM generator 330 can determine a difference between the number of runtime cycles for the boiler that was included in the operational data and the number of runtime cycles for boilers that was included in the predetermined operational metrics. The ECM generator 330 can then generate, responsive to detecting the difference between the predetermined operational metrics and the operational data, a set of actions that adjust the role in the baseline sustainability performance for the at least one piece of building equipment by decreasing the difference between the predetermined operational metrics and the operational data. For example, the ECM generator 330 can generate a maintenance schedule (e.g., a set of actions) for the boiler and the maintenance schedule can result in the number of runtime cycles for the boiler decreasing. The decreasing in the number of runtime cycles for the boiling can decrease the role of the boiler in the baseline sustainability performance (e.g., the boiler running less can result in a reduction in carbon emissions attributed to the boiler).

As a non-limiting example, the ECM Manager 305 and/or a component thereof can perform the following functions to generate at least one of the ECMs and/or energy conservation protocols described herein. The ECM generator 330 can retrieve, from the database 340, data pertaining to the building 10. For example, the ECM generator 330 can retrieve a number of heating weeks for the building 10, data pertaining to the heating system of the building 10, a temperature setpoint for the building 10, and/or among other possible information. The ECM generator 330 can, responsive to retrieving the data pertaining to the building 10, generate at least one ECM. The ECM generator 330 can generate the ECMs using the number of heating weeks for the building 10 and the data pertaining to the heating systems. For example, the number of heating weeks for the building 10 can be 30 weeks and the data pertaining to the heating systems can include an efficiency rating for the heating system. The ECM generator 330 can, using the number of heating weeks and the efficiency rating, generate the ECMs. For example, a first ECM of the plurality of ECMs can be replacing the heating system with a more efficient heating system. The first ECM can also include information pertaining to the impact of the ECM. The information can include an energy savings, a carbon reduction, and/or among other possible information. The ECM generator 330 can determine the impact of the first ECM by comparing the replacement heating system with the current heating system of the building 10. For example, the replacement heating system can be 25% more efficient than the current heating system and given the 25% difference the ECM generator 330 can determine the impact of replacing the current heating system with the replacement heating system.

As another non-limiting example, the ECM manager 305 and/or a component thereof can perform the following functions to generate at least one ECM and/or energy conservation protocol described herein. The ECM generator 330 can retrieve, from the database 340, data pertaining to the building 10. For example, the ECM generator 330 can retrieve information pertaining to the windows, building maintenance, and the air infiltration rate of the building. The ECM generator 330 can generate, using the data retrieved from the database 340, at least one ECM. For example, the ECM generator 330 can generate a first ECM pertaining to replacing the caulk around the windows of the building and/or a second ECM pertaining to replacing the windows on a side of the building that have a given amount of sun exposure. The ECM generator 330 can determine that replacing the caulk around the building 10 can result in a decrease in building equipment runtime (e.g., the internal temperature of the building 10 is maintained better given a decrease in air infiltration). The ECM generator 330 can also determine that replacing the windows on the side of the building that have the given amount of sun exposure can also result in a decrease in building equipment runtime. The decrease in building equipment runtime can result in a decrease in energy consumption for the building 10. The decrease in building equipment runtime can also result in a decrease in carbon emission for the building 10.

As another non-limiting example, the ECM manager 305 and/or a component thereof can perform the following functions to generate at least one ECM and/or energy conservation protocol described herein. The ECM generator 330 can retrieve, from the database 340, operational data pertaining to a piece of building equipment for the building 10. For example, the ECM generator 330 can retrieve operational data pertaining to lighting equipment. The ECM generator 330 can use the operational data to determine a role in the baseline sustainability performance for the lighting system. For example, the baseline sustainability performance for the building 10 can pertain to energy consumption and the ECM generator 330 can determine an amount of energy consumption attributed to the lighting equipment (e.g., the role). The ECM generator 330 can retrieve, from the database 340, predetermined operational metrics that pertain to the lighting equipment. For example, the ECM generator 330 can retrieve energy consumption metrics (e.g., how many watts does a piece of lighting equipment consume, how many lumens does a piece of lighting equipment emit, etc.). The ECM generator 330 can detect, using the predetermined operational metrics and the operational data, a different between the predetermined operational metrics and the operational data. For example, the predetermined operational metrics can include pieces of lighting equipment that consume 60 watts of power and the operational data can indicate that the pieces of lighting equipment in the building consume 100 watts of power. The ECM generator 330 can generate, responsive to detecting the difference between the predetermined operational metrics and the operational data, a set of cations that adjust the role in the baseline sustainability performance for the pieces of lighting equipment. For example, the set of actions can include replacing the lighting equipment with lighting equipment that consume 60 watts, lowering a brightness setting for the lighting equipment that can result in the lighting equipment consuming a reduced wattage, and/or among other possible actions. The role in the baseline sustainability performance for the pieces of lighting equipment can be adjusted responsive to a reduction in the amount of energy being consumed by the pieces of lighting equipment.

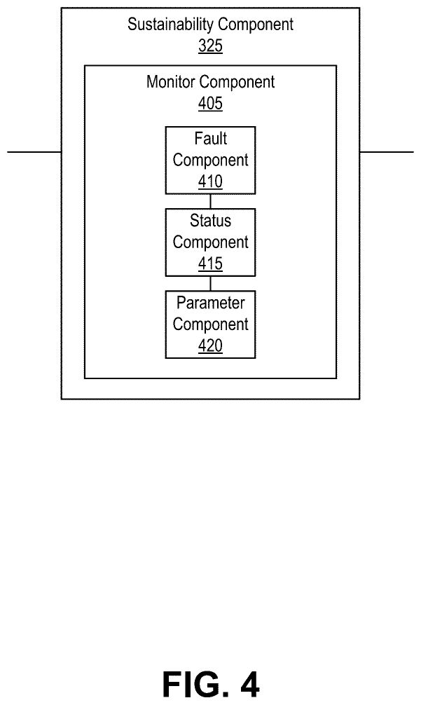

Referring now to FIG. 4, a block diagram of the sustainability component 325 is shown, according to an exemplary embodiment. The sustainability component 325 can include at least one monitor component 405. The monitor component 405 can include at least one fault component 410, at least one status component 415 and at least one parameter component 420. The sustainability component 325 and/or at least one of the components thereof can perform similar functionality to that of the BAS 200. For example, the fault component 410 can perform similar functionality to that of the FDD layer 216.

The communication component 320 can receive, from the data source 310 and/or the user device 318, data that pertains to a building (e.g., the building 10). The communication component 320 can provide, to the sustainability component 325, the data that pertains to the building. The fault component 410 can detect, using the data that pertains to the building, at least one fault condition. The fault condition can be that a piece of building equipment failed to properly run. For example, the fault component 410 can detect that a boilers heating and cooling valves were simultaneously open. The fault component 410 can, in response to detecting the fault condition, determine that the fault condition impacts the sustainability target. For example, the fault condition can be that a HVAC system startup runtime is higher than a predetermined threshold (e.g., the HVAC systems startup should have been completed) and the fault component 410 can determine that the addition startup runtime has resulted in additional energy consumption. The fault component 410 can determine that the additional energy consumption has impacted the sustainability target.

In some embodiments, the fault component 410, in response to determining that the fault condition impacts the sustainability target, can provide, to the ECM generator 330, an indication. The indication can include at least one of the fault condition, the one or more pieces of building equipment associated with the fault condition and/or an action that can be taken to correct the fault condition (e.g., replace the pieces of equipment, perform maintenance on the pieces of equipment, etc.). The ECM generator 330 can, in response to receiving the indication from the fault component 410, update the energy conservation protocols to include at least one action that can address the fault condition and/or a portion of the fault condition. For example, the ECM generator 330 can update the energy conservation protocol by adding a FIM, to the energy conservation protocols, that can address the fault condition. The ECM generator 330 can, in response to updating the energy conservation protocols, provide, the updated energy conservation protocols, to the database 340 and to the sustainability component 325. The database 340 can maintain the updated energy conservation protocols. The sustainability component 325 can execute the updated energy conservation protocols. For example, the sustainability component 325 can generate a work order than includes maintenance work that pertains to the pieces of equipment included in the fault condition.

The parameter component 420 can determine, using the data that pertains to the building, a current value of the parameter included in the sustainability target. For example, the parameter component 420 can include a current value for the energy consumption of the building that is included in the sustainability target. The parameter component 420 can determine the current value of the parameter in response to a predetermined amount of time. For example, the parameter component 420 can determine the current value after the energy conservation protocols have been established for 1 day, 1 month, 1 year or any other possible amount of time. The parameter component 420 can determine a difference between the current value of the parameter and the baseline value of the parameter. For example, the parameter can be water consumption, the current value can be 5,000 gallons and the baseline value can be 6,000 gallons. The parameter component 420 can determine, responsive to the difference between the current value and the baseline value being larger than a predetermined threshold, that the energy conservation protocols have impacted the parameter that pertains to the sustainability target.

The status component 415 can monitor, using the data that pertains to the building, a status of the energy conservation protocols and/or the actions included in the energy conservation protocols. For example, the status component 415 can monitor the status of a particular action (e.g., a FIM) included in the energy conservation protocols. The status component 415 can determine, responsive to monitoring the status of energy conservation protocols, that the status of the energy conservation protocols and/or the actions included in the energy conservation protocols have remained the same. For example, the status of a FIM can be that a piece of equipment will be replaced by a predetermined date. The status component 415 can determine, in response to the passing of the predetermine date, that the status of the FIM is the same (e.g., the piece of equipment was not replaced by the predetermined date).

In some embodiments, the status component 415 can, in response to determining that the status of the energy conservation protocols and/or the actions included in the energy conservation protocols have remained the same, can provide, to the communication component 320, an indication. The indication can be an indication that the status has remained the same. For example, the indication can be that the FIM included in the energy conservation protocol has not yet completed. The indication can also include information that pertains to a person, object or entity that pertains to the energy conservation protocols, the actions included in the energy conservation protocols and/or the pieces of building equipment associated with the energy conservation protocols and/or actions. For example, the indication can include the person or company that has been assigned to replace a piece of building equipment. The communication component 320 can, using the indication, identify a device (e.g., the user device 318) associated with the energy conservation protocols. The communication component 320 can, in response to identifying the device, provide, to the device, a signal that causes the device to display, via a user interface, a notice to execute at least one action that is included in the energy conservation protocol. For example, the notice can include an indication that a FIM has yet to be performed. The status component 415 can, in response to the communication component 320 providing the signal to the device, monitor the status of the energy conservation protocols.

The status component 415 can determine, using the data that pertains to the building, that the action included in the notice provided by the communication component 320 has been executed. The status component 415 can determine that the action has been executed by identifying at least one of data that has been produced by a new piece of equipment that was added to the building based on a FIM, an indication from the person or the company performing the FIM that the FIM has been completed, data that indicates the previous piece of equipment was removed (e.g., the piece of equipment is no longer sending data) or any other possible data that can indicate that the action included in the notice has been executed.

In some embodiments, the status component 415 can, responsive to determining that the action has been executed, detect that a first piece of building equipment has been replaced by a second piece of building equipment. The second piece of building equipment can perform a similar role to the first piece of building equipment. For example, the first piece of building equipment can be a boiler and the second piece of building equipment can also be a boiler.

The status component 415 can determine, responsive to the second piece of building equipment replacing the first piece of building equipment, an impact of the second piece of building equipment to at least one of the sustainability goal or the target sustainability level. For example, the status component 415 can determine an impact that the second piece of equipment can have on an amount of energy consumed by the building 10. To continue this example, the status component 415 can determine the impact by determining a difference between an amount of energy that was consumed by the first piece of building equipment over a certain amount of time and an amount of energy that the second piece of building equipment is predicted to consume of the same certain amount of time. The difference between the amount of energy that was consumed by the first piece of building equipment and the predicted amount of energy for the second piece of building equipment can indicate the impact that the second piece of building equipment can have on the sustainability goal and/or the target sustainability level.

The status component 415 can communicate with the communication component 320. The status component 415 can provide, to the communication component 320, the impact of the second piece of building equipment on the sustainability goal and/or the target sustainability level. The communication component 320 can, in response to receiving the impact of the second piece of building equipment on the sustainability goal and/or the target sustainability level, provide, to the data source 310 and/or the user device 318, the impact of the second piece of building equipment on the sustainability goal and/or the target sustainability level. The communication component 320 providing, to the user device 318, the impact of the second piece of building equipment on the sustainability goal and/or the target sustainability level can cause the user device 318 to display a user interface that includes the impact of the second piece of building equipment on the sustainability goal and/or the target sustainability level.

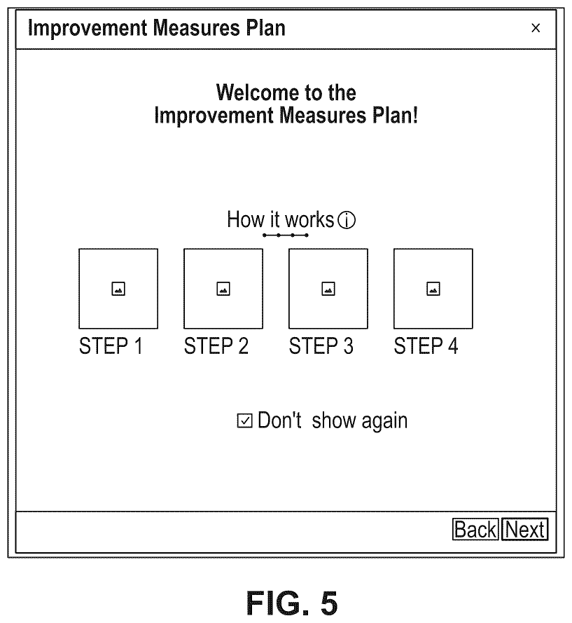

Referring now to FIG. 5, a user interface is displayed. The user interface can be shown, displayed, or otherwise provided by a device (e.g., the user device 318). The user interface can be displayed, in response to the ECM manager 305 providing signals to the device, by the device. The user interface can include a setup window. The setup window can pertain to at least one of building improvement plans, sustainability targets, energy conservation protocols and/or any other possible sustainability tracking that pertains to a building.

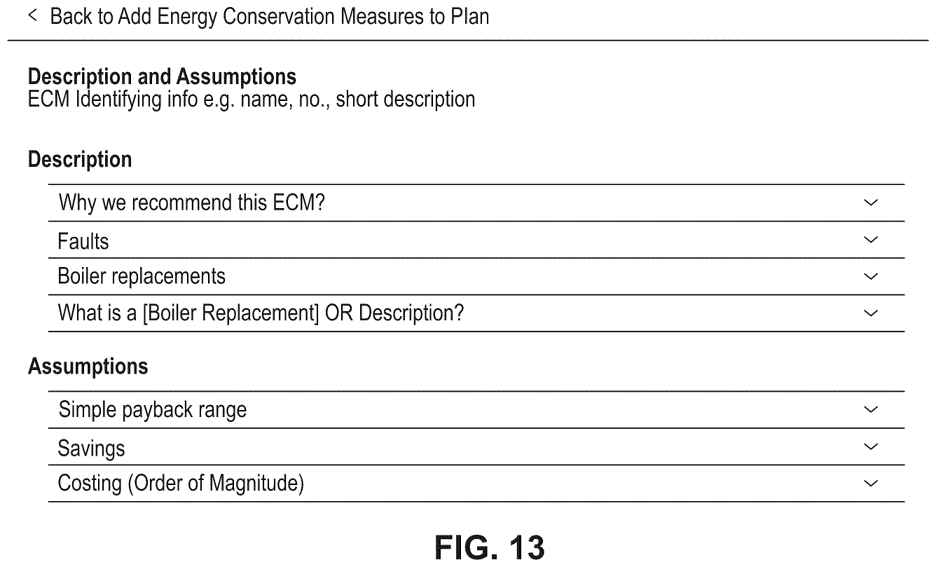

The setup window can be displayed by the device in response to an operator of the device establishing a sustainability target. For example, the setup window can be displayed after the operator has established a business level goal (e.g., a sustainability goal) or target sustainability level, a location level goal or target, a building level goal or target and/or a building sub-target goal or target similar to that described in U.S. Provisional Patent application No. 63/336,935 filed Apr. 29, 2022. The setup window can include at least one icon that indicates at least one step that can be taken, performed, or otherwise executed to generate at least one energy conservation protocol. For example, a step 1 icon can include information that the operator of the device displaying the user interface shown in FIG. 13 can generate an energy conservation protocol. The user interface can also include a back icon and a next icon. The operator can select the next icon to initiate the establishing of the energy conservation protocols. The operator can select the back icon to pause the establishing of the energy conservation protocols.

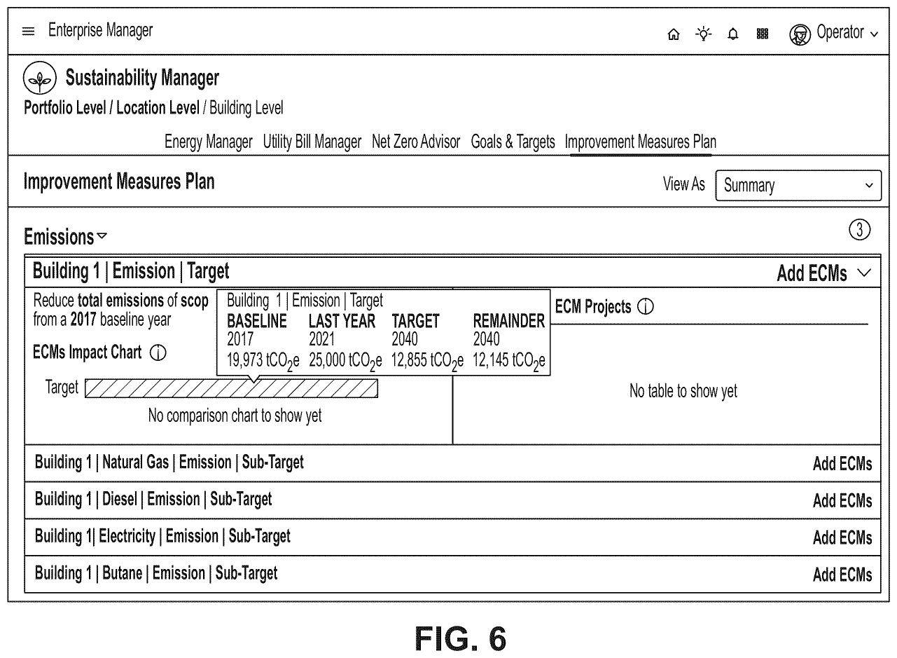

Referring now to FIG. 6, a user interface is shown, in accordance with an exemplary embodiment. The user interface can include an improvement measures plan dashboard. The user interface can be generated in response to the operator selecting the next icon shown in FIG. 5. The improvement measures plan dashboard can include a view as icon. The operator of the device displaying the user interface shown in FIG. 6 can hover over, select, or otherwise interact with the view as icon to adjust the view, appearance, or presentation of the improvement measures plan. The view as icon can include at least one option. For example, the view as icon can include a summary view, a table view, a timeline view and/or an estimated impact view. FIG. 6 depicts an example of the improvement measures plan dashboard in the summary view.

The improvement measures plan dashboard can include an emissions window. The emissions window can include information that pertains to a particular building. For example, FIG. 6 shows that the information pertains to building 1. The information can include a baseline value, a previous year value, a target value, and a remainder value that all pertain to the same parameter. FIG. 6 shows that the values all pertain to carbon emissions. The emissions window can also include sub-target windows that pertain to one or more sources of the emissions. FIG. 6 shows that the sub-targets windows can include a window for natural gas, diesel, electricity, and butane. The emission window as well as each sub-target window can include an add ECM icon. The operator of the device displaying the user interface shown in FIG. 6 can hover over, select, or other interact with at least one of the add ECM icons to add an ECM to that particular window. For example, the operator can add an ECM to the emissions window by selecting the add ECM icon that pertains to the emissions window.

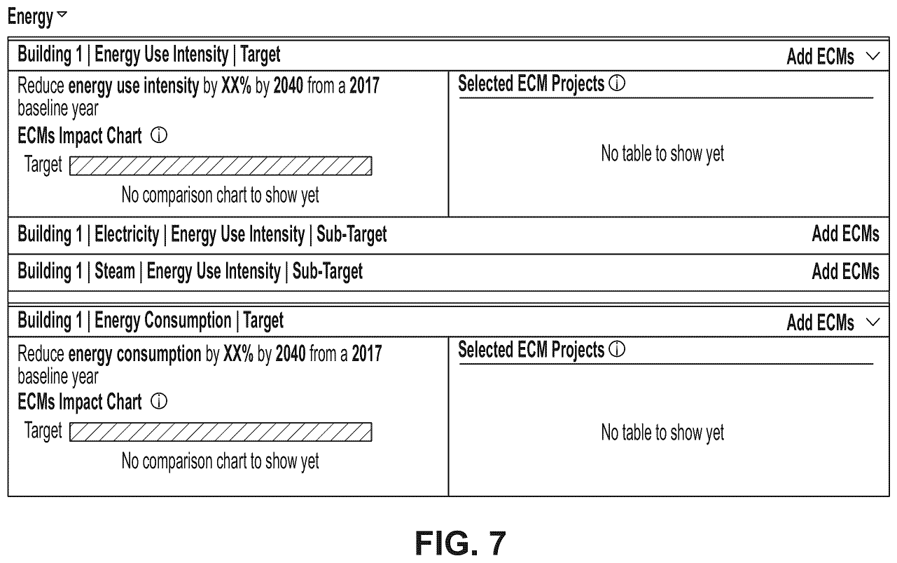

Referring now to FIG. 7, a user interface is shown, in accordance with an exemplary embodiment. The user interface can include the improvement measures plan dashboard and the improvement measures plan dashboard can include at least one energy window. The energy window can include at least one energy use intensity window and at least one energy consumption window. The user interface can be an extension of, a scroll down, an overlay, or otherwise included in or with the user interface shown in FIG. 6.

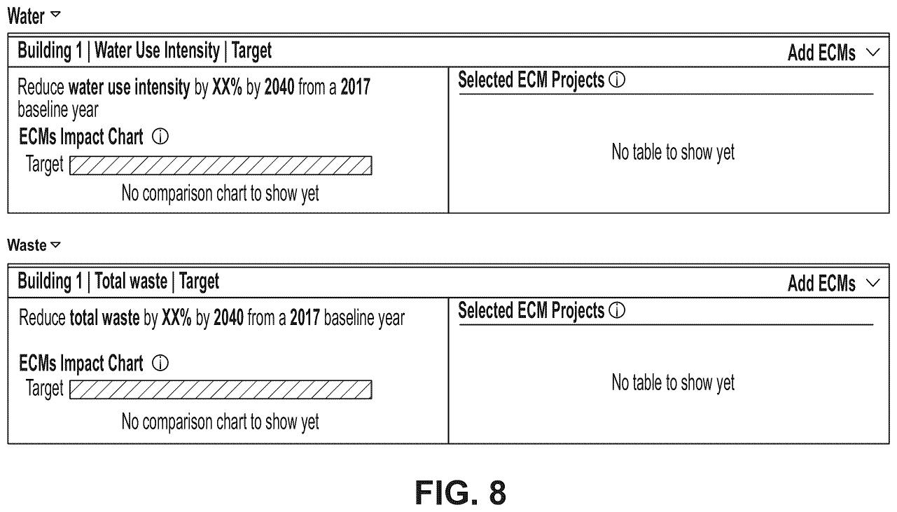

Referring now to FIG. 8, a user interface is shown, in accordance with an exemplary embodiment. The user interface can include the improvement measures plan dashboard and the improvement measures plan dashboard can include at least one water window and at least one waste window. The user interface can be an extension of, a scroll down, an overlay, or otherwise included in or with at least one the user interface shown in FIG. 6 and/or the user interface shown in FIG. 7.

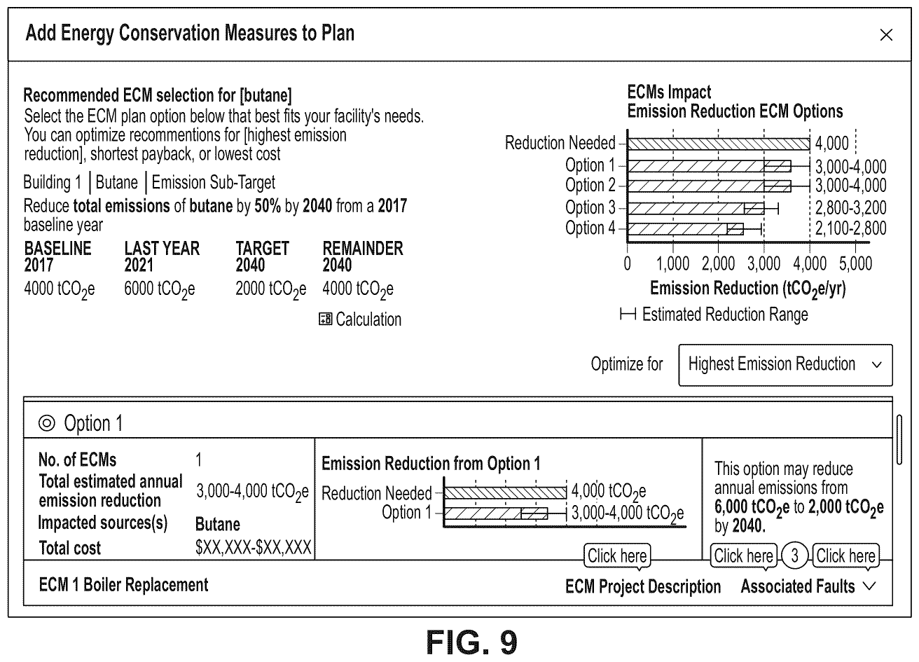

Referring now to FIG. 9, a user interface is shown, in accordance with an exemplary embodiment. The user interface can include an energy conservation measure window. The user interface shown in FIG. 9 can be generated in response to an operator selecting at least one of the add ECM icons shown in at least one of FIGS. 6-8. The user interface shown in FIG. 9 can be displayed, provided, shown, or otherwise presented as an overlay on top of at least one of the user interfaces shown in FIGS. 6-8. The user interface shown in FIG. 9 can also be generated as a new user interface that replaces a user interface previously shown by a device.

The user interface shown in FIG. 9 can include a ECMs impact chart. The ECMs impact chart can include a graphical representation of at least one sub-target goal that pertains to the sustainability target and/or the energy conservation protocols that were generated and/or obtained by the ECM manager 305. The ECMs impact chart can include a sub-target portion and at least one portion that pertains to at least one option (e.g., at least one FIM, action, etc.). The ECMs impact chart can show the impact that each option can have. FIG. 9 shows that the energy conservation measure window pertains to the butane emissions associated with building 1. FIG. 9 can also include at least one window that pertains to the options included in the ECMs impact chart.

FIG. 9 shows that option 1 pertains to replacing a boiler. The windows that pertain to the options can be filtered, sort or otherwise organized using an optimize for icon. The optimize for icon can include at least one option. For example, the optimize for icon can include a highest emission reduction option, a shortest payback period option and/or a lowest amount option. FIG. 9 depicts an example of the option windows being sorted by the highest emission reduction option. The user interface can also include a description and assumptions icon can provide additional information that pertains to a particular option window.

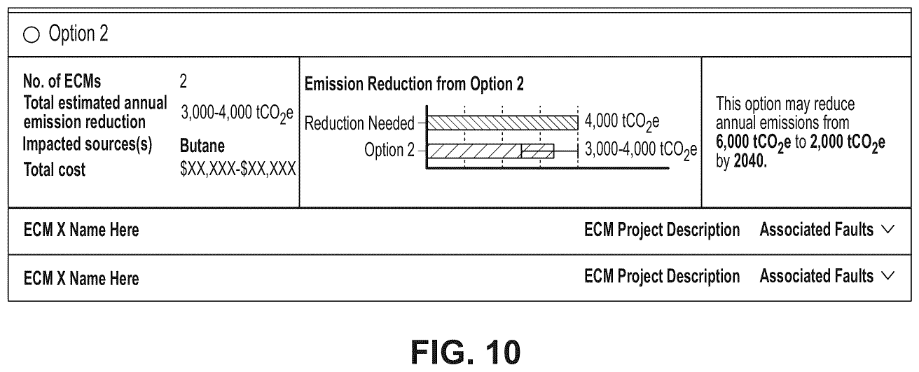

Referring now to FIG. 10, a user interface is shown, in accordance with an exemplary embodiment. The user interface can include an option window that pertains to at least one option that was included in an ECMs impact chart. The user interface can also include a customize icon and an accept and finish icon. The operator of the device displaying the user interface shown in FIG. 10 can select the customize icon to customize at least one of the options shown in the user interface. The operator can select the accept and finish icon to establish at least one option that has been selected by the operator. The filled in circle next to option 2 indicates that that operator has selected option 2. Option 2 can be established responsive to the operator selecting the accept and finish icon and/or option 2 can be customized responsive to the operator selecting the customize icon. The user interface shown in FIG. 10 can be an extension of, a scroll down, an overlay, or otherwise included in or with the user interface shown in FIG. 9. Similarly, the information shown in FIG. 10 can be displayed or shown in the user interface shown in FIG. 9

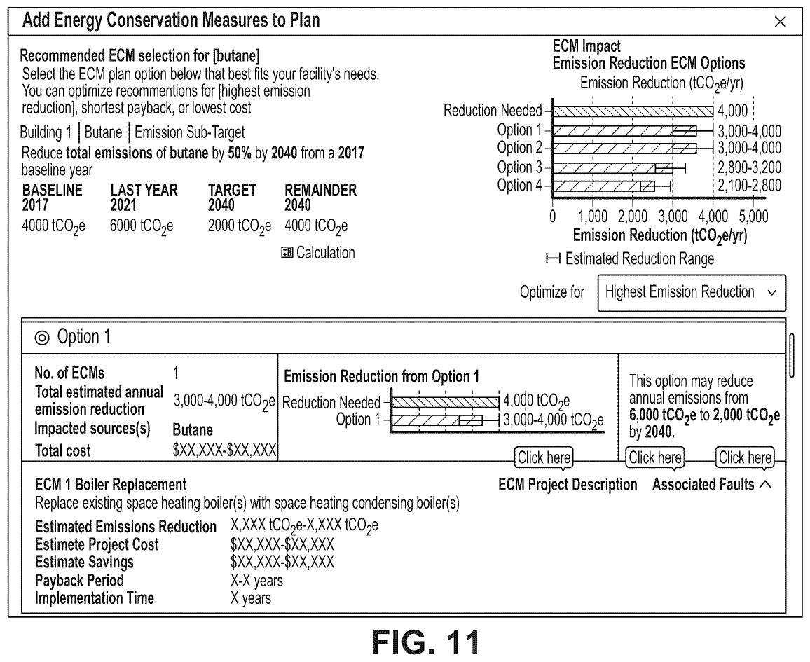

Referring now to FIG. 11, a user interface is shown, in accordance with an exemplary embodiment. FIG. 11 depicts an example of the user interface shown in FIG. 9 after the operator has selected the description and assumptions icon. A drop down window has opened to include information that pertains to option 1.

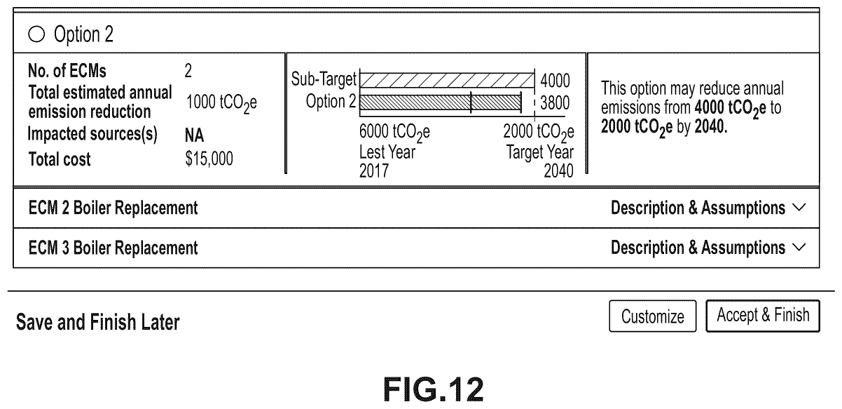

Referring now to FIG. 12, a user interface is shown, in accordance with an exemplary embodiment. FIG. 12 can include similar information to that shown in FIG. 10. FIG. 12 can be an extension of, a scroll down, an overlay, or otherwise included in or with the user interface shown in FIG. 11.

Referring now to FIG. 13, a user interface is shown, in accordance with an exemplary embodiment. The user interface can include a description window. The user interface shown in FIG. 13 can be displayed, provided, shown, or otherwise presented as an overlay on top of at least one of the user interfaces shown in FIGS. 9-12. The user interface shown in FIG. 13 can also be generated as a new user interface that replaces a user interface previously shown by a device. The user interface shown in FIG. 13 can include similar information to that shown in FIG. 11. The description window can provide information pertaining to why given ECMs where recommended, faults associated with building equipment, information pertaining a given ECM, a description of the given ECM, example payback ranges, savings associated with implementing ECMs, and/or amounts associated with ECMs.

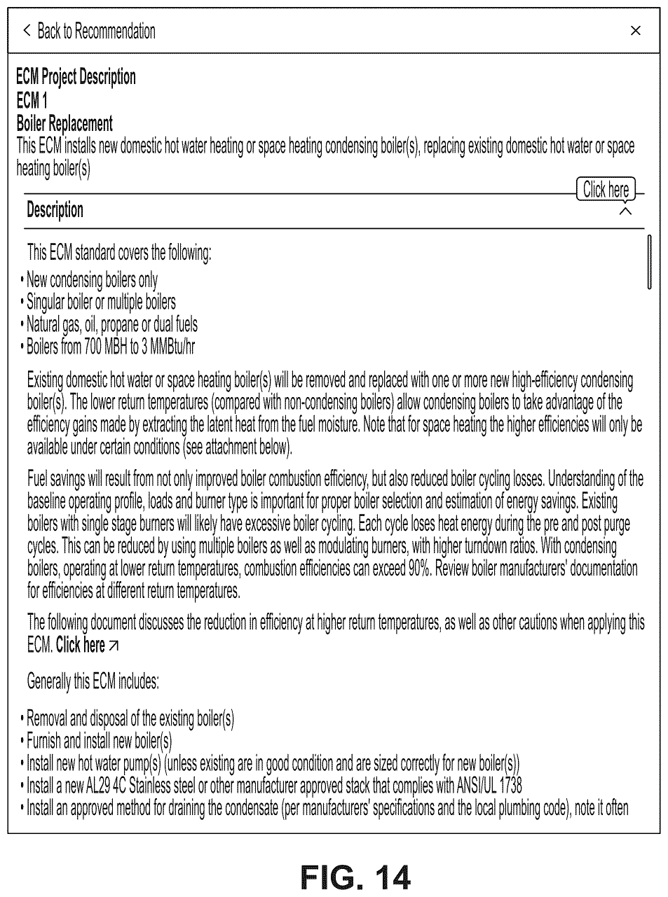

Referring now to FIG. 14, a user interface is shown, in accordance with an exemplary embodiment. The user interface can include a description window. The user interface shown in FIG. 14 can be the same user interface to that shown in FIG. 13. FIG. 14 shows the boiler replacements icon has been selected and that a window has opened to provide additional information that pertains to the boiler replacement that pertains to a particular ECM.

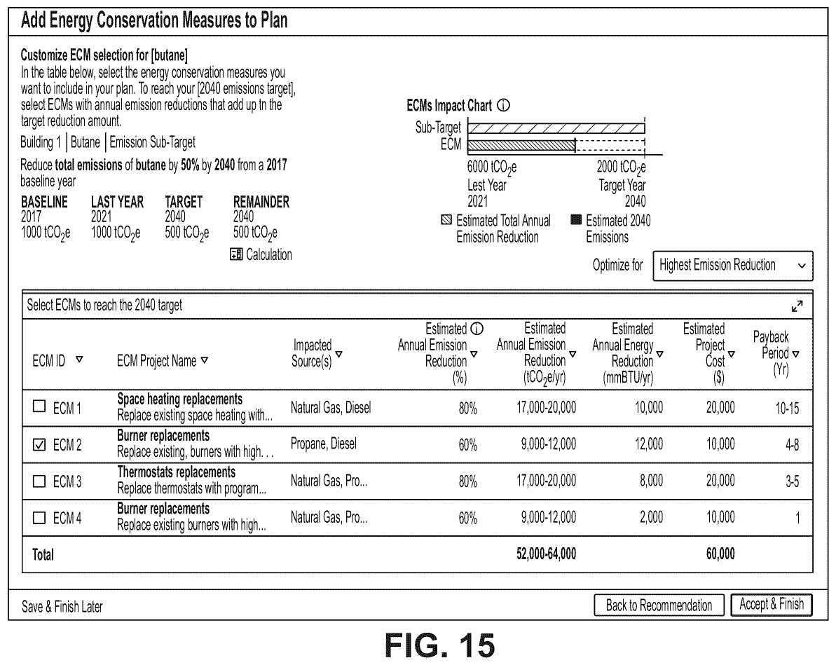

Referring now to FIG. 15, a user interface is shown, in accordance with an exemplary embodiment. The user interface can include a customization window that pertains to the improvement measures plan. The user interface shown in FIG. 15 can be generated in response to the operator selecting the customize icon shown in at least one of FIG. 10 or 12. The user interface shown in FIG. 15 can be displayed, provided, shown, or otherwise presented as an overlay on top of at least one of the user interfaces shown in FIGS. 9-12. The user interface shown in FIG. 15 can also be generated as a new user interface that replaces a user interface previously shown by a device. The user interface shown in FIG. 15 can include similar information to that shown in FIGS. 9-12. Additionally, the operator can customize, adjust, or otherwise update at least one of the options included in FIGS. 9-12.

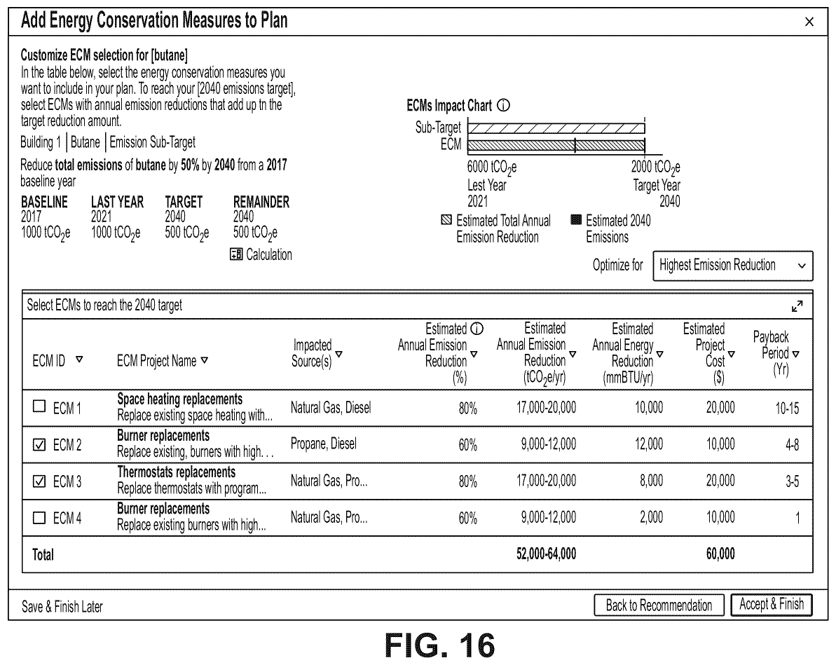

Referring now to FIG. 16, a user interface is shown, in accordance with an exemplary embodiment. The user interface can include a customization window that pertains to the improvement measures plan. The user interface shown in FIG. 16 can be generated in response to the operator selecting the customize icon shown in at least one of FIG. 10 or 12. The user interface shown in FIG. 16 can be displayed, provided, shown, or otherwise presented as an overlay on top of at least one of the user interfaces shown in FIGS. 9-12. The user interface shown in FIG. 16 can also be generated as a new user interface that replaces a user interface previously shown by a device. Additionally, the user interface shown in FIGS. 15 and 16 can be included within a single user interface (e.g., the user interfaces are combined).

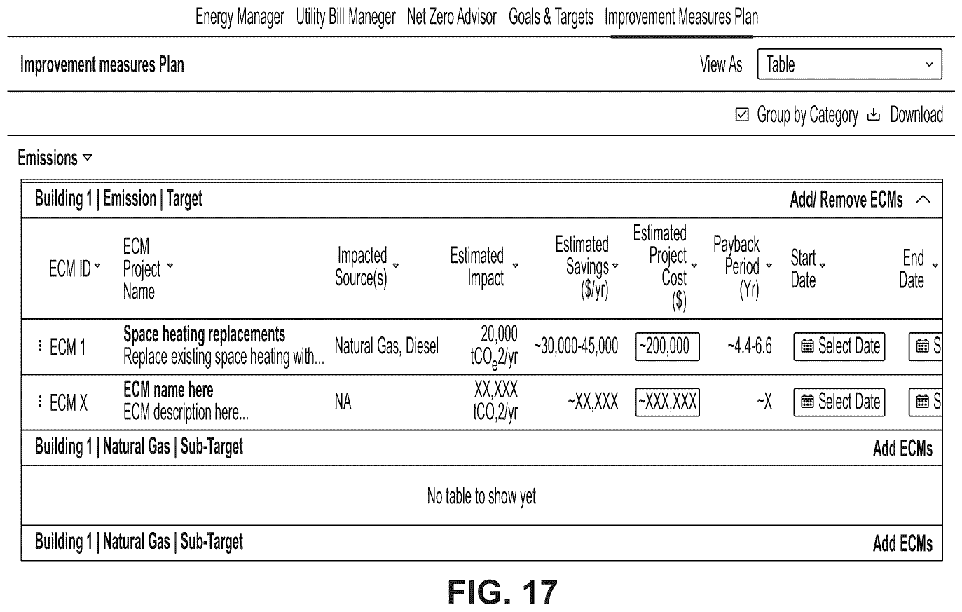

Referring now to FIG. 17, a user interface is shown, in accordance with an exemplary embodiment. The user interface shown in FIG. 17 can include the same improvement measures plan dashboard shown in at least one of FIGS. 6-8. FIG. 17 depicts an example view of the improvement measures plan dashboard responsive to the operator interacting with the view as icon and selecting the table option. Additionally, in response to the operator selecting the table option a group by category icon is shown to toggle between grouping and not grouping ECMs by category. The categories can be or include the different sustainability categories (emission, energy, water and/or waste) described herein. The categories can also include the sources that pertain to each category. For example, the emission category can include natural gas, diesel, propane, butane, electricity, or any other possible emission source.

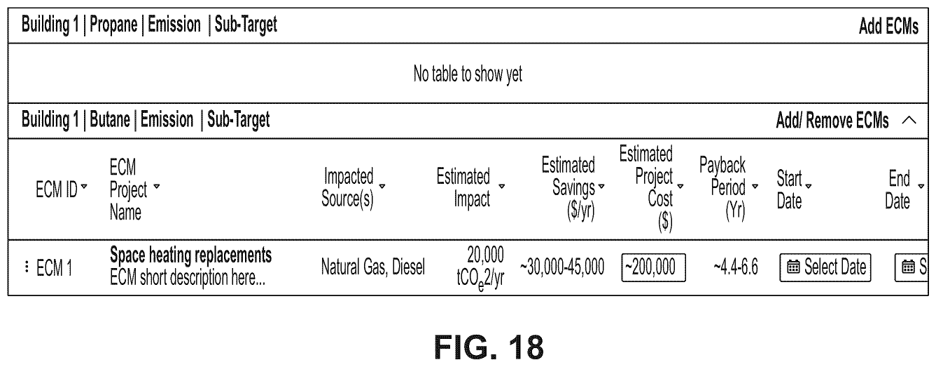

Referring now to FIG. 18, a user interface is shown, in accordance with an exemplary embodiment. The user interface shown in FIG. 18 can include the improvement measures plan dashboard described herein. The user interface can also include a window that pertains to the emission source butane. The window can include ECMs that can impact emissions associated with butane. The user interface can be an extension of, a scroll down, an overlay, or otherwise included in or with the user interface shown in FIG. 17. Additionally, the user interface shown in FIGS. 17 and 18 can be included within a single user interface (e.g., the user interfaces are combined).

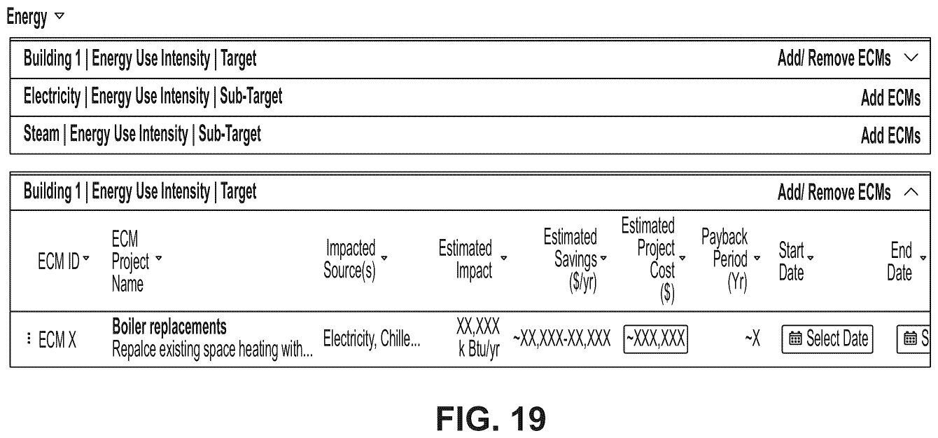

Referring now to FIG. 19, a user interface is shown, in accordance with an exemplary embodiment. The user interface shown in FIG. 19 can include the improvement measures plan dashboard described herein. The user interface can also include a window that pertains to energy category. The window can include ECMs that impact the energy use intensity and/or the energy consumption associated with the building. The user interface can be an extension of, a scroll down, an overlay, or otherwise included in or with at least one the user interfaces shown in FIGS. 17-18. Additionally, the user interfaces shown in FIGS. 17, 18, and 19 can be included within a single user interface (e.g., the user interfaces are combined).

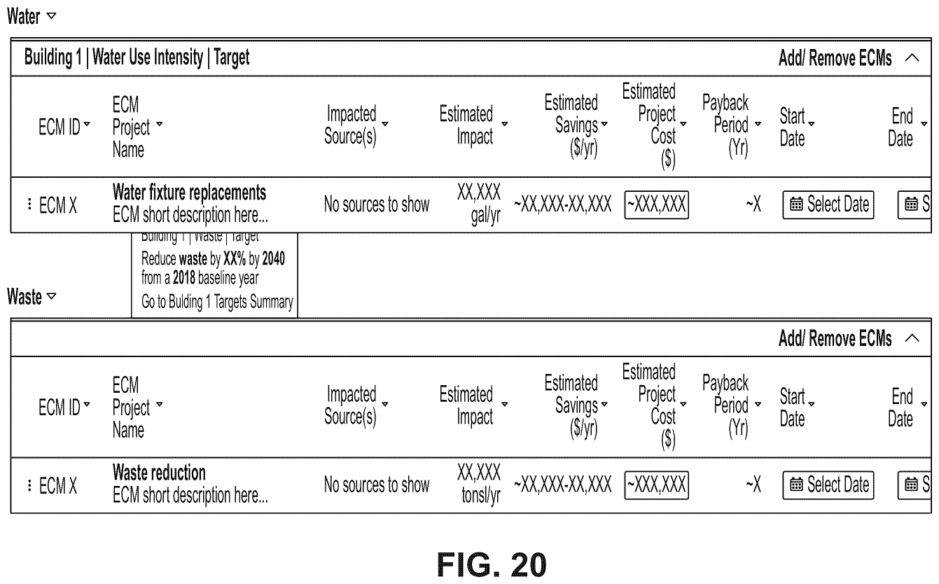

Referring now to FIG. 20, a user interface is shown, in accordance with an exemplary embodiment. The user interface shown in FIG. 20 can include the improvement measures plan dashboard described herein. The user interface can also include a window that pertains to water category and/or the waste category. The window can include ECMs that impact the water use intensity and/or the waste production associated with the building. The user interface can be an extension of, a scroll down, an overlay, or otherwise included in or with at least one the user interfaces shown in FIGS. 17-19. Additionally, the user interface shown in FIGS. 17, 18, 19, and 20 can be included within a single user interface (e.g., the user interfaces are combined).

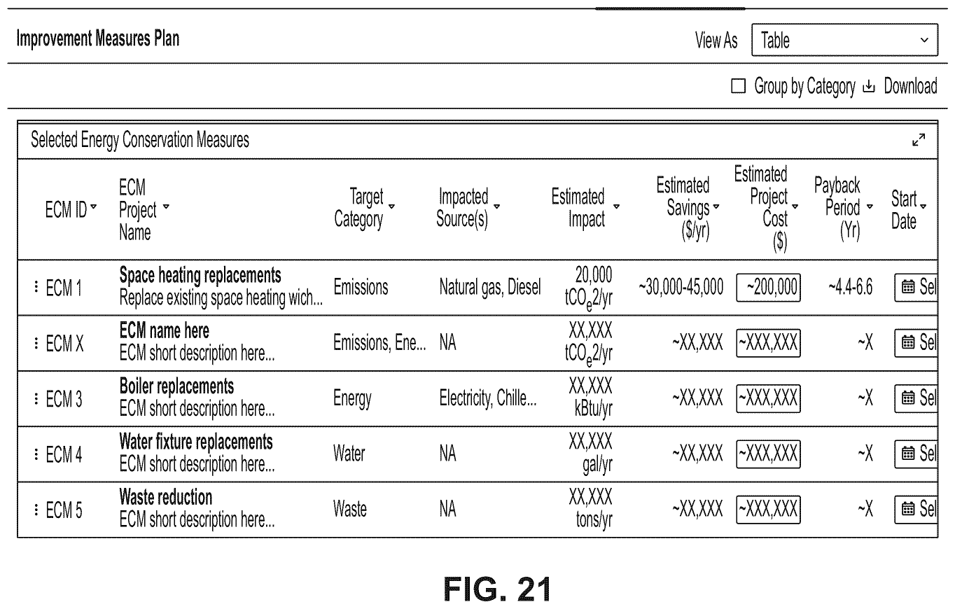

Referring now to FIG. 21, a user interface is shown, in accordance with an exemplary embodiment. The user interface can include the improvement measures plan dashboard and the user interface can include similar information to that of FIGS. 6-8 and/or 17-20. The user interface shown in FIG. 21 can be displayed, shown, or otherwise generated in response to the operator unselecting the group by category icon shown in FIG. 17. Additionally, the user interface shown in FIG. 21 can be displayed, shown, or otherwise generated in response to the operator interacting with the view as icon shown in FIG. 6 and selecting the table option.

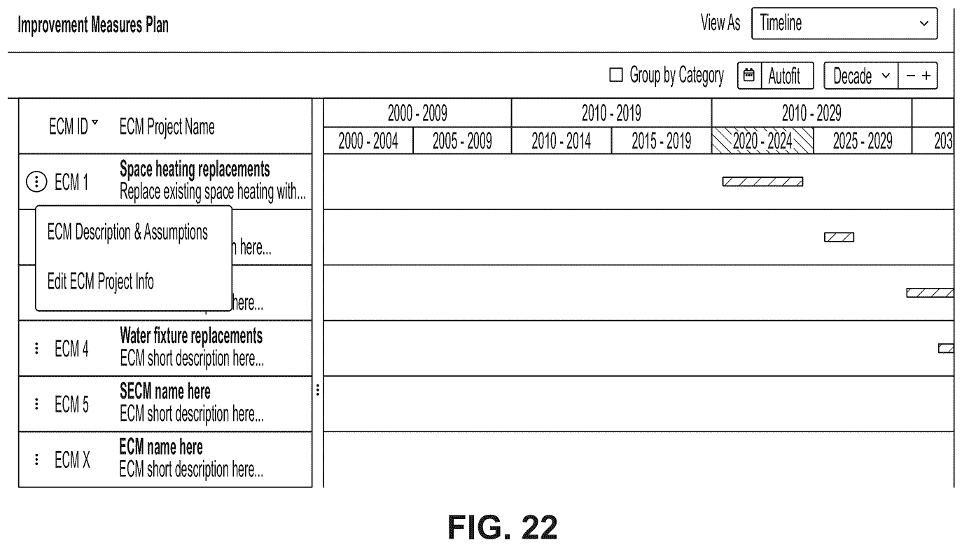

Referring now to FIG. 22, a user interface is shown, in accordance with an exemplary embodiment. The user interface can include the improvement measures dashboard. FIG. 22 depicts an example of the information associated with the improvement measures dashboard being displayed in the timeline view. As shown in FIG. 22 the dashboard can include at least one ECM associated with the building and timeline chart that pertains to each ECM. The timeline chart can provide a graphical representation of a predicted amount of time that the ECM can take to be either completed or fully executed. The amount of time can be the duration of time it will take to perform a FIM (e.g., replace a piece of equipment). The amount of time can also be how long the ECM can be in place prior to a target value being reached. For example, the ECM is replacing a boiler and the amount of time for the new boiler to decrease the emissions associated with the building by a predetermined amount is 3 years. The operator can adjust the graphical representation shown in FIG. 22 to represent at least one of days, months, years, decades and or any other possible amount of time.

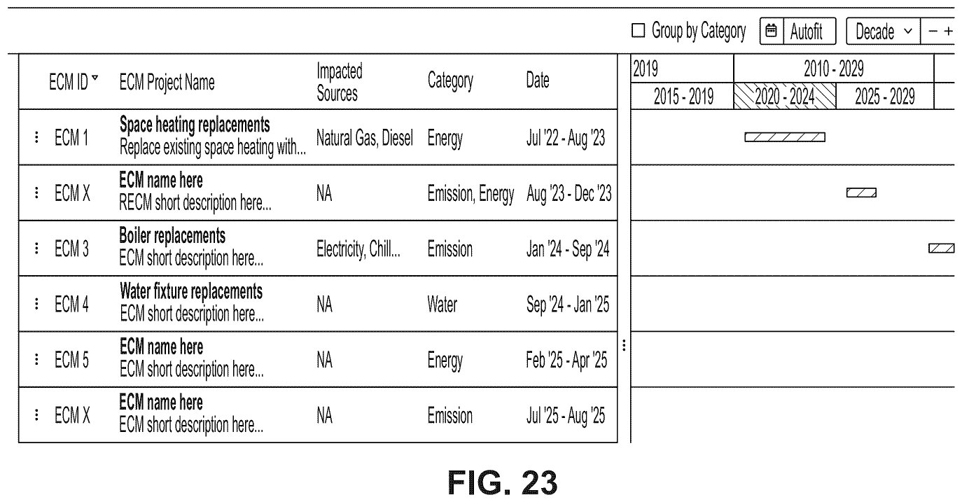

Referring now to FIG. 23, a user interface is shown, in accordance with an exemplary embodiment. The user interface can include the improvement measures dashboard. The user interface shown in FIG. 23 shows an expanded view of the ECMs that pertain to the building and a collapsed view of the predicted amount of time that pertains to each ECM. The user interface shown in FIG. 23 can be an extension of, a scroll down, an overlay, or otherwise included in or with the user interfaces shown in FIG. 22. For example, the operator of the device displaying the user interface shown in FIG. 23 can hover over, interact with, or otherwise move at least one of the ECMs or the predicted amount of time to either expand or collapse the ECMs or the predicted amount of time.

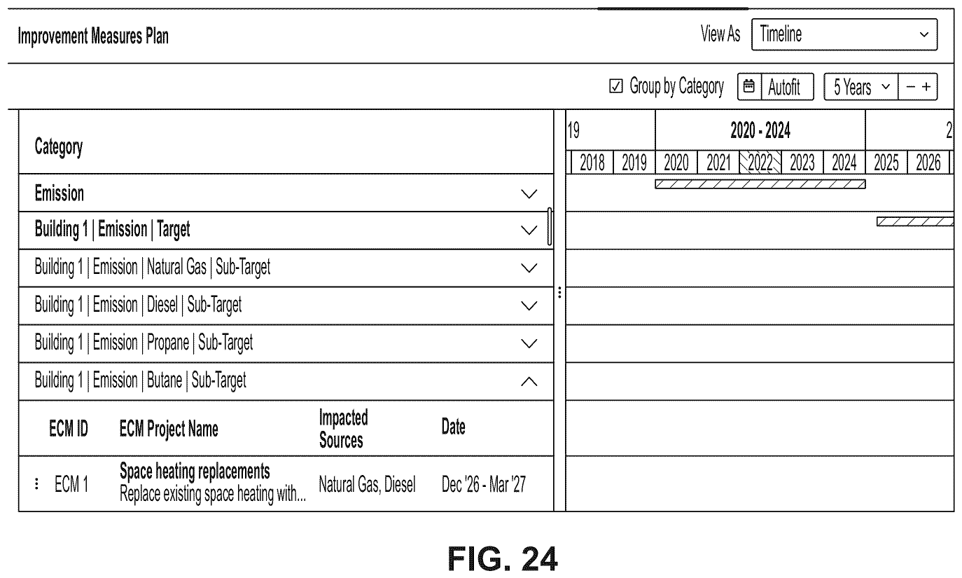

Referring now to FIG. 24, a user interface is shown, in accordance with an exemplary embodiment. The user interface can include the improvement measures dashboard. The user interface can also include a view of the ECMs sorted by category that is similar to the view shown in at least one of FIGS. 17-20. The user interface includes a view of the ECMs associated with the emission category. The user interface shown in FIG. 24 can be an extension of, a scroll down, an overlay, or otherwise included in or with at least one the user interfaces shown in FIG. 22 or 23. Additionally, the user interfaces shown in FIGS. 22, 23, and 24 can be included within a single user interface (e.g., the user interfaces are combined).

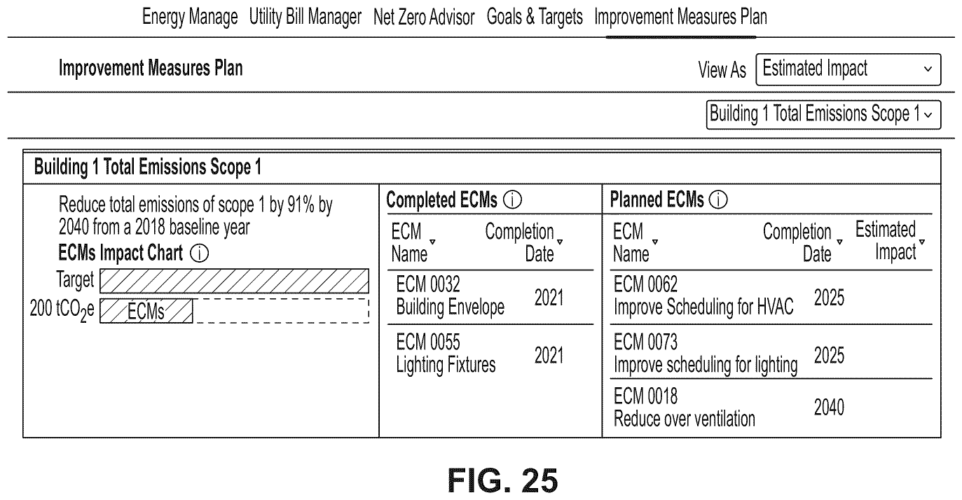

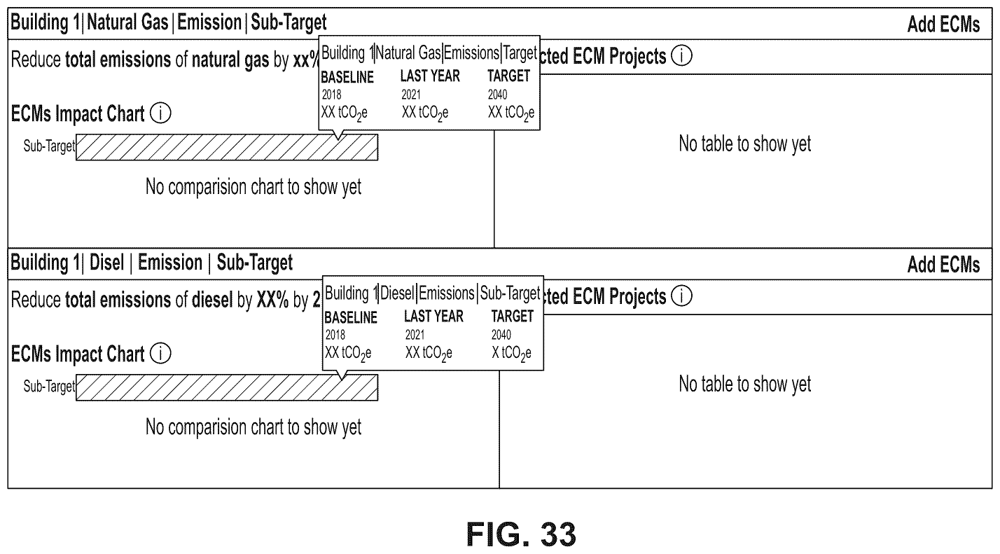

Referring now to FIG. 25, a user interface is shown, in accordance with an exemplary embodiment. The user interface can include the improvement measures plan dashboard. The user interface can provide information that pertains to the ECMs of building 1. The user interface can include the ECMs impact chart described herein. The ECMs impact chart can include the target value that pertains to the sustainability target and a progress towards the target. The progress towards the target can include the progress that has been made by incorporating, executing, or otherwise performing ECMs. The improvement measures plan dashboard can include a list of completed ECMs and a list of planned ECMs. The operator of the device can filter, sort or other organize the information shown in FIG. 33 by selecting the icon below the view as icon. The information can be provided in relation to the building sustainability target, the building level goal, sustainability categories, the sub-targets that relate to the sustainability categories and/or any other possible combination. Additionally, the user interface shown in FIG. 25 can be displayed, shown, or otherwise generated in response to the operator interacting with the view as icon shown in at least one FIGS. 6, 17, 22, and/or 24 and selecting the estimated impact option.

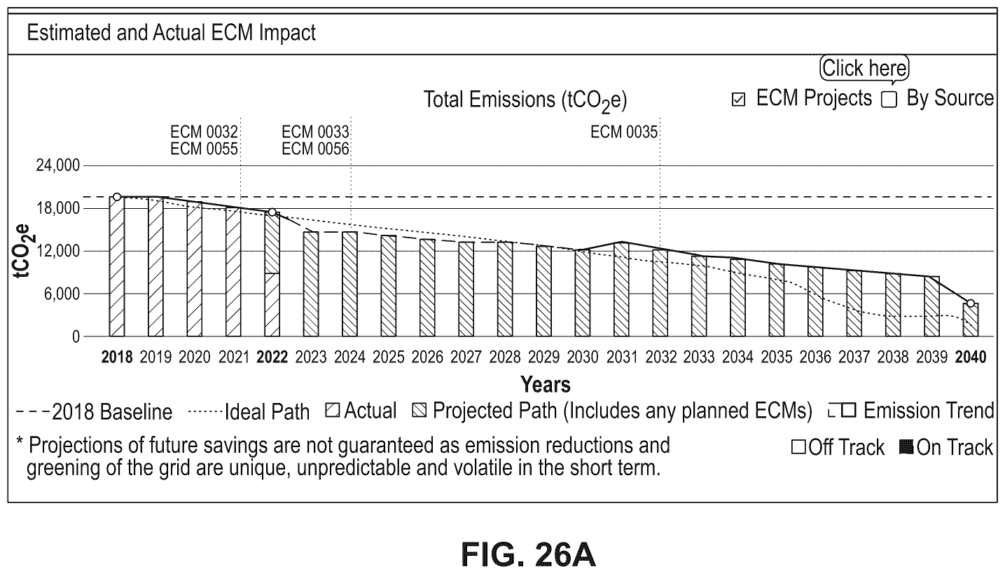

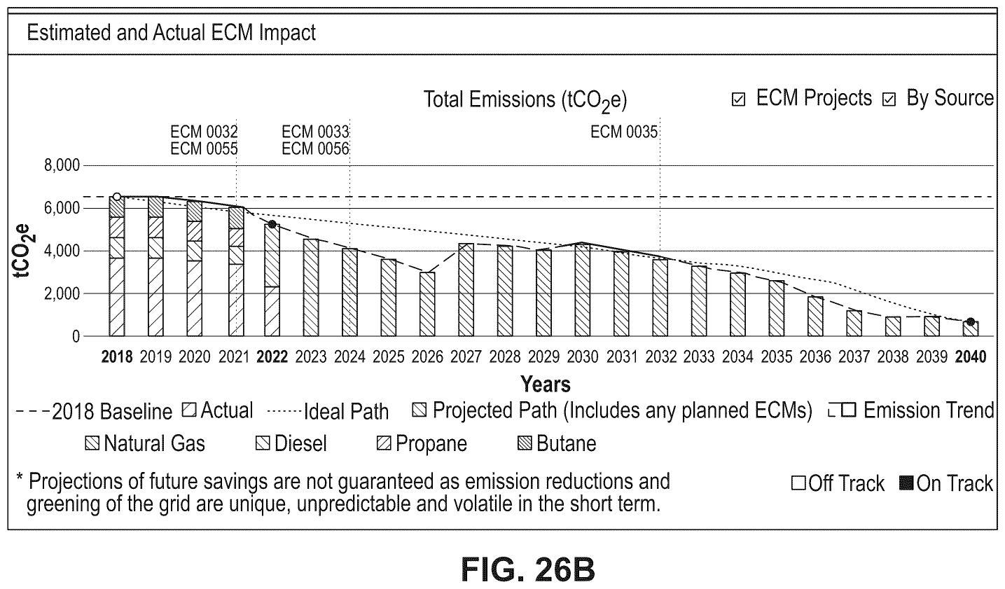

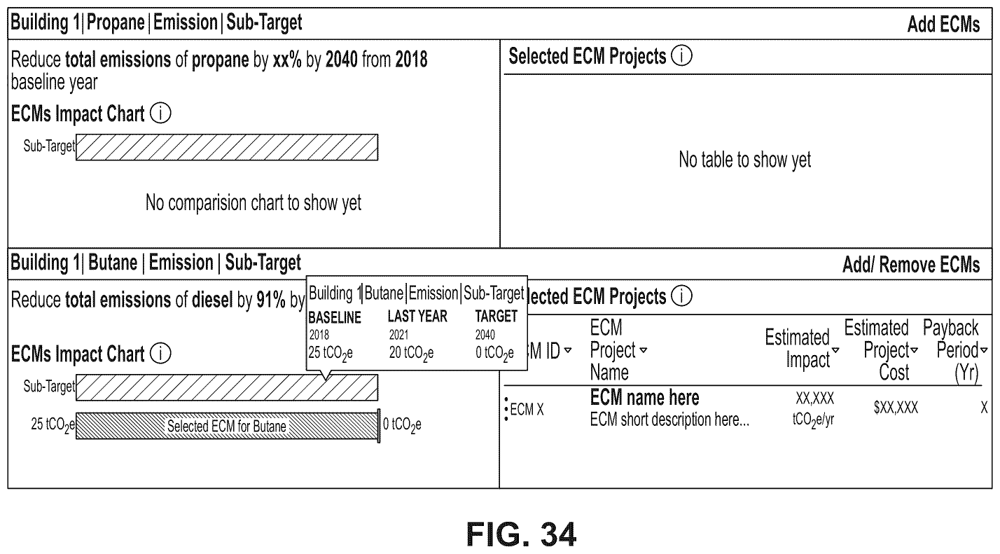

Referring now to FIG. 26A, a user interface is shown, in accordance with an exemplary embodiment. The user interface can include a graphical representation of ECM tracking. The graphical representation depicted by the user interface can be based on ECM projects. The graphical representation depicted by the user interface can also be based on the sources that contribute to parameters associated with the sustainability target. The user interface can include the baseline value that pertains to parameters associated with the sustainability target. For example, the user interface can include the baseline value of the total emission that pertain to a building (e.g., building 10). Similarly, the user interface can include the baseline value that pertains to at least one of the sustainability categories (e.g., emissions, energy, water, waste, etc.). The user interface can include the impact that at least one ECM can have on the value of the parameter. For example, FIG. 26A shows that ECM 0032 and ECM 0055 upon completion can reduce the carbon emissions from 20,000 to 18,000 tCO2e/yr. Similarly, FIG. 26A shows that ECM 0033 and ECM 0056 upon completion can reduce the carbons emissions from 18,000 to 15,000 tCO2e/yr. Additionally, FIG. 26A shows that ECM 0035 upon completion can reduce the carbon emissions from 15,000 to 12,000 tCO2e/yr. The operator of the device displaying the user interface shown in FIG. 34A can adjust, modify, or otherwise change how the information is presented by hovering over, interacting with, or selecting at least one of a show sources icon, a completed ECMs icon and/or a planned ECMs icon. The user interface show in FIG. 26A can be an extension of, a scroll down, an overlay, or otherwise included in or with the user interface shown in FIG. 24.

Referring now to FIG. 26B, a user interface is shown, in accordance with an exemplary embodiment. The user interface includes a graphical representation of ECM tracking including impacts contributed to ECM projects as well as a by source view. The by source view depicts the impact that ECM projects have to each source that contribute to the sustainability parameters and/or the sustainability target. FIG. 26B depicts an example of the ECM projects impacting natural gas consumption, diesel consumption, propane consumption, and butane consumption. The user interface shown in FIG. 26B can be and/or include information similar to that shown in FIG. 26A. Similarly, the user interface shown in FIG. 26B can be at least one of an extension to the user interface shown in FIG. 26A, a scroll down, an overlay, or otherwise included in or with the user interface shown in FIG. 26A. The user interface shown in FIG. 26B can be generated responsive to an operator of the device displaying the user interface shown in FIG. 26B and/or FIG. 26A selecting the by source icon.

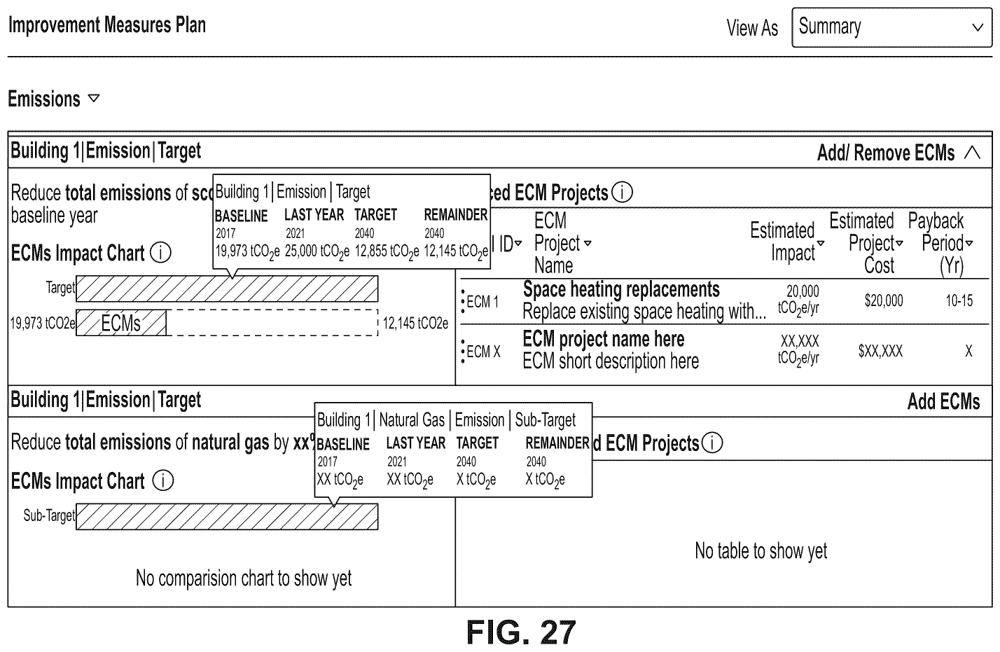

Referring now to FIG. 27, a user interface is shown, in accordance with an exemplary embodiment. The user interface can include an improvement measures plan dashboard. The improvement measures plan dashboard can include information about the same building to that of FIG. 6 and/or the improvement measures plan dashboard can include information about a different building to that of FIG. 6. The user interface can be generated in response to the operator selecting the next icon shown in FIG. 5. The improvement measures plan dashboard can include a view as icon. The operator of the device displaying the user interface shown in FIG. 27 can hover over, select, or otherwise interact with the view as icon to adjust the view, appearance, or presentation of the improvement measures plan. FIG. 27 can include information that pertains to the emission category associated with the building. Additionally, FIG. 27 shows that at least one ECM has been generated, established, customized, or otherwise associated with the emission category of the building. FIG. 27 also includes information that pertains to the natural gas emission source that impacts the emissions category.

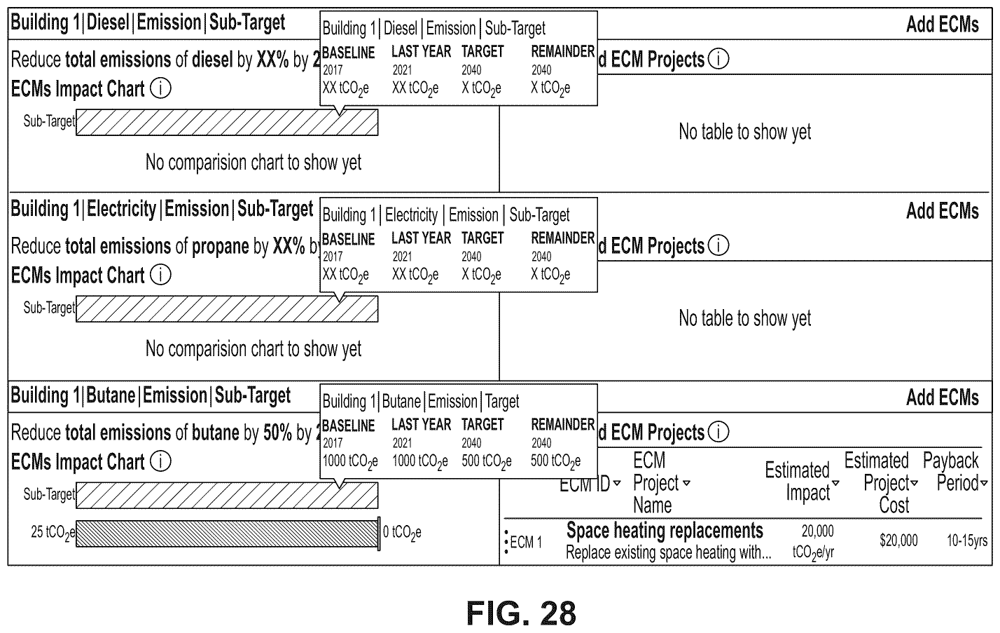

Referring now to FIG. 28, a user interface is shown, in accordance with an exemplary embodiment. The user interface can include the improvement measures plan dashboard. The user interface can include at least one window that includes information that pertains to the diesel emission source, the electricity emission source and/or the butane emission source that pertain to the emission category shown in FIG. 27. The butane window can include a ECMs impact chart that indicates that an ECM has been established, executed, or otherwise implemented that can result in the target value associated with butane being reached. The user interface show in FIG. 28 can be an extension of, a scroll down, an overlay, or otherwise included in or with the user interface shown in FIG. 27. Additionally, the user interfaces shown in FIGS. 27 and 28 can be included within a single user interface (e.g., the user interfaces are combined).

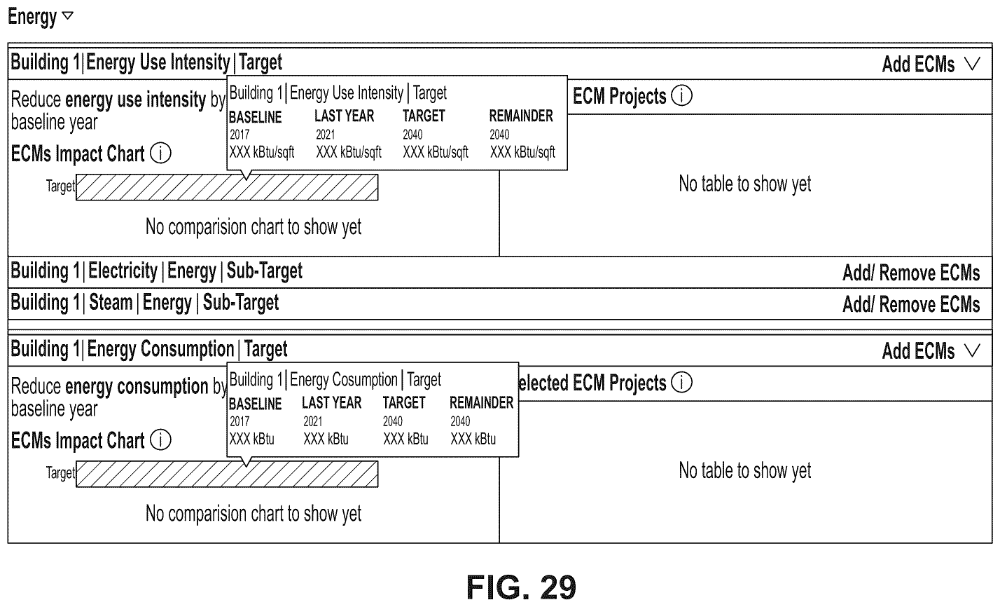

Referring now to FIG. 29, a user interface is shown, in accordance with an exemplary embodiment. The user interface can include the improvement measures plan dashboard. The user interface can include at least one window that includes information that pertains to the energy sustainability category. The user interface can provide an indication that an ECM has not been established, executed, or otherwise implemented in relation to the energy use intensity parameter and/or the energy consumption parameter. The user interface show in FIG. 29 can be an extension of, a scroll down, an overlay, or otherwise included in or with the user interface shown in FIGS. 27 and/or 28. Additionally, the user interfaces shown in FIGS. 27, 28, and 29 can be included within a single user interface (e.g., the user interfaces are combined).

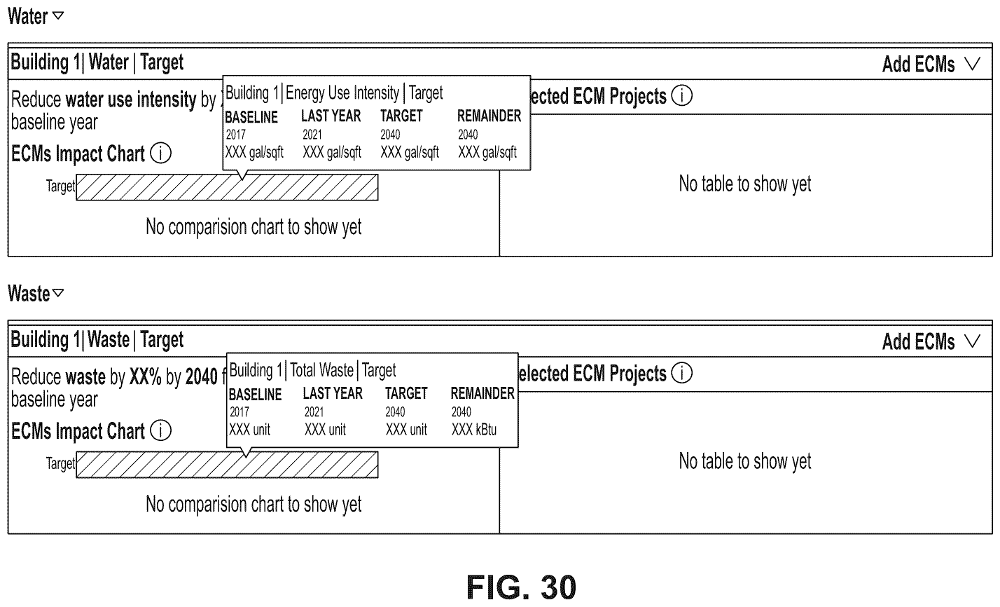

Referring now to FIG. 30, a user interface is shown, in accordance with an exemplary embodiment. The user interface can include the improvement measures plan dashboard. The user interface can include at least one window that includes information that pertains to the water sustainability category and/or the waste sustainability category. The user interface can provide an indication that an ECM has not been established, executed, or otherwise implemented in relation to the water use intensity parameter and/or the waste parameter. The user interface show in FIG. 30 can be an extension of, a scroll down, an overlay, or otherwise included in or with the user interface shown in FIGS. 27, 28, and/or 29. Additionally, the user interfaces shown in FIGS. 27, 28, 29, and/or 30 can be included within a single user interface (e.g., the user interfaces are combined).

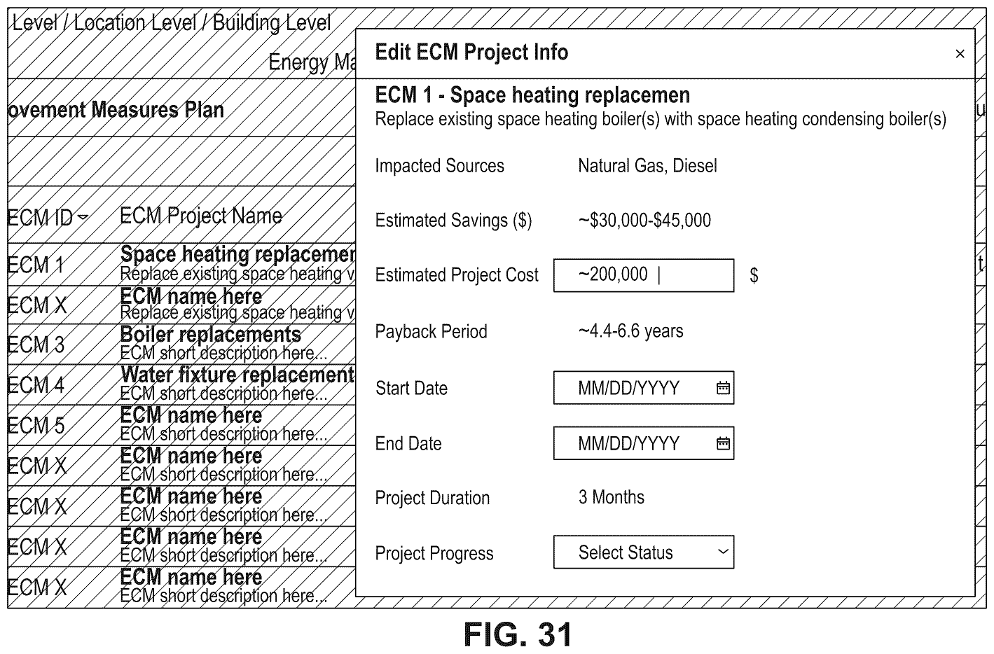

Referring now to FIG. 31, a user interface is shown, in accordance with an exemplary embodiment. The user interface can include an energy conservation window. The user interface shown in FIG. 31 can be a pop window, an overlay on top of and/or otherwise included in at least one of the user interfaces described herein. The energy conservation window can include a start date and an end date icon. The operator of the device display the user interface shown in FIG. 31 can hover over, interact with, or otherwise select a start date and an end date for the ECM shown in FIG. 31. Additionally, the operator can select the status of the ECM. The status can be at least one established, paused, declined, accepted and/or any other possible status.

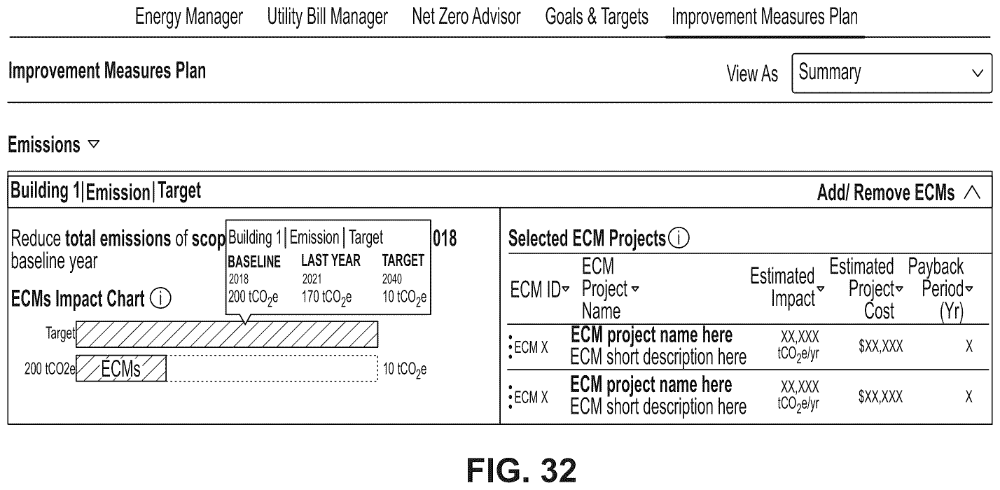

Referring now to FIG. 32, a user interface is shown, in accordance with an exemplary embodiment. The user interface can include an improvement measures plan dashboard. The improvement measures plan dashboard can include information about the same building to that of FIG. 6 or 27 and/or the improvement measures plan dashboard can include information about a different building to that of FIG. 6 or 27. The user interface can be generated in response to the operator selecting the next icon shown in FIG. 5. The improvement measures plan dashboard can include a view as icon. The operator of the device displaying the user interface shown in FIG. 32 can hover over, select, or otherwise interact with the view as icon to adjust the view, appearance, or presentation of the improvement measures plan. FIG. 32 can include information that pertains to the emission sustainability category associated with the building. Additionally, FIG. 32 shows that at least one ECM has been generated, established, customized, or otherwise associated with the emission category of the building.

Referring now to FIG. 33, a user interface is shown, in accordance with an exemplary embodiment. The user interface can include the improvement measures plan dashboard. The user interface can include at least one window that includes information that pertains to the natural gas emission source and the diesel emission source that pertain to the emission sustainability category shown in FIG. 32. The user interface show in FIG. 33 can be an extension of, a scroll down, an overlay, or otherwise included in or with the user interface shown in FIG. 32. Additionally, the user interfaces shown in FIGS. 32 and 33 can be included within a single user interface (e.g., the user interfaces are combined).

Referring now to FIG. 34, a user interface is shown, in accordance with an exemplary embodiment. The user interface can include the improvement measures plan dashboard. The user interface can include at least one window that includes information that pertains to the propane emission source and the butane emission source that pertain to the emission sustainability category shown in FIG. 32. The butane window can include a ECMs impact chart that indicates that an ECM has been established, executed, or otherwise implemented that can result in the target value associated with butane being reached. The butane window is also shown to include an add/remove ECMs icon given that an ECM has been established for butane. Additionally the propane window is shown to only have the add ECMs icon given that an ECM has not yet been established for propane. The user interface show in FIG. 34 can be an extension of, a scroll down, an overlay, or otherwise included in or with the user interfaces shown in FIGS. 32 and 33. Additionally, the user interfaces shown in FIGS. 32, 33, and 34 can be included within a single user interface (e.g., the user interfaces are combined).

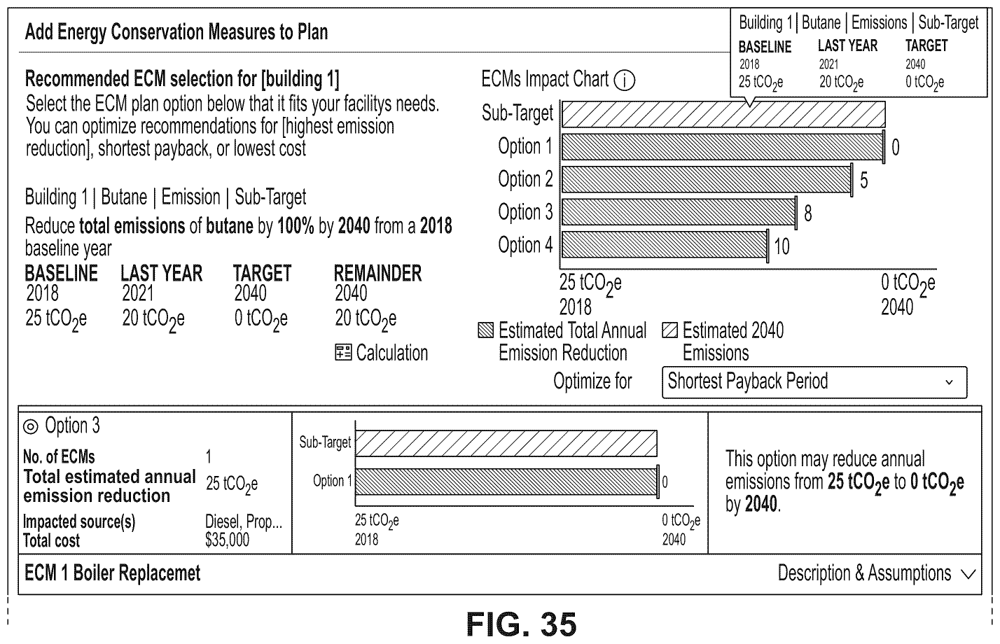

Referring now to FIG. 35, a user interface is shown, in accordance with an exemplary embodiment. The user interface can include an energy conservation measure window. The user interface shown in FIG. 35 can be generated in response to an operator selecting at least one of the add ECM icons shown in at least one of FIGS. 6-8, 17-20, 27-30, and/or 32-34. The user interface shown in FIG. 35 can be displayed, provided, shown, or otherwise presented as an overlay on top of at least one of the user interfaces shown in FIGS. 6-8, 17-20, 27-30, and/or 32-34. The user interface shown in FIG. 35 can also be generated as a new user interface that replaces a user interface previously shown by a device.

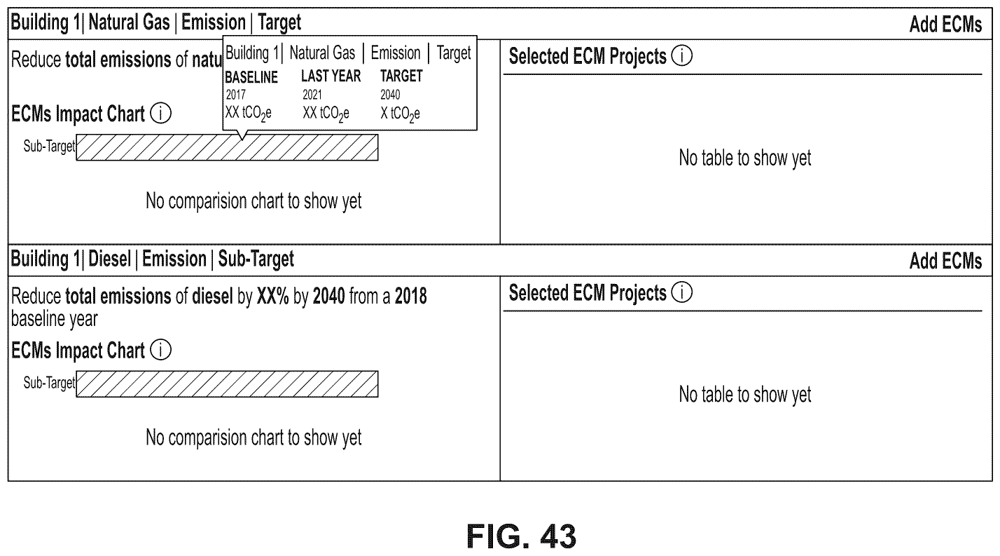

The user interface shown in FIG. 35 can include a ECMs impact chart. The ECMs impact chart can include a graphical representation of at least one sub-target goal that pertains to the sustainability target and/or the energy conservation protocols that were generated and/or obtained by the ECM manager 305. The ECMs impact chart can include a sub-target portion and at least one portion that pertains to at least one option (e.g., at least one FIM, action, etc.). The ECMs impact chart can show the impact that each option can have. FIG. 43 shows that the energy conservation measure window pertains to the butane emissions associated with building 1. FIG. 35 can also include at least one window that pertains to the options included in the ECMs impact chart.

FIG. 35 shows that option 3 pertains to replacing a boiler. The windows that pertain to the options can be filtered, sort or otherwise organized using an optimize for icon. The optimize for icon can include at least one option. For example, the optimize for icon can include a highest emission reduction option, a shortest payback period option and/or a lowest amount option. FIG. 35 depicts an example of the option windows being sorted by the shortest payback period option. The user interface can also include a description and assumptions icon that can provide additional information that pertains to a particular option window.

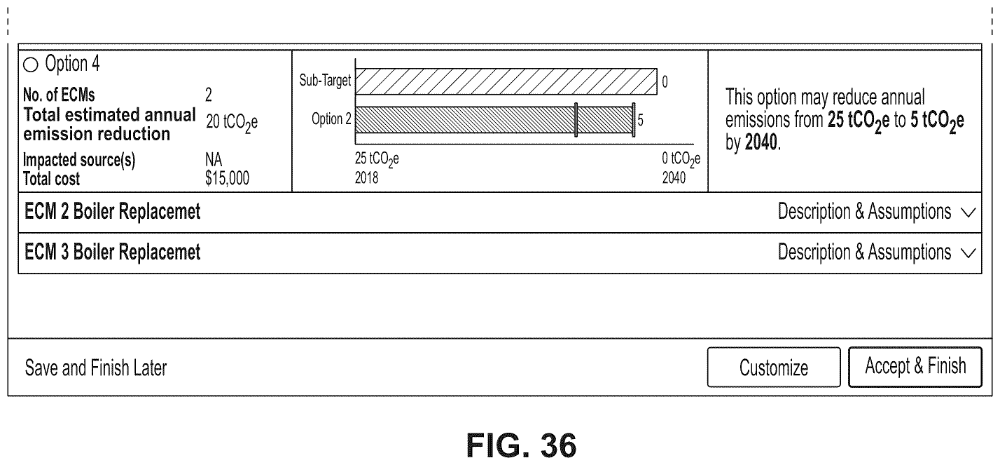

Referring now to FIG. 36, a user interface is shown, in accordance with an exemplary embodiment. The user interface can include an option window that pertains to at least one option that was included in an ECMs impact chart. The user interface can also include a customize icon and an accept and finish icon. The operator of the device displaying the user interface shown in FIG. 35 can select the customize icon to customize at least one of the options shown in the user interface. The operator can select the accept and finish icon to establish at least one option that has been selected by the operator. The empty circle next to option 2 indicates that that operator has yet to select option 2. Option 2, once selected, can be established responsive to the operator selecting the accept and finish icon and/or option 2 can be customized responsive to the operator selecting the customize icon. The user interface shown in FIG. 36 can be an extension of, a scroll down, an overlay, or otherwise included in or with the user interface shown in FIG. 35. Similarly, the information shown in FIG. 36 can be displayed, or shown in the user interface shown in FIG. 35. Additionally, the user interfaces shown in FIGS. 35 and 36 can be included within a single user interface (e.g., the user interfaces are combined).

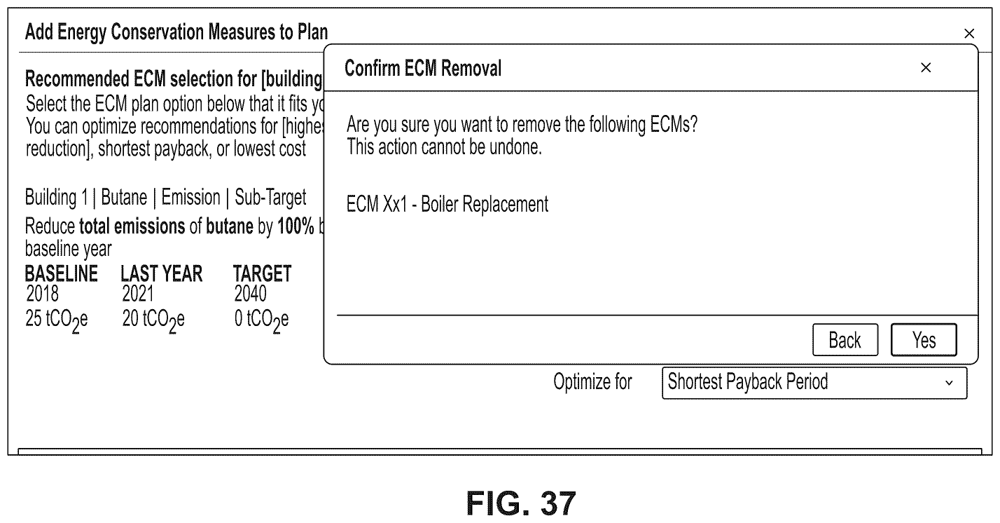

Referring now to FIG. 37, a user interface is shown, in accordance with an exemplary embodiment. The user interface can include an energy conservation measure window. The user interface shown in FIG. 37 can be generated in response to an operator selecting at least one of the add/remove ECM icons shown in at least one of FIGS. 17-20, 27-29, 32, and/or 34. The user interface shown in FIG. 37 can be displayed, provided, shown or otherwise presented as an overlay on top of at least one of the user interfaces shown in FIGS. 17-20, 27-29, 32, and 34. The user interface shown in FIG. 37 can also be generated as a new user interface that replaces a user interface previously shown by a device.

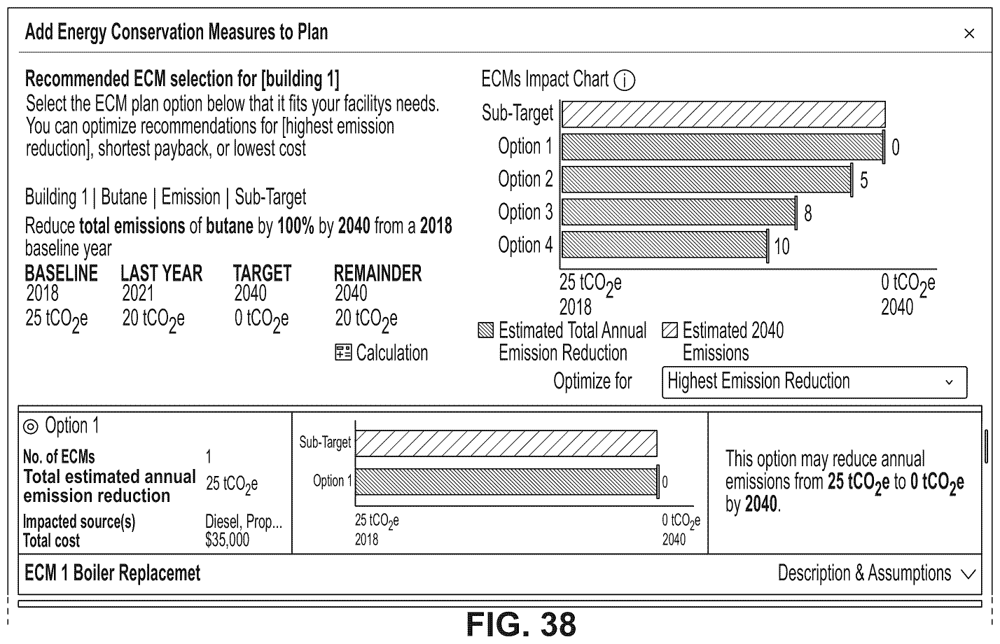

Referring now to FIG. 38, a user interface is shown, in accordance with an exemplary embodiment. The user interface can include an energy conservation measure window. The user interface shown in FIG. 38 can be generated in response to an operator selecting at least one of the add ECM icons shown in at least one of FIGS. 6-8, 17-20, 27-29, 32-34. The user interface shown in FIG. 38 can be displayed, provided, shown, or otherwise presented as an overlay on top of at least one of the user interfaces shown in FIGS. 6-8, 17-20, 27-29, and/or 32-34. The user interface shown in FIG. 38 can also be generated as a new user interface that replaces a user interface previously shown by a device.

The user interface shown in FIG. 38 can include a ECMs impact chart. The ECMs impact chart can include a graphical representation of at least one sub-target goal that pertains to the sustainability target and/or the energy conservation protocols that were generated and/or obtained by the ECM manager 305. The ECMs impact chart can include a sub-target portion and at least one portion that pertains to at least one option (e.g., at least one FIM, action, etc.). The ECMs impact chart can show the impact that each option can have. FIG. 38 shows that the energy conservation measure window pertains to the butane emissions associated with building 1. FIG. 38 can also include at least one window that pertains to the options included in the ECMs impact chart.

FIG. 38 shows that option 1 pertains to replacing a boiler. The windows that pertain to the options can be filtered, sort or otherwise organized using an optimize for icon. The optimize for icon can include at least one option. For example, the optimize for icon can include a highest emission reduction option, a shortest payback period option and/or a lowest amount option. FIG. 38 depicts an example of the option windows being sorted by the highest emission reduction option. The user interface can also include a description and assumptions icon can provide additional information that pertains to a particular option window.

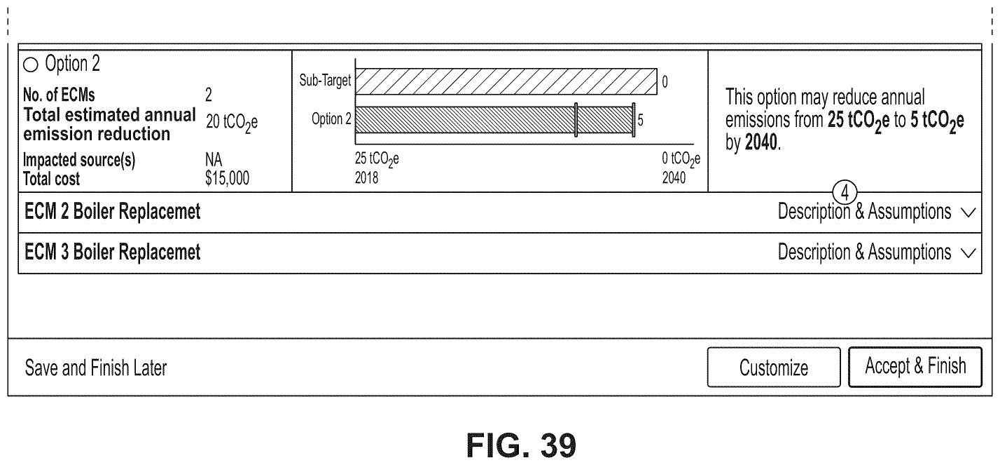

Referring now to FIG. 39, a user interface is shown, in accordance with an exemplary embodiment. The user interface can include an option window that pertains to at least one option that was included in an ECMs impact chart. The user interface can also include a customize icon and an accept and finish icon. The operator of the device displaying the user interface shown in FIG. 39 can select the customize icon to customize at least one of the options shown in the user interface. The operator can select the accept and finish icon to establish at least one option that has been selected by the operator. The empty circle next to option 2 indicates that that operator has yet to select option 2. Option 2, once selected, can be established responsive to the operator selecting the accept and finish icon and/or option 2 can be customized responsive to the operator selecting the customize icon. The user interface shown in FIG. 39 can be an extension of, a scroll down, an overlay, or otherwise included in or with the user interface shown in FIG. 38. Similarly, the information shown in FIG. 39 can be displayed or shown in the user interface shown in FIG. 38. Additionally, the user interfaces shown in FIGS. 38 and 39 can be included within a single user interface (e.g., the user interfaces are combined).

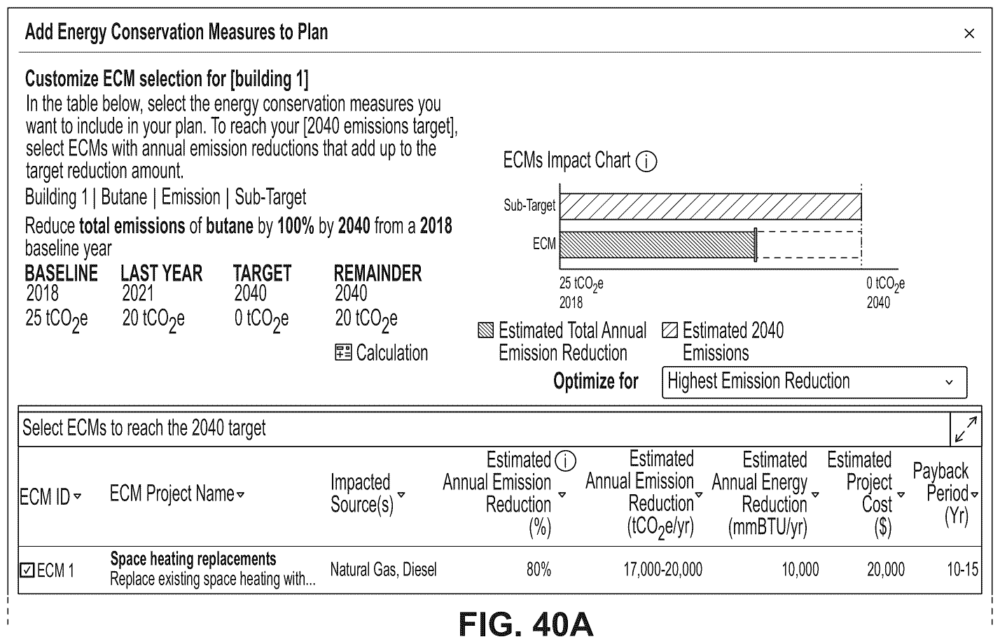

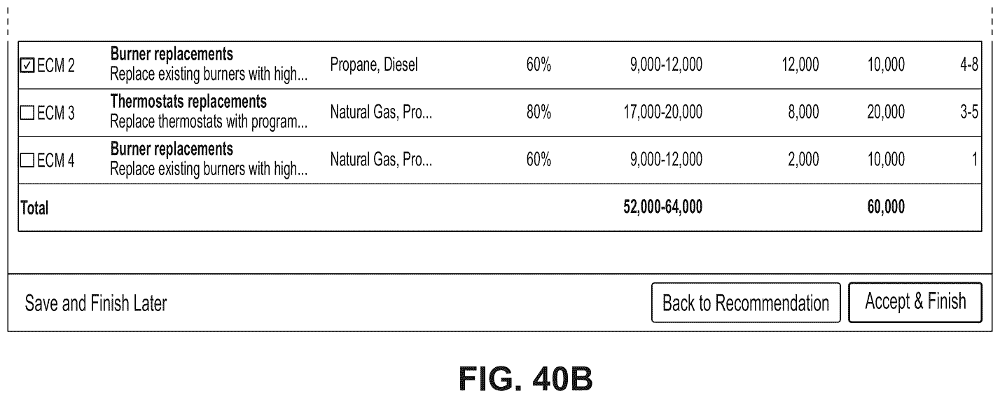

Referring now to FIG. 40A, a user interface is shown, in accordance with an exemplary embodiment. The user interface can include a customization window that pertains to the improvement measures plan. The user interface shown in FIG. 40A can be generated in response to the operator selecting the customize icon shown in at least one of FIGS. 10, 12, 36, and/or 39. The user interface shown in FIG. 40A can be displayed, provided, shown or otherwise presented as an overlay on top of at least one of the user interfaces shown in FIGS. 10, 12, 36, and/or 39. The user interface shown in FIG. 40A can also be generated as a new user interface that replaces a user interface previously shown by a device.

FIG. 40A shows that an operator of the device displaying the user interface has selected the ECM that pertains to space heating replacements and burner replacements. The operator can select an accept and finish icon to establish the selected ECMs. The operator can select a back to recommendations icon to return to the user interface shown in at least one of FIGS. 10, 12, 36, and/or 39.

Referring now to FIG. 40B, a user interface is shown, in accordance with an exemplary embodiment. The user interface shown in FIG. 40B can be and/or include information similar to that shown in FIG. 40A. Similarly, the user interface shown in FIG. 40B can be at least one of an extension to the user interface shown in FIG. 40A, a scroll down, an overlay or otherwise included in or with the user interface shown in FIG. 40A.

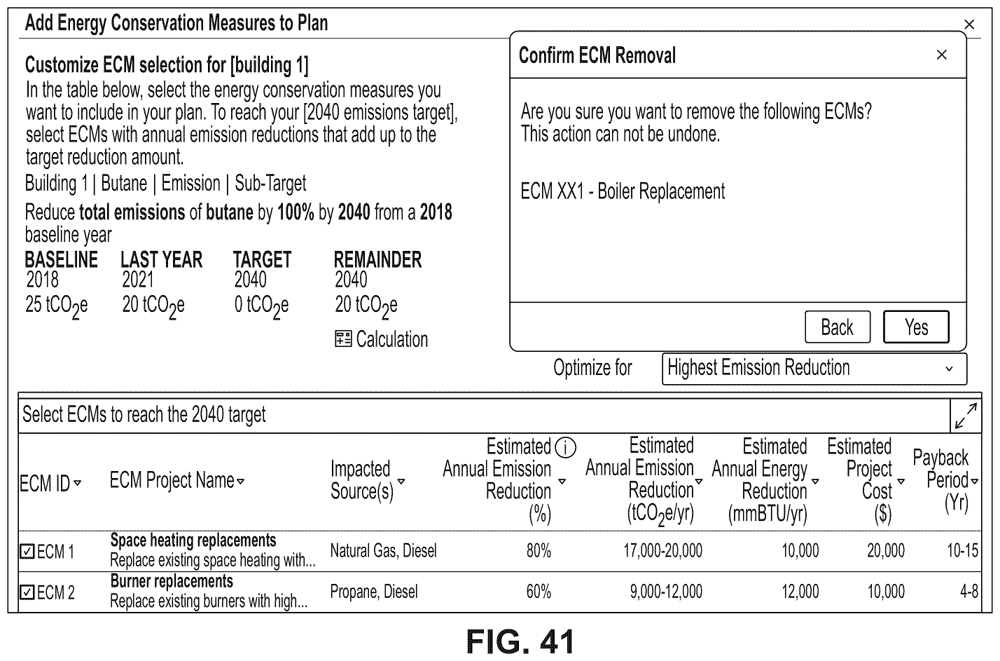

Referring now to FIG. 41, a user interface is shown, in accordance with an exemplary embodiment. The user interface can include an energy conservation measure window. The user interface shown in FIG. 41 can be generated in response to an operator selecting at least one of the add/remove ECM icons shown in at least one of FIGS. 17-20, 27-29, 32, and/or 34. The user interface shows that the operator of the device has selected the ECM that pertains to space heating replacements and burner replacements. The operator can select a yes icon to complete the removal of the selected ECMs from the energy conservation protocols. The operator can select a back icon to cancel the removal of the selected ECMS. The user interface shown in FIG. 41 can be displayed, provided, shown, or otherwise presented as an overlay on top of at least one of the user interfaces shown in FIGS. 17-20, 27-29, 32, and/or 34. The user interface shown in FIG. 41 can also be generated as a new user interface that replaces a user interface previously shown by a device.

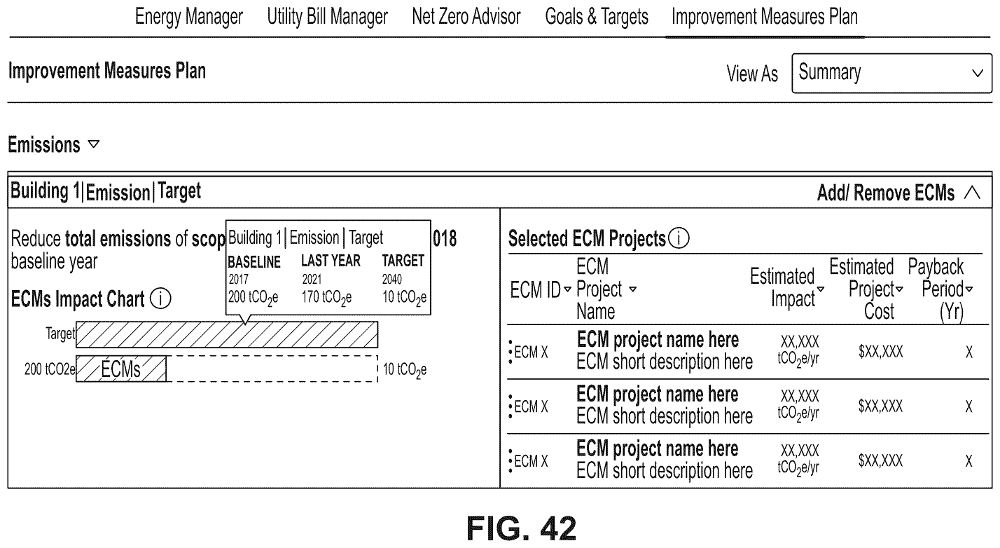

Referring now to FIG. 42, a user interface is shown, in accordance with an exemplary embodiment. The user interface can include an improvement measures plan dashboard. The improvement measures plan dashboard can include information about the same building to that of FIGS. 6, 27, and/or 32 and/or the improvement measures plan dashboard can include information about a different building to that of FIGS. 6, 27, and/or 32. The user interface can be generated in response to the operator selecting the next icon shown in FIG. 5. The improvement measures plan dashboard can include a view as icon. The operator of the device displaying the user interface shown in FIG. 42 can hover over, select, or otherwise interact with the view as icon to adjust the view, appearance, or presentation of the improvement measures plan. FIG. 42 can include information that pertains to the emission sustainability category associated with the building. Additionally, FIG. 42 shows that at least one ECM has been generated, established, customized, or otherwise associated with the emission category of the building.

Referring now to FIG. 43, a user interface is shown, in accordance with an exemplary embodiment. The user interface can include the improvement measures plan dashboard. The user interface can include at least one window that includes information that pertains to the natural gas emission source and the diesel emission source that pertain to the emission sustainability category shown in FIG. 42. The user interface show in FIG. 43 can be an extension of, a scroll down, an overlay, or otherwise included in or with the user interface shown in FIG. 42. Additionally, the user interfaces shown in FIGS. 42 and 43 can be included within a single user interface (e.g., the user interfaces are combined).

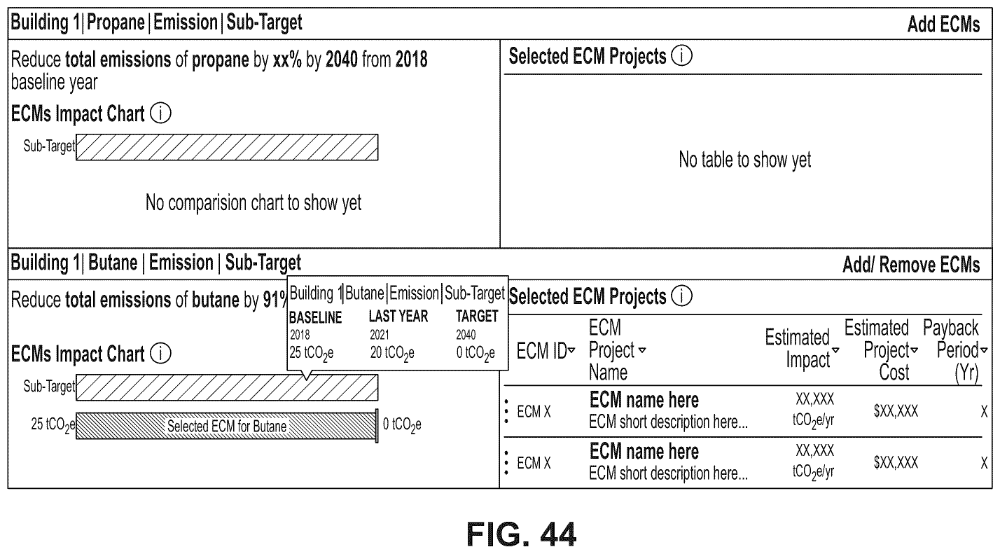

Referring now to FIG. 44, a user interface is shown, in accordance with an exemplary embodiment. The user interface can include the improvement measures plan dashboard. The user interface can include at least one window that includes information that pertains to the propane emission source and the butane emission source that pertain to the emission sustainability category shown in FIG. 42. The butane window can include a ECMs impact chart that indicates that an ECM has been established, executed, or otherwise implemented that can result in the target value associated with butane being reached. The butane window is also shown to include an add/remove ECMs icon given that an ECM has been established for butane. Additionally the propane window is shown to only have the add ECMs icon given that an ECM has not yet been established for propane. The user interface show in FIG. 44 can be an extension of, a scroll down, an overlay, or otherwise included in or with the user interfaces shown in FIGS. 42 and/or 43. Additionally, the user interfaces shown in FIGS. 42, 43, and 44 can be included within a single user interface (e.g., the user interfaces are combined).

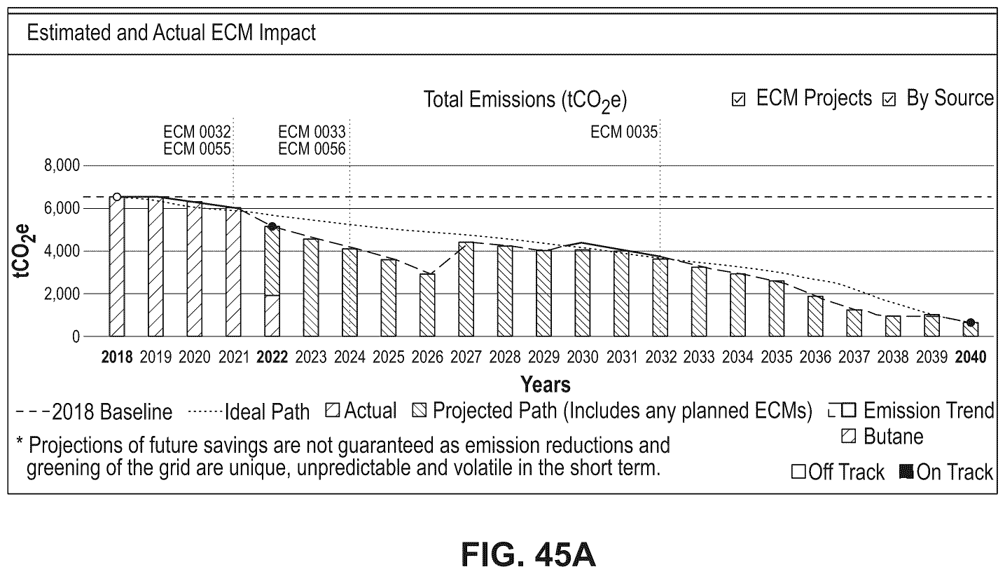

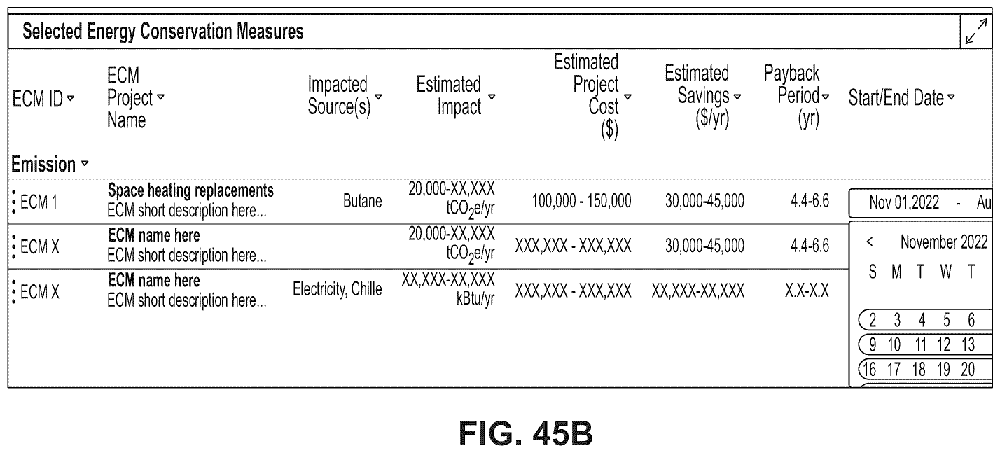

Referring now to FIG. 45A, a user interface is shown, in accordance with an exemplary embodiment. The user interface can include a graphical representation of ECM tracking. The graphical representation depicted by the user interface can be based on ECM projects. The graphical representation depicted by the user interface can also be based on the sources that contribute to parameters associated with the sustainability target. The user interface can include the baseline value that pertains to parameters associated with the sustainability target. For example, the user interface can include the baseline value of the total emission that pertain to a building (e.g., building 10). Similarly, the user interface can include the baseline value that pertains to at least one of the sustainability categories (e.g., emissions, energy, water, waste, etc.). The user interface can include the impact that at least one ECM can have on the value of the parameter. For example, FIG. 45A shows that ECM 0032 and ECM 0055 upon completion can reduce the carbon emissions from 6,200 to 6,000 tCO2e/yr. Similarly, FIG. 45A shows that ECM 0033 and ECM 0056 upon completion can reduce the carbons emissions from 6,000 to 4,000 tCO2e/yr. Additionally, FIG. 43A shows that ECM 0035 upon completion can reduce the carbon emissions from 4,000 to 3,800 tCO2e/yr. The operator of the device displaying the user interface shown in FIG. 45A can adjust, modify, or otherwise change how the information is presented by hovering over, interacting with, or selecting at least one of a show sources icon, a completed ECMs icon and/or a planned ECMs icon. The user interface show in FIG. 45A can be an extension of, a scroll down, an overlay, or otherwise included in or with the user interface shown in FIG. 24.

Referring now to FIG. 45B, a user interface is shown, in accordance with an exemplary embodiment. The user interface includes a graphical representation of ECM tracking including impacts contributed to ECM projects as well as a by source view. The by source view depicts the impact that ECM projects have to each source that contribute to the sustainability parameters and/or the sustainability target. FIG. 45B depicts an example of the ECM projects impacting natural gas consumption, diesel consumption, propane consumption, and butane consumption. The user interface shown in FIG. 45B can be and/or include information similar to that shown in FIG. 45A. Similarly, the user interface shown in FIG. 45B can be at least one of an extension to the user interface shown in FIG. 45A, a scroll down, an overlay or otherwise included in or with the user interface shown in FIG. 45A. The user interface shown in FIG. 45B can be generated responsive to an operator of the device displaying the user interface shown in FIG. 45B and/or FIG. 45A selecting the by source icon.

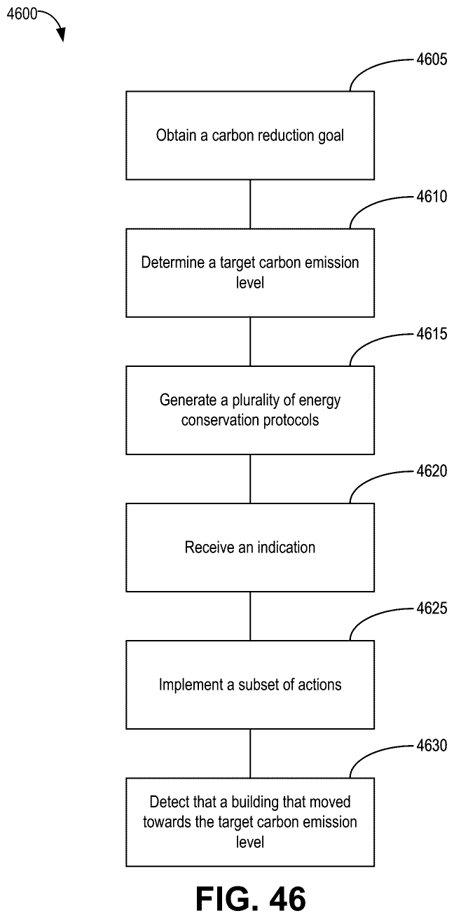

FIG. 46 depicts a flow diagram of a process 4600 for reducing carbon emissions for a building, according to an exemplary embodiment. The building can be and/or include the building 10. The building 10 can be or be included in at least one location of a business. For example, the building 10 can be located in a first campus of a business and the business can include a plurality of campuses. The building 10 can contribute to the sustainability of itself and/or the sustainability of the business. The building 10 can include a number of pieces of building equipment. The pieces of building equipment can contribute to a sustainability performance of the building 10 (e.g., the sustainability performances described herein). At least one step of the process 4600 can be performed by the ECM Manager 305 and/or a component thereof. For example, the ECM generator 330 can perform at least one step of the process 4600. The process 4600 can also be performed by any computing device and/or system described herein. The process 4600 can be performed before the construction of the building 10, during the construction of the building 10, after the completion of the construction of the building 10, and/or among other possible points in time.

In step 4605, a carbon reduction goal can be obtained. The carbon reduction goal can pertain to and/or be associated with the building 10. The carbon reduction goal can be included in a sustainability goal for the building 10. Similarly, the carbon reduction goal can be the sustainability goal for the building 10. The carbon reduction goal can be obtained from a data source and/or a user device. For example, the carbon reduction goal can be obtained from the user device 318. The communication component 320 can obtain the carbon reduction goal from the user device 318.

In some embodiments, the carbon reduction goal can be established for the building 10. For example, the company and/or the entity responsible for the building 10 can establish the carbon reduction goal for the building 10. The carbon reduction goal can be established by performing steps similar to the steps described in U.S. Provisional Patent application No. 63/336,935 filed Apr. 29, 2022, to establish a business level goal (e.g., a sustainability goal) or target sustainability level, a location level goal or target, a building level goal or target and/or a building sub-target goal. The establishing of the carbon reduction goal can cause the user device to display a user interface. For example, the user interface shown in FIG. 5 can be displayed on the user device responsive to establishing the carbon reduction goal.

The communication component 320 can, responsive to obtaining the carbon reduction goal, communicate with the sustainability component 325. The communication component 320 can provide the carbon reduction goal to the sustainability component 325. The sustainability component 325 can determine a baseline carbon emission level for the building 10. The sustainability component 325 can determine the baseline carbon emission level for the building 10 by retrieving data stored in the database 340. For example, the sustainability component 325 can retrieve data pertaining to equipment emissions and then determine the baseline carbon emission level for the building 10. The baseline carbon emission level for the building 10 can be an average value over a period of time (e.g., the average yearly emission level over the past 5 years). The baseline carbon emission level for the building 10 can also be a recent value (e.g., the carbon emission level of the building 10 in the previous year). The baseline carbon emission level for the building 10 can also be based on a duration of time with respect to operation of the building 10. For example, the baseline carbon emission level for the building 10 can be a total carbon emission of the building 10 in the last three months.

In step 4610, a target carbon emission level can be determined. The target carbon emission level can pertain to the building 10. The target carbon emission level can be determined using the baseline carbon emission level and the carbon reduction goal. For example, the sustainability component 325 can use the carbon reduction goal obtained in step 4605 and the baseline carbon emission level determined in step 4605 to determine the target carbon emission level.

The target carbon emission level can be a carbon emission value and the carbon emission value, if reached by the building 10, can result in the building 10 achieving the carbon reduction goal for the building 10. For example, the carbon reduction goal can be a goal to reduce carbon emissions for the building 10 by 90%. To continue this example, the baseline carbon emissions for the building 10 can be 10,000 tCO2e/yr. The sustainability component 325 can, using the carbon reduction goal of 90% and the baseline carbon emissions level of 10,000 tCO2e/yr., determine a target carbon emission level of 1,000 tCO2e/yr.

In step 4615, a plurality of energy conservation protocols can be generated. The ECM generator 330 can generate the energy conservation protocols. The energy conservation protocols can be and/or included in a plurality of ECMs. The energy conservation protocols can include a plurality of actions. The plurality of actions can be and/or include ECMs, FIMs, and/or among other possible actions that can be taken to improve the sustainability of the building 10. The plurality of actions can meet at least a portion of the carbon reduction goal and/or at least a portion of the target emission level. For example, a first energy conservation protocol can include actions, that when implemented, that result in the carbon emissions of the building 10 being reduced.

The ECM generator 330 can generate the energy conservation protocols using the baseline carbon emission level determined in step 4605 and the target carbon emission level determined in step 4610. For example, the ECM generator 330 can use a difference between the target emission level and the baseline carbon emission level to the determine ECMs that can be included in the energy conservation protocols. The ECM generator 330 can also use data stored in the database 340 to determine a plurality of impacts associated with the ECMs and/or the energy conservation protocols. The impacts can include expected runtime values, expected efficiency numbers, and/or among other possible information. The ECM generator 330 can use the impacts to generate ECMs that can meet the target carbon emission level and the carbon reduction goal. The ECM generator 330 can, in response to generating the energy conservation protocols, communicate with the communication component 320. The ECM generator 330 can provide, to the communication component 320, the energy conservation protocols.

The communication component 320 can, in response to receiving the energy conservation protocols, provide the energy conservation protocols. For example, the communication component 320 can provide the energy conservation protocols generated in step 4615 to the data source 310 or the user device 318. The providing of the energy conservation protocols, by the communication component 320, can cause the user device 318 to display, via a user interface associated with the user device 318, at least a portion of the energy conservation protocols. For example, the user interface displayed by the user device 318 can display, show, present or otherwise include the energy conservation protocols and the actions included in the energy conservation protocols. The user interface can include at least one selectable element and the operator of the device displaying the user interface can interact with the selectable elements to accept the ECMS, the energy conservation protocols and/or the actions included in the ECMs and/or the energy conservation protocols. For example, the user interface can include information similar to that shown in FIG. 15 and the operator can select the accept and finish icon to accept the selected ECMs.

In step 4620, an indication can be received. The communication component 320 can receive the indication. The indication can be received from the user device 318. The indication can be an indication to accept a subset of the plurality of actions include in the energy conservation protocols. For example, a first energy conservation protocol can include a plurality of actions and an operator of the device displaying the first energy conservation protocol can select an icon to accept a subset of the plurality of actions. The operator selecting the icon can result in the communication component 320 receiving the indication to accept. The communication component 320 can provide the indication to accept the subset of the plurality of actions to the ECM generator 330.

In step 4625, a subset of actions can be implemented. The subset of actions can be the subset of actions that were accepted by the operator in step 4620. The ECM generator 330 can implement, responsive to the communication component 320 providing the indication to the ECM generator 330, the subset of actions. The ECM generator 330 implementing the subset of actions included in the first energy conservation protocol can include at least one of establishing, modifying, updating, changing, or otherwise proceeding with the subset of actions included in the first energy conservation protocol. The implementing of the subset of actions can include the controller 335 controlling and/or operating at least one piece of building equipment based on the subset of actions. For example, the subset of actions can include control strategies and the controller 335 can use the control strategies to control pieces of building equipment.

In step 4630, a change in the carbon emission level of the building can be detected. For example, the monitor component 405 can detect that the building 10 has moved towards the target carbon emission level that was obtained in step 4605. For example, the monitor component 405 can determine a current carbon emission level of the building 10 and the monitor component 405 can determine that the current carbon emission level is smaller than the baseline carbon emission level. The monitor component 405 can detect that the building 10 has moved towards the target carbon emission level responsive to the subset of actions having been implemented in step 4625.

While the user interfaces described herein are described as having given number values and the user interfaces illustrated in the figures are shown to include given numerical values, the information shown in the user interfaces can include numerical values that are similar to the values described herein and/or the user interfaces can include numerical values that are different than the values described herein.

The user interfaces described herein can be generated in response to the ECM manager 305 and/or components thereof providing signals, to at least one device (e.g., the user device 318), that cause the device to display, via an interface, the user interfaces. Additionally, any information or data that is received, monitored, generated or that otherwise pertains to the systems described herein can also be included in the user interfaces described herein.

### Artificial Intelligence Implementations

In some embodiments, the systems for and methods of generating, providing, and implementing ECMs for buildings can be executed and/or implemented using Artificial Intelligence (AI) and/or Machine Learning (ML). For example, the ECM manager 305 may be implemented in and/or executed by a Generative Artificial Intelligence (GAI) model. Additionally, the user interfaces described herein can be provided, to a user device, as a response to a prompt.

In some embodiments, the GAI model can receive, from the user device, a prompt to establish a sustainability goal for a building. The building may be and/or include the building 10. In some embodiments, the building may be at least one of a preexisting building, a building undergoing construction (e.g., the building is currently being building), a pre-construction building (e.g., plans for the building are being developed), and/or among other possible combinations. The GAI model can be trained, using data associated with sustainability improvements for building, to identify and/or otherwise detect factors associated with the building that impact the sustainability of the building.

As a non-limiting example, the GAI model can retrieve, from a database, efficiency metrics for equipment that is currently installed in the building. To continue this example, the GAI model can determine, using efficiency metrics for the currently installed equipment and efficiency metrics for currently available retrofit equipment, a piece of currently installed equipment that contributes to the sustainability performance of the building by a larger amount relative to a predicted contribution of a similar piece of retrofit equipment. For example, the GAI model can determine that a current VAV unit has a yearly emissions value accounting for 5% of the total yearly emissions for the building.

To continue the non-limiting example, the GAI model can determine that if a piece of equipment (e.g., a recommendation including a FIM to install a retrofit VAV unit) were to replace the current VAV unit that the yearly emissions value for the retrofit VAV unit may be half of the carbon emissions value for the currently installed VAV unit. For example, the building may have a total carbon emission value of 8,000 tCO2e/yr. In this example, the contribution to the carbon emissions by the current VAV unit may be 400 tCO2e/yr (e.g., 5% of the total carbon emission value). The replacing of the currently installed VAV unit with the retrofit VAV unit may produce a carbon emission reduction of 200 tCO2e/yr. In this example, the total carbon emissions value for the building, for a future point in time, may change from 8,000 to 7,800 tCO2e/yr. The result of replacing the currently installed VAV unit with the retrofit VAV unit may result in a 2.5% reduction in the yearly carbon emission for the building.

In some embodiments, the building may be at least one of a commercial building, a medical facility (e.g., a hospital, a clinic, an assisted living facility, a nursing home, etc.), a residential complex (e.g., an apartment complex, condos, etc.), an educational building (e.g., schools, college campus buildings, etc.), mixed use buildings (e.g., stores/shops occupy a portion of the building and residential areas occupy a portion of the building), and/or among other possible combinations. For example, the building may be an office building and the office building may include multiple floors having multiple zones and/or multiple rooms.

In some embodiments, the various systems described herein can be implemented to more precisely generate data for various applications including, for example and without limitation, virtual assistance for creating and supporting building managers in establishing and implementing ECMs and/or FIMs to reach sustainability goals; generating technical reports corresponding to ECM implementations; facilitating diagnostics and troubleshooting procedures; recommendations of FIMs to be performed; and/or recommendations for products or tools to use or install as part of the FIMs. Various such applications can facilitate both asynchronous and real-time sustainability improvement tracking, including by generating text data for such applications based on data from disparate data sources that may not have predefined database associations amongst the data sources, yet may be relevant at specific steps or points in time during sustainability improvement implementations.

In some systems, building managers, building supervisors, and/or building occupants can be supported by text information, such as predefined text documents such as sustainability impact guides, sustainability improvement guides, and/or recommendation guides. Various such text information may not be useful for specific sustainability recommendations and/or FIMs. For example, the text information may correspond to different items of equipment or versions of items of equipment to be serviced. The text information, being predefined, may not account for specific sustainability improvements that may be implemented as FIMs and/or ECMs.

AI and/or ML systems, including but not limited to Large Language Models (LLMs), can be used to generate text data and data of other modalities in a more responsive manner to real-time conditions, including generating strings of text data that may not be provided in the same manner in existing documents, yet may still meet criteria for useful text information, such as relevance, style, and coherence. For example, LLMs can predict text data based at least on inputted prompts and by being configured (e.g., trained, modified, updated, fine-tuned) according to training data representative of the text data to predict or otherwise generate.

However, various considerations may limit the ability of such systems to precisely generate appropriate data for specific conditions. For example, due to the predictive nature of the generated data, some LLMs may generate text data that is incorrect, imprecise, or not relevant to the specific conditions. Using the LLMs may require a user to manually vary the content and/or syntax of inputs provided to the LLMs (e.g., vary inputted prompts) until the output of the LLMs meets various objective or subjective criteria of the user. The LLMs can have token limits for sizes of inputted text during training and/or runtime/inference operations (and relaxing or increasing such limits may require increased computational processing, API calls to LLM services, and/or memory usage), limiting the ability of the LLMs to be effectively configured or operated using large amounts of raw data or otherwise unstructured data.

Systems and methods in accordance with the present disclosure can use machine learning models, including LLMs and other generative AI systems, to capture data, including but not limited to unstructured knowledge from various data sources, and process the data to accurately generate outputs, such as completions responsive to prompts, including in structured data formats for various applications and use cases. The system can implement various automated and/or expert-based thresholds and data quality management processes to improve the accuracy and quality of generated outputs and update training of the machine learning models accordingly. The system can enable real-time messaging and/or conversational interfaces for users to provide field data regarding equipment to the system (including presenting targeted queries to users that are expected to elicit relevant responses for efficiently receiving useful response information from users) and guide users, such as service technicians, through relevant service, diagnostic, troubleshooting, and/or repair processes.

This can include, for example, receiving data from sustainability improvement implementations in various formats, including various modalities and/or multi-modal formats (e.g., text, speech, audio, image, and/or video). The system can facilitate automated, flexible customer report generation, such as by processing information received from building managers, building supervisors, and other users into a standardized format, which can reduce the constraints on how the user submits data while improving resulting reports. The system can couple unstructured sustainability data to other input/output data sources and analytics, such as to relate unstructured data with outputs of timeseries data from equipment (e.g., sensor data; report logs) and/or outputs from models or algorithms of equipment operation, which can facilitate more accurate analytics, prediction services, diagnostics, and/or fault detection. The system can perform classification or other pattern recognition or trend sustainability improvements to facilitate more timely FIM recommendations, FIM implementation, FIM tracking, equipment maintenance scheduling, scheduling installs of equipment based on expected times for jobs, and provisioning of trucks, tools, and/or parts.

The system can perform sustainability improvement predictions by using models trained with data that includes indications of root causes of sustainability performance metrics or sustainability performance factors, where the indications are labels for or otherwise associated with (unstructured or structure) data such as building emissions, equipment runtime, utility reports, building schematics, Building Information Models (BIMs), service requests, service reports, service calls, etc. The system can receive, from a building manager and/or a user associated with a building, feedback regarding the accuracy of the predictions, as well as feedback regarding how the user evaluated information about the sustainability of the building (e.g., what data did they evaluate; what did they inspect; did the prediction or instructions accurately match the sustainability performance improvement), which can be used to update the prediction model.

The system may perform root cause prediction by being trained using data that includes indications of root causes of faults or errors, where the indications are labels for or otherwise associated with (unstructured or structure) data such as service requests, service reports, service calls, etc. The system can receive, from a service technician in the field evaluating the issue with the equipment, feedback regarding the accuracy of the root cause predictions, as well as feedback regarding how the service technician evaluated information about the equipment (e.g., what data did they evaluate; what did they inspect; did the root cause prediction or instructions for finding the root cause accurately match the type of equipment, etc.), which can be used to update the root cause prediction model. The system may also be trained to associated equipment faults with an impact on the sustainability performance of the building. For example, the system may be trained to learn to identify that a repetitive fault of an AHU is negatively impacting the sustainability performance of the building. The system may then provide recommendations to address the repetitive fault of the AHU resulting in an improvement in the sustainability performance of the building.

For example, the system can provide a platform for sustainability improvements and FIM recommendations in which a machine learning model is configured based on connecting or relating unstructured data and/or semantic data, such as human feedback and written/spoken reports, with time-series data regarding building utilities, weather, occupancy, building status, and pieces of equipment, so that the machine learning model can more accurately provide and/or generate sustainability improvement measures (e.g., FIMs and ECMs). For instance, the system can more accurately provide a FIM recommendation to improve the sustainability of the building; the system can request feedback from a building manager and/or a user regarding the recommendation, such as whether the recommendation correctly addressed the request of the user and/or whether implementation of the recommendation resulted in the predicted sustainability improvement, as well as the information that the user used to evaluate the correctness or accuracy of the recommendation; the system can use this feedback to modify the machine learning models, which can increase the accuracy of the machine learning models.

In some instances, significant computational resources (or human user resources) can be required to process data relating to equipment operation, such as time-series product data and/or sensor data, to detect, identify and/or generate FIMs to improve the sustainability of a building. In addition, it can be resource-intensive to label such data with identifiers of FIMS and/or ECMs that may be implemented, which can make it difficult to generate machine learning training data from such data. Systems and methods in accordance with the present disclosure can leverage the efficiency of language models (e.g., GPT-based models or other pre-trained LLMs) in extracting semantic information (e.g., semantic information identifying FIMs, ECMs, sustainability strategies, causes of faults, and other accurate expert knowledge regarding sustainability improvements) from the unstructured data in order to use both the unstructured data and the data relating to the sustainability of the building to generate more accurate outputs regarding sustainability improvements for the building. As such, by implementing language models using various operations and processes described herein, building management and equipment servicing systems can take advantage of the causal/semantic associations between the unstructured data and the data relating to the sustainability of the building, and the language models can allow these systems to more efficiently extract these relationships in order to more accurately identify and/or generate FIMs and/or ECMs to improve the sustainability of the building. While various implementations are described as being implemented using generative AI models such as transformers and/or GANs, in some embodiments, various features described herein can be implemented using non-generative AI models or even without using AI/ML, and all such modifications fall within the scope of the present disclosure.

The system can enable a generative AI-based sustainability wizard interface. For example, the interface can include user interface and/or user experience features configured to provide a question/answer-based input/output format, such as a conversational interface, that directs users through providing targeted information for accurately generating FIMs and ECMs to improve the sustainability of the building, presenting solutions, or presenting instructions for actions that may be taken to reduce a user impact on the sustainability performance of the building. The system can use the interface to present information regarding equipment replacement, equipment retrofitting, equipment setpoints, building use, and/or zone utilization to improve the sustainability performance of the building.

In various implementations, the systems can include a plurality of machine learning models that may be configured using integrated or disparate data sources. This can facilitate more integrated user experiences or more specialized (and/or lower computational usage for) data processing and output generation. Outputs from one or more first systems, such as one or more first algorithms or machine learning models, can be provided at least as part of inputs to one or more second systems, such as one or more second algorithms or machine learning models. For example, a first language model can be configured to process unstructured inputs (e.g., text, speech, images, etc.) into a structure output format compatible for use by a second system, such as a FIM or ECM recommendation algorithm or a sustainability improvement model.

The system can be used to automate interventions for sustainability tracking, sustainability improvements, equipment operation, servicing, fault detection and diagnostics (FDD), and alerting operations. For example, by being configured to perform operations such as root cause prediction, the system can monitor data regarding equipment to predict events associated with faults and trigger responses such as alerts and service scheduling to mitigate the faults impact on the sustainability performance of the building. The system can present to a technician or manager of the equipment a report regarding the intervention (e.g., action taken responsive to predicting a fault or root cause condition) and requesting feedback regarding the accuracy of the intervention, which can be used to update the machine learning models to more accurately generate interventions and/or identify the relationship between equipment faults and the sustainability of the building (e.g., how is the equipment fault impacting the sustainability performance of the building).

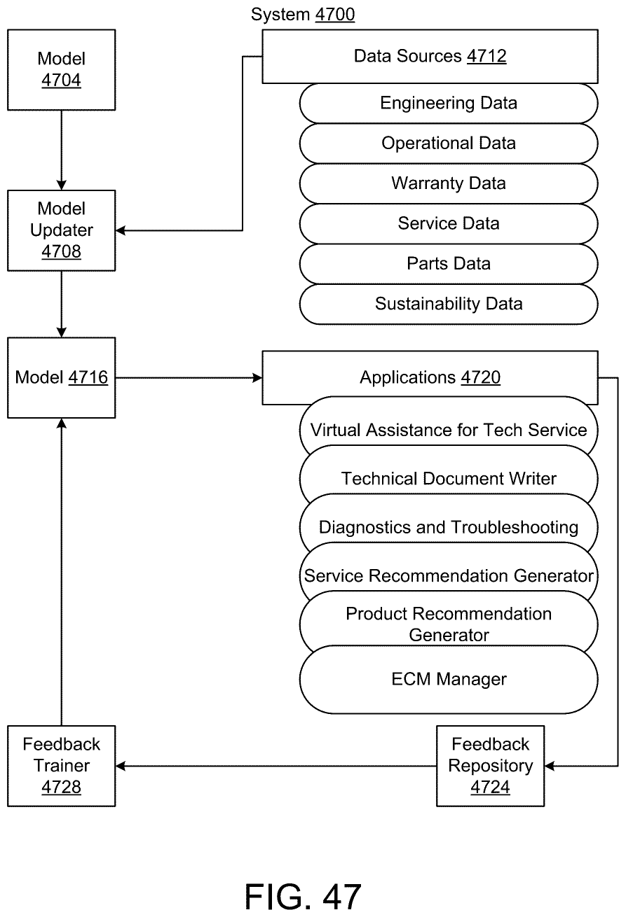

FIG. 47 depicts an example of a system 4700. The system 4700 can implement various operations for configuring (e.g., training, updating, modifying, transfer learning, fine-tuning, etc.) and/or operating various AI and/or ML systems, such as neural networks of LLMs or other generative AI systems. The system 4700 can be used to implement various generative AI-based building equipment servicing operations. While the present disclosure discusses various implementations that utilize generative AI methodologies, it should be understood that, in various embodiments, non-generative AI methods can also be used, alone or in combination with generative AI methods, and all such implementations are contemplated within the scope of the present disclosure.

For example, the system 4700 can be implemented for operations associated with any of a variety of building management systems (BMSs) or equipment or components thereof. A BMS can include a system of devices that can control, monitor, and manage equipment in or around a building or building area. The BMS can include, for example, a HVAC system, a security system, a lighting system, a fire alerting system, any other system that is capable of managing building functions or devices, or any combination thereof. The BMS can include or be coupled with items of equipment, for example and without limitation, such as heaters, chillers, boilers, air handling units, sensors, actuators, refrigeration systems, fans, blowers, heat exchangers, energy storage devices, condensers, valves, or various combinations thereof.

The items of equipment can operate in accordance with various qualitative and quantitative parameters, variables, setpoints, and/or thresholds or other criteria, for example. In some instances, the system 4700 and/or the items of equipment can include or be coupled with one or more controllers for controlling parameters of the items of equipment, such as to receive control commands for controlling operation of the items of equipment via one or more wired, wireless, and/or user interfaces of controller.

Various components of the system 4700 or portions thereof can be implemented by one or more processors coupled with or more memory devices (memory). The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.). The processors can be configured in various computer architectures, such as graphics processing units (GPUs), distributed computing architectures, cloud server architectures, client-server architectures, or various combinations thereof. One or more first processors can be implemented by a first device, such as an edge device, and one or more second processors can be implemented by a second device, such as a server or other device that is communicatively coupled with the first device and may have greater processor and/or memory resources.

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

### Machine Learning Models

The system 4700 can include or be coupled with one or more first models 4704. The first model 4704 can include one or more neural networks, including neural networks configured as generative models. For example, the first model 4704 can predict or generate new data (e.g., artificial data; synthetic data; data not explicitly represented in data used for configuring the first model 4704). The first model 4704 can generate any of a variety of modalities of data, such as text, speech, audio, images, and/or video data. The neural network can include a plurality of nodes, which may be arranged in layers for providing outputs of one or more nodes of one layer as inputs to one or more nodes of another layer. The neural network can include one or more input layers, one or more hidden layers, and one or more output layers. Each node can include or be associated with parameters such as weights, biases, and/or thresholds, representing how the node can perform computations to process inputs to generate outputs. The parameters of the nodes can be configured by various learning or training operations, such as unsupervised learning, weakly supervised learning, semi-supervised learning, or supervised learning.

The first model 4704 can include, for example and without limitation, one or more language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

For example, the first model 4704 can include at least one GPT model. The GPT model can receive an input sequence, and can parse the input sequence to determine a sequence of tokens (e.g., words or other semantic units of the input sequence, such as by using Byte Pair Encoding tokenization). The GPT model can include or be coupled with a vocabulary of tokens, which can be represented as a one-hot encoding vector, where each token of the vocabulary has a corresponding index in the encoding vector; as such, the GPT model can convert the input sequence into a modified input sequence, such as by applying an embedding matrix to the token tokens of the input sequence (e.g., using a neural network embedding function), and/or applying positional encoding (e.g., sin-cosine positional encoding) to the tokens of the input sequence. The GPT model can process the modified input sequence to determine a next token in the sequence (e.g., to append to the end of the sequence), such as by determining probability scores indicating the likelihood of one or more candidate tokens being the next token, and selecting the next token according to the probability scores (e.g., selecting the candidate token having the highest probability scores as the next token). For example, the GPT model can apply various attention and/or transformer based operations or networks to the modified input sequence to identify relationships between tokens for detecting the next token to form the output sequence.

The first model 4704 can include at least one diffusion model, which can be used to generate image and/or video data. For example, the diffusional model can include a denoising neural network and/or a denoising diffusion probabilistic model neural network. The denoising neural network can be configured by applying noise to one or more training data elements (e.g., images, video frames) to generate noised data, providing the noised data as input to a candidate denoising neural network, causing the candidate denoising neural network to modify the noised data according to a denoising schedule, evaluating a convergence condition based on comparing the modified noised data with the training data instances, and modifying the candidate denoising neural network according to the convergence condition (e.g., modifying weights and/or biases of one or more layers of the neural network). In some implementations, the first model 4704 includes a plurality of generative models, such as GPT and diffusion models, that can be trained separately or jointly to facilitate generating multi-modal outputs, such as technical documents (e.g., service guides) that include both text and image/video information.

In some implementations, the first model 4704 can be configured using various unsupervised and/or supervised training operations. The first model 4704 can be configured using training data from various domain-agnostic and/or domain-specific data sources, including but not limited to various forms of text, speech, audio, image, and/or video data, or various combinations thereof. The training data can include a plurality of training data elements (e.g., training data instances). Each training data element can be arranged in structured or unstructured formats; for example, the training data element can include an example output mapped to an example input, such as a query representing a sustainability request or one or more portions of a sustainability request, and a response representing data provided responsive to the query (e.g., recommendations, predictions, FIMs, ECMs, etc.). The training data can include data that is not separated into input and output subsets (e.g., for configuring the first model 4704 to perform clustering, classification, or other unsupervised ML operations). The training data can include human-labeled information, including but not limited to feedback regarding outputs of the models 4704, 4716. This can allow the system 4700 to generate more human-like outputs.

In some implementations, the training data includes data relating to building management systems. For example, the training data can include examples of HVAC-R data, such as operating manuals, technical data sheets, configuration settings, operating setpoints, diagnostic guides, troubleshooting guides, user reports, technician reports. In some implementations, the training data used to configure the first model 4704 includes at least some publicly accessible data, such as data retrievable via the Internet.

Referring further to FIG. 47, the system 4700 can configure the first model 4704 to determine one or more second models 4716. For example, the system 4700 can include a model updater 4708 that configures (e.g., trains, updates, modifies, fine-tunes, etc.) the first model 4704 to determine the one or more second models 4716. In some implementations, the second model 4716 can be used to provide application-specific outputs, such as outputs having greater precision, accuracy, or other metrics, relative to the first model, for targeted applications.

The second model 4716 can be similar to the first model 4704. For example, the second model 4716 can have a similar or identical backbone or neural network architecture as the first model 4704. In some implementations, the first model 4704 and the second model 4716 each include generative AI machine learning models, such as LLMs (e.g., GPT-based LLMs) and/or diffusion models. The second model 4716 can be configured using processes analogous to those described for configuring the first model 4704.

In some implementations, the model updater 4708 can perform operations on at least one of the first model 4704 or the second model 4716 via one or more interfaces, such as application programming interfaces (APIs). For example, the models 4704, 4716 can be operated and maintained by one or more systems separate from the system 4700. The model updater 4708 can provide training data to the first model 4704, via the API, to determine the second model 4716 based on the first model 4704 and the training data. The model updater 4708 can control various training parameters or hyperparameters (e.g., learning rates, etc.) by providing instructions via the API to manage configuring the second model 4716 using the first model 4704.

### Data Sources

The model updater 4708 can determine the second model 4716 using data from one or more data sources 4712. For example, the system 4700 can determine the second model 4716 by modifying the first model 4704 using data from the one or more data sources 4712. The data sources 4712 can include or be coupled with any of a variety of integrated or disparate databases, data warehouses, digital twin data structures (e.g., digital twins of items of equipment or building management systems or portions thereof), data lakes, data repositories, documentation records, or various combinations thereof. In some implementations, the data sources 4712 include HVAC-R data in any of text, speech, audio, image, or video data, or various combinations thereof, such as data associated with HVAC-R components and procedures including but not limited to installation, operation, configuration, repair, servicing, diagnostics, and/or troubleshooting of HVAC-R components and systems. Various data described below with reference to data sources 4712 may be provided in the same or different data elements, and may be updated at various points. The data sources 4712 can include or be coupled with items of equipment (e.g., where the items of equipment output data for the data sources 4712, such as sensor data, etc.). The data sources 4712 can include various online and/or social media sources, such as blog posts or data submitted to applications maintained by entities that manage the buildings. The system 4700 can determine relations between data from different sources, such as by using timeseries information and identifiers of the sites or buildings at which items of equipment are present to detect relationships between various different data relating to the items of equipment (e.g., to train the models 4704, 4716 using both timeseries data (e.g., sensor data; outputs of algorithms or models, etc.) regarding a given item of equipment and freeform natural language reports regarding the given item of equipment).

The data sources 4712 can include unstructured data or structured data (e.g., data that is labeled with or assigned to one or more predetermined fields or identifiers). For example, using the first model 4704 and/or second model 4716 to process the data can allow the system 4700 to extract useful information from data in a variety of formats, including unstructured/freeform formats, which can allow service technicians to input information in less burdensome formats. The data can be of any of a plurality of formats (e.g., text, speech, audio, image, video, etc.), including multi-modal formats. For example, the data may be received from service technicians in forms such as text (e.g., laptop/desktop or mobile application text entry), audio, and/or video (e.g., dictating findings while capturing video).

The data sources 4712 can include engineering data regarding one or more items of equipment. The engineering data can include manuals, such as installation manuals, instruction manuals, or operating procedure guides. The engineering data can include specifications or other information regarding operation of items of equipment. The engineering data can include engineering drawings, process flow diagrams, refrigeration cycle parameters (e.g., temperatures, pressures), or various other information relating to structures and functions of items of equipment.

In some implementations, the data sources 4712 can include operational data regarding one or more items of equipment. The operational data can represent detected information regarding items of equipment, such as sensor data, logged data, user reports, or technician reports. The operational data can include, for example, service tickets generated responsive to requests for service, work orders, data from digital twin data structures maintained by an entity of the item of equipment, outputs, or other information from equipment operation models (e.g., chiller vibration models), or various combinations thereof. Logged data, user reports, service tickets, consumption records, time sheets, and various other such data can provide temporal information, such as how long service operations may take, or durations of time between service operations, which can allow the system 4700 to predict resources to use for performing service as well as when to request service.

The data sources 4712 can include, for instance, warranty data. The warranty data can include warranty documents or agreements that indicate conditions under which various entities associated with items of equipment are to provide service, repair, or other actions corresponding to items of equipment, such as actions corresponding to service requests.

The data sources 4712 can include service data. The service data can include data from any of various service providers, such as service reports. The service data can indicate service procedures performed, including associated service procedures with initial service requests and/or sensor data related conditions to trigger service and/or sensor data measured during service processes.

In some implementations, the data sources 4712 can include parts data, including but not limited to parts usage and sales data. For example, the data sources 4712 can indicate various parts associated with installation or repair of items of equipment. The data sources 4712 can indicate tools for performing service and/or installing parts.

In some implementations, the data sources 4712 can include sustainability data. The sustainability data can include data that is provided by the data sources 310 and/or the user device 318. For example, the sustainability data can include a sustainability goal that has been established for the building. The sustainability data also include data similar the data that is stored by the database 340. For example, the sustainability data can include operational metrics, building metrics, occupancy metrics, equipment inventory, maintenance records, building improvement records, and/or building upkeep information. The sustainability data can also include at least one of weather data, utility data, a baseline sustainability performance for the building, and/or the ECM saving category actions described herein. The sustainability data can also include FIMs, ECMs and/or energy conservation protocols similar to those generated by the ECM manager 305.

The system 4700 can include, with the data of the data sources 4712, labels to facilitate cross-reference between items of data that may relate to common items of equipment, sites, service technicians, customers, or various combinations thereof. For example, data from disparate sources may be labeled with time data, which can allow the system 4700 (e.g., by configuring the models 4704, 4716) to increase a likelihood of associating information from the disparate sources due to the information being detected or recorded (e.g., as energy conservation protocols, ECMs, and/or FIMS) at the same time or near in time.

For example, the data sources 4712 can include data that can be particular to specific or similar items of equipment, buildings, equipment configurations, environmental states, or various combinations thereof. In some implementations, the data includes labels or identifiers of such information, such as to indicate locations, weather conditions, timing information, uses of the items of equipment or the buildings or sites at which the items of equipment are present, etc. This can enable the models 4704, 4716 to detect patterns of usage (e.g., spikes; troughs; seasonal or other temporal patterns) or other information that may be useful for determining roles and/or impacts that the items of equipment have on the sustainability of the building, such as to allow the models 4704, 4716 to be trained using information indicative of sustainability factors across multiple items of equipment (which may have the same or similar impact on the sustainability of the building even if the data regarding the items of equipment is not identical). For example, an item of equipment may be at a site that is a museum; by relating site usage or occupancy data with data regarding the item of equipment, such as sensor data and service reports, the system 4700 can configure the models 4704, 4716 to determine a high likelihood of the sustainability of the building being impacted by high usage (e.g., gala, major exhibit opening), and can generate recommendations to perform given ECMs or FIMs prior to the events.

### Model Configuration

Referring further to FIG. 47, the model updater 4708 can perform various machine learning model configuration/training operations to determine the second models 4716 using the data from the data sources 4712. For example, the model updater 4708 can perform various updating, optimization, retraining, reconfiguration, fine-tuning, or transfer learning operations, or various combinations thereof, to determine the second models 4716. The model updater 4708 can configure the second models 4716, using the data sources 4712, to generate outputs (e.g., completions) in response to receiving inputs (e.g., prompts), where the inputs and outputs can be analogous to data of the data sources 4712.

For example, the model updater 4708 can identify one or more parameters (e.g., weights and/or biases) of one or more layers of the first model 4704, and maintain (e.g., freeze, maintain as the identified values while updating) the values of the one or more parameters of the one or more layers. In some implementations, the model updater 4708 can modify the one or more layers, such as to add, remove, or change an output layer of the one or more layers, or to not maintain the values of the one or more parameters. The model updater 4708 can select at least a subset of the identified one or parameters to maintain according to various criteria, such as user input or other instructions indicative of an extent to which the first model 4704 is to be modified to determine the second model 4716. In some implementations, the model updater 4708 can modify the first model 4704 so that an output layer of the first model 4704 corresponds to output to be determined for applications 4720.

Responsive to selecting the one or more parameters to maintain, the model updater 4708 can apply, as input to the second model 4716 (e.g., to a candidate second model 4716, such as the modified first model 4704, such as the first model 4704 having the identified parameters maintained as the identified values), training data from the data sources 4712. For example, the model updater 4708 can apply the training data as input to the second model 4716 to cause the second model 4716 to generate one or more candidate outputs.

The model updater 4708 can evaluate a convergence condition to modify the candidate second model 4716 based at least on the one or more candidate outputs and the training data applied as input to the candidate second model 4716. For example, the model updater 4708 can evaluate an objective function of the convergence condition, such as a loss function (e.g., L1 loss, L2 loss, root mean square error, cross-entropy or log loss, etc.) based on the one or more candidate outputs and the training data; this evaluation can indicate how closely the candidate outputs generated by the candidate second model 4716 correspond to the ground truth represented by the training data. The model updater 4708 can use any of a variety of optimization algorithms (e.g., gradient descent, stochastic descent, Adam optimization, etc.) to modify one or more parameters (e.g., weights or biases of the layer(s) of the candidate second model 4716 that are not frozen) of the candidate second model 4716 according to the evaluation of the objective function. In some implementations, the model updater 4708 can use various hyperparameters to evaluate the convergence condition and/or perform the configuration of the candidate second model 4716 to determine the second model 4716, including but not limited to hyperparameters such as learning rates, numbers of iterations or epochs of training, etc.

As described further herein with respect to applications 4720, in some implementations, the model updater 4708 can select the training data from the data of the data sources 4712 to apply as the input based at least on a particular application of the plurality of applications 4720 for which the second model 4716 is to be used for. For example, the model updater 4708 can select data from the parts data source 4712 for the product recommendation generator application 4720, or select various combinations of data from the data sources 4712 (e.g., engineering data, operational data, and service data) for the service recommendation generator application 4720. As another example, the model updater 4708 can select data form the sustainability data source 4712 for ECM Manager application 4720. The model updater 4708 can apply various combinations of data from various data sources 4712 to facilitate configuring the second model 4716 for one or more applications 4720.

In some implementations, the system 4700 can perform at least one of conditioning, classifier-based guidance, or classifier-free guidance to configure the second model 4716 using the data from the data sources 4712. For example, the system 4700 can use classifiers associated with the data, such as identifiers of the item of equipment, a type of the item of equipment, a type of entity operating the item of equipment, a site at which the item of equipment is provided, or a history of issues at the site, to condition the training of the second model 4716. For example, the system 4700 combine (e.g., concatenate) various such classifiers with the data for inputting to the second model 4716 during training, for at least a subset of the data used to configure the second model 4716, which can enable the second model 4716 to be responsive to analogous information for runtime/inference time operations.

### Applications

Referring further to FIG. 47, the system 4700 can use outputs of the one or more second models 4716 to implement one or more applications 4720. For example, the second models 4716, having been configured using data from the data sources 4712, can be capable of precisely generating outputs that represent useful, timely, and/or real-time information for the applications 4720. In some implementations, each application 4720 is coupled with a corresponding second model 4716 that is specifically configured to generate outputs for use by the application 4720. Various applications 4720 can be coupled with one another, such as to provide outputs from a first application 4720 as inputs or portions of inputs to a second application 4720.

The applications 4720 can include any of a variety of desktop, web-based/browser-based, or mobile applications. For example, the applications 4720 can be implemented by enterprise management software systems, employee, or other user applications (e.g., applications that relate to BMS functionality such as temperature control, user preferences, conference room scheduling, etc.), equipment portals that provide data regarding items of equipment, or various combinations thereof. The applications 4720 can include user interfaces, wizards, checklists, conversational interfaces, chatbots, configuration tools, or various combinations thereof. The applications 4720 can receive an input, such as a prompt (e.g., from a user), provide the prompt to the second model 4716 to cause the second model 4716 to generate an output, such as a completion in response to the prompt, and present an indication of the output. The applications 4720 can receive inputs and/or present outputs in any of a variety of presentation modalities, such as text, speech, audio, image, and/or video modalities. For example, the applications 4720 can receive unstructured or freeform inputs from a user, such as a service technician, and generate reports in a standardized format, such as a customer-specific format. This can allow, for example, technicians to automatically, and flexibly, generate customer-ready reports after service visits without requiring strict input by the technician or manually sitting down and writing reports; to receive inputs as dictations in order to generate reports; to receive inputs in any form or a variety of forms, and use the second model 4716 (which can be trained to cross-reference metadata in different portions of inputs and relate together data elements) to generate output reports (e.g., the second model 4716, having been configured with data that includes time information, can use timestamps of input from dictation and timestamps of when an image is taken, and place the image in the report in a target position or label based on time correlation).

The applications 4720 can also receive unstructured or freeform inputs from a user, such as a building manager, and generate sustainability reports that include sustainability factors (e.g., roles and/or impacts associated with pieces of equipment, ECMs, FIMs, and/or energy conservation protocols. The second model 4716 can also be used to detect sustainability factors that may arise from certain actions associated with the building and provide recommendation, prior to the action occurring, to adjust the impact on the certain actions on the sustainability of the building. The second model 4716 can also receive prompts, from a user, to generate recommendations to improve a sustainability performance of the building. The second model 4716 may be trained with data provided by the sustainability data source 4712 to identify similarities between the building and data associated with buildings included in the sustainability data sources 4712.

In some implementations, the applications 4720 include at least one virtual assistant (e.g., virtual assistance for technician services) application 4720. The virtual assistant application can provide various services to support technician operations, such as presenting information from service requests, receiving queries regarding actions to perform to service items of equipment, and presenting responses indicating actions to perform to service items of equipment. The virtual assistant application can receive information regarding an item of equipment to be serviced, such as sensor data, text descriptions, or camera images, and process the received information using the second model 4716 to generate corresponding responses.

For example, the virtual assistant application 4720 can be implemented in a UI/UX wizard configuration, such as to provide a sequence of requests for information from the user (the sequence may include requests that are at least one of predetermined or dynamically generated responsive to inputs from the user for previous requests). For example, the virtual assistant application 4720 can provide one or more requests for users such as service technicians, facility managers, or other occupants, and provide the received responses to at least one of the second model 4716 or a root cause detection function (e.g., algorithm, model, data structure mapping inputs to candidate causes, etc.) to determine a prediction of a cause of the issue of the item of equipment and/or solutions. The virtual assistant application 4720 can use requests for information such as for unstructured text by which the user describes characteristics of the item of equipment relating to the issue; answers expected to correspond to different scenarios indicative of the issue; and/or image and/or video input (e.g., images of problems, equipment, spaces, etc. that can provide more context around the issue and/or configurations). For example, responsive to receiving a response via the virtual assistant application 4720 indicating that the problem is with temperature in the space, the system 4700 can request, via the virtual assistant application 4720, information regarding HVAC-R equipment associated with the space, such as pictures of the space, an air handling unit, a chiller, or various combinations thereof.

The virtual assistant application 4720 can include a plurality of applications 4720 (e.g., variations of interfaces or customizations of interfaces) for a plurality of respective user types. For example, the virtual assistant application 4720 can include a first application 4720 for a customer user, and a second application 4720 for a service technician user. The virtual assistant applications 4720 can allow for updating and other communications between the first and second applications 4720 as well as the second model 4716. Using one or more of the first application 4720 and the second application 4720, the system 4700 can manage continuous/real-time conversations for one or more users, and evaluate the users' engagement with the information provided (e.g., did the user, customer, service technician, etc., follow the provided steps for responding to the issue or performing service, did the user discontinue providing inputs to the virtual assistant application 4720, etc.), such as to enable the system 4700 to update the information generated by the second model 4716 for the virtual assistant application 4720 according to the engagement. In some implementations, the system 4700 can use the second model 4716 to detect sentiment of the user of the virtual assistant application 4720, and update the second model 4716 according to the detected sentiment, such as to improve the experience provided by the virtual assistant application 4720.

The applications 4720 can include at least one document writer application 4720, such as a technical document writer. The document writer application 4720 can facilitate preparing structured (e.g. form-based) and/or unstructured documentation, such as documentation associated with service requests. For example, the document writer application 4720 can present a user interface corresponding to a template document to be prepared that is associated with at least one of a service request or the item of equipment for which the service request is generated, such as to present one or more predefined form sections or fields. The document writer application 4720 can use inputs, such as prompts received from the users and/or technical data provided by the user regarding the item of equipment, such as sensor data, text descriptions, or camera images, to generate information to include in the documentation. For example, the document writer application 4720 can provide the inputs to the second model 4716 to cause the second model 4716 to generate completions for text information to include in the fields of the documentation.

The applications 4720 can include, in some implementations, at least one diagnostics and troubleshooting application 4720. The diagnostics and troubleshooting application 4720 can receive inputs including at least one of a service request or information regarding the item of equipment to be serviced, such as information identified by a service technician. The diagnostics and troubleshooting application 4720 can provide the inputs to a corresponding second model 4716 to cause the second model 4716 to generate outputs such as indications of potential items to be checked regarding the item of equipment, modifications or fixes to make to perform the service, or values or ranges of values of parameters of the item of equipment that may be indicative of specific issues to for the service technician to address or repair.

The applications 4720 can include at least one service recommendation generator application 4720. The service recommendation generator application 4720 can receive inputs such as a service request or information regarding the item of equipment to be serviced, and provide the inputs to the second model 4716 to cause the second model 4716 to generate outputs for presenting service recommendations, such as actions to perform to address the service request.

In some implementations, the applications 4720 can include a product recommendation generator application 4720. The product recommendation generator application 4720 can process inputs such as information regarding the item of equipment or the service request, using one or more second models 4716 (e.g., models trained using parts data from the data sources 4712), to determine a recommendation of a part or product to replace or otherwise use for repairing the item of equipment.

In some implementations, the applications 4720 can include at least one ECM manager application 4720. The ECM manager application 4720 can process inputs pertaining to the sustainability of the building. For example, the ECM manager application 4720 can receive inputs including a sustainability goal for a building. The ECM manager application 4720 can, using one or more second models 4716 (e.g., models trained using sustainability data from the data sources 4712 generate FIMS, ECMs, and/or energy conservation protocols. The ECM manager application 4720 and/or the one or more second models 4716 may perform similar functionality to that of the ECM manager 305. For example, the one or more second models 4716 can be trained to receive, as prompts, requests for FIMs that can be used to reduce the carbon emissions of the building. The one or more second models 4716 can provide, as one or more responses, at least one of reports, energy conservation protocols, and/or recommendations that include ECMs and/or FIMs. The response can also include predicted impacts associated with the ECMs and/or FIMs. The predicted impacts and/or the reports can be presented within at least one of the user interfaces described herein.

The ECM manager application 4720 can include a recommendation engine. The recommendation engine can receive inputs including building specifications, BIMs, sustainability metrics (e.g., emission values, equipment utilization, occupancy metrics, sustainability performance levels, sustainability goals, etc.). The recommendation engine can receive the inputs from a user (e.g., someone interacting with and/or interfacing with the ECM manager application 4720). For example, a first input can be the user entering and/or providing a BIM pertaining to the building. The recommendation engine can, based on the first input, prompt the user for additional information. The recommendation engine can also generate a response. For example, the recommendation engine can provide an energy conservation protocol that may result in a sustainability goal being reached.

The recommendation engine can also generate a sustainability goal for the building. For example, the recommendation engine can receive one or more inputs from the user. The inputs can include data that is provided by at least one of the data sources described herein. For example, the inputs can include operational metrics. The recommendation engine can generate, using the data provided by the input, a sustainability goal that may be achievable in given amount of time. The inputs can also include the user prompting the recommendation engine to determine how realistic the sustainability goal is based on the amount of time established to reach the sustainability goal. For example, the sustainability goal can be to reduce the carbon emissions of the building by 20% within the next 5 years. The recommendation engine, based on the timeframe of 5 years, can determine if the year over year reduction in carbon emissions that may result in the 20% reduction of carbon emissions is achievable.

### Feedback Training

Referring further to FIG. 47, the system 4700 can include at least one feedback trainer 4728 coupled with at least one feedback repository 4724. The system 4700 can use the feedback trainer 4728 to increase the precision and/or accuracy of the outputs generated by the second models 4716 according to feedback provided by users of the system 4700 and/or the applications 4720.

The feedback repository 4724 can include feedback received from users regarding output presented by the applications 4720. For example, for at least a subset of outputs presented by the applications 4720, the applications 4720 can present one or more user input elements for receiving feedback regarding the outputs. The user input elements can include, for example, indications of binary feedback regarding the outputs (e.g., good/bad feedback; feedback indicating the outputs do or do not meet the user's criteria, such as criteria regarding technical accuracy or precision); indications of multiple levels of feedback (e.g., scoring the outputs on a predetermined scale, such as a 1-5 scale or 1-10 scale); freeform feedback (e.g., text or audio feedback); or various combinations thereof.

The system 4700 can store and/or maintain feedback in the feedback repository 4724. In some implementations, the system 4700 stores the feedback with one or more data elements associated with the feedback, including but not limited to the outputs for which the feedback was received, the second model(s) 4716 used to generate the outputs, and/or input information used by the second models 4716 to generate the outputs (e.g., sustainability reports, energy conservation protocols, FIMs, ECMs, sustainability impact warnings, service request information; information captured by the user regarding the item of equipment).

The feedback trainer 4728 can update the one or more second models 4716 using the feedback. The feedback trainer 4728 can be similar to the model updater 4708. In some implementations, the feedback trainer 4728 is implemented by the model updater 4708; for example, the model updater 4708 can include or be coupled with the feedback trainer 4728. The feedback trainer 4728 can perform various configuration operations (e.g., retraining, fine-tuning, transfer learning, etc.) on the second models 4716 using the feedback from the feedback repository 4724. In some implementations, the feedback trainer 4728 identifies one or more first parameters of the second model 4716 to maintain as having predetermined values (e.g., freeze the weights and/or biases of one or more first layers of the second model 4716), and performs a training process, such as a fine tuning process, to configure parameters of one or more second parameters of the second model 4716 using the feedback (e.g., one or more second layers of the second model 4716, such as output layers or output heads of the second model 4716).

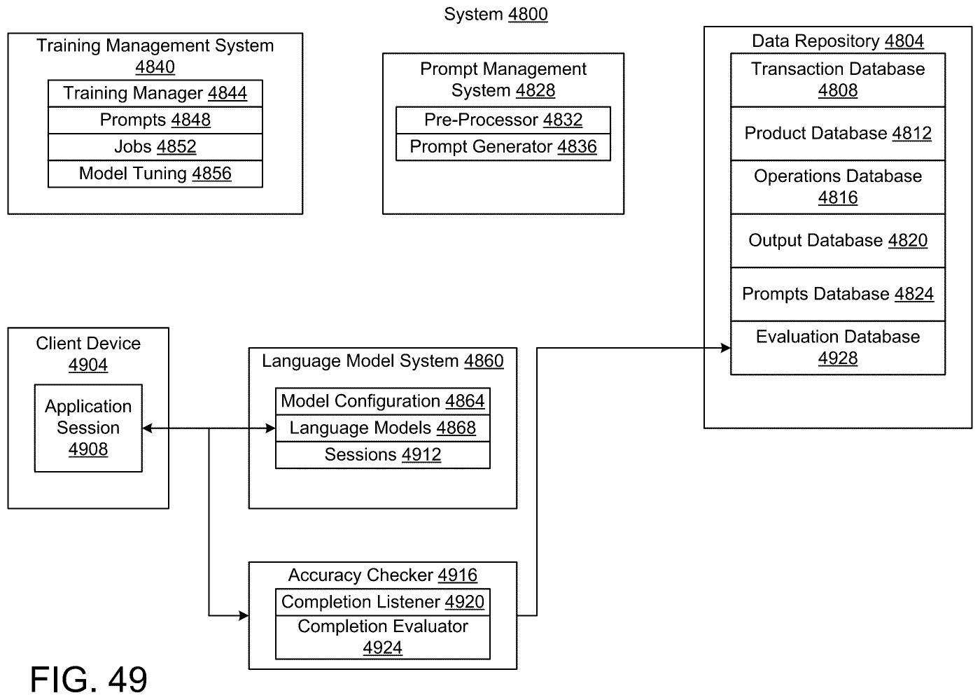

In some implementations, the system 4700 may not include and/or use the model updater 4708 (or the feedback trainer 4728) to determine the second models 4716. For example, the system 4700 can include or be coupled with an output processor (e.g., an output processor similar or identical to accuracy checker 4916 described with reference to FIG. 49) that can evaluate and/or modify outputs from the first model 4704 prior to operation of applications 4720, including to perform any of various post-processing operations on the output from the first model 4704. For example, the output processor can compare outputs of the first model 4704 with data from data sources 4712 to validate the outputs of the first model 4704 and/or modify the outputs of the first model 4704 (or output an error) responsive to the outputs not satisfying a validation condition.

### Connected Machine Learning Models

Referring further to FIG. 47, the second model 4716 can be coupled with one or more third models, functions, or algorithms for training/configuration and/or runtime operations. The third models can include, for example and without limitation, any of various models relating to items of equipment, such as energy usage models, sustainability models, carbon models, air quality models, or occupant comfort models. For example, the second model 4716 can be used to process unstructured information regarding items of equipment into predefined template formats compatible with various third models, such that outputs of the second model 4716 can be provided as inputs to the third models; this can allow more accurate training of the third models, more training data to be generated for the third models, and/or more data available for use by the third models. The second model 4716 can receive inputs from one or more third models, which can provide greater data to the second model 4716 for processing.

### Automated Service Scheduling and Provisioning

The system 4700 can be used to automate operations for scheduling, provisioning, and deploying service technicians and resources for service technicians to perform service operations. For example, the system 4700 can use at least one of the first model 4704 or the second model 4716 to determine, based on processing information regarding service operations for items of equipment relative to completion criteria for the service operation, particular characteristics of service operations such as experience parameters of scheduled service technicians, identifiers of parts provided for the service operations, geographical data, types of customers, types of problems, or information content provided to the service technicians to facilitate the service operation, where such characteristics correspond to the completion criteria being satisfied (e.g., where such characteristics correspond to an increase in likelihood of the completion criteria being satisfied relative to other characteristics for service technicians, parts, information content, etc.). For example, the system 4700 can determine, for a given item of equipment, particular parts to include on a truck to be sent to the site of the item of equipment. As such, the system 4700, responsive to processing inputs at runtime such as service requests, can automatically and more accurately identify service technicians and parts to direct to the item of equipment for the service operations. The system 4700 can use timing information to perform batch scheduling for multiple service operations and/or multiple technicians for the same or multiple service operations. The system 4700 can perform batch scheduling for multiple trucks for multiple items of equipment, such as to schedule a first one or more parts having a greater likelihood for satisfying the completion criteria for a first item of equipment on a first truck, and a second one or more parts having a greater likelihood for satisfying the completion criteria for a second item of equipment on a second truck.

### Automated Energy Conservation Protocols

The system 4700 can be used to automate operations for generating, tracking, implementing, and deploying energy conservation protocols. For example, the system 4700 can use at least one of the first model 4704 or the second model 4716 to generate FIMs and/or ECMs that can be implemented to improve the sustainability performance of the building. The energy conservation protocols may also be used to achieve, reach, and/or otherwise move towards a sustainability goal of the building. For example, the system 4700 can recognize, generate, and/or otherwise determine actions (e.g., FIMs and ECMs) that can be taken and/or otherwise performed to reach the sustainability goal for the building.

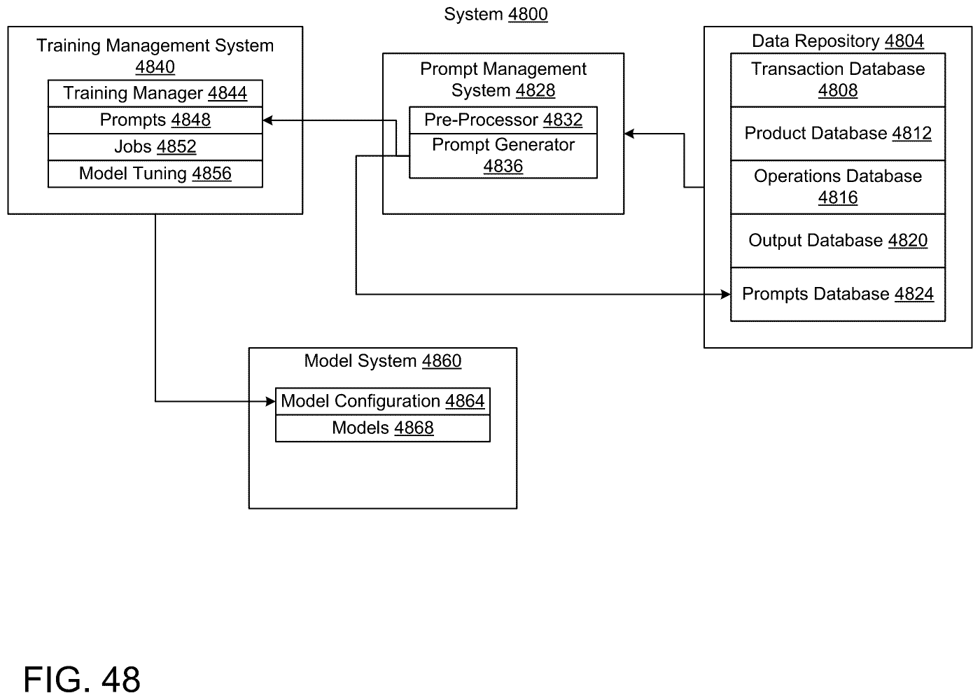

FIG. 48 depicts an example of a system 4800. The system 4800 can include one or more components or features of the system 4700, such as any one or more of the first model 4704, data sources 4712, second model 4716, applications 4720, feedback repository 4724, and/or feedback trainer 4728. The system 4800 can perform specific operations to enable generative AI applications for building managements systems and equipment servicing, such as various manners of processing input data into training data (e.g., tokenizing input data; forming input data into prompts and/or completions), and managing training and other machine learning model configuration processes. Various components of the system 4800 can be implemented using one or more computer systems, which may be provided on the same or different processors (e.g., processors communicatively coupled via wired and/or wireless connections).

The system 4800 can include at least one data repository 4804, which can be similar to the data sources 4712 described with reference to FIG. 47. For example, the data repository 4804 can include a transaction database 4808, which can be similar or identical to one or more of warranty data or service data of data sources 112. For example, the transaction database 4808 can include data such as parts used for service transactions; sales data indicating various service transactions or other transactions regarding items of equipment; warranty and/or claims data regarding items of equipment; and service data.

The data repository 4804 can include a product database 4812, which can be similar or identical to the parts data of the data sources 112. The product database 4812 can include, for example, data regarding products available from various vendors, specifications or parameters regarding products, and indications of products used for various service operations. The product database 4812 can include data such as events or alarms associated with products; logs of product operation; and/or time series data regarding product operation, such as longitudinal data values of operation of products and/or building equipment.

The data repository 4804 can include an operations database 4816, which can be similar or identical to the operations data of the data sources 112. For example, the operations database 4816 can include data such as manuals regarding parts, products, and/or items of equipment; customer service data; and or reports, such as operation or service logs.

In some implementations, the data repository 4804 can include an output database 4820, which can include data of outputs that may be generated by various machine learning models and/or algorithms. For example, the output database 4820 can include values of pre-calculated predictions and/or insights, such as parameters regarding operation items of equipment, such as setpoints, changes in setpoints, flow rates, control schemes, identifications of error conditions, or various combinations thereof.

As depicted in FIG. 48, the system 4800 can include a prompt management system 4828. The prompt management system 4828 can include one or more rules, heuristics, logic, policies, algorithms, functions, machine learning models, neural networks, scripts, or various combinations thereof to perform operations including processing data from data repository 4804 into training data for configuring various machine learning models. For example, the prompt management system 4828 can retrieve and/or receive data from the data repository 4804 and determine training data elements that include examples of input and outputs for generation by machine learning models, such as a training data element that includes a prompt and a completion corresponding to the prompt, based on the data from the data repository 4804.

In some implementations, the prompt management system 4828 includes a pre-processor 4832. The pre-processor 4832 can perform various operations to prepare the data from the data repository 4804 for prompt generation. For example, the pre-processor 4832 can perform any of various filtering, compression, tokenizing, or combining (e.g., combining data from various databases of the data repository 4804) operations.

The prompt management system 4828 can include a prompt generator 4836. The prompt generator 4836 can generate, from data of the data repository 4804, one or more training data elements that include a prompt and a completion corresponding to the prompt. In some implementations, the prompt generator 4836 receives user input indicative of prompt and completion portions of data. For example, the user input can indicate template portions representing prompts of structured data, such as predefined fields or forms of documents, and corresponding completions provided for the documents. The user input can assign prompts to unstructured data. In some implementations, the prompt generator 4836 automatically determines prompts and completions from data of the data repository 4804, such as by using any of various natural language processing algorithms to detect prompts and completions from data. In some implementations, the system 4800 does not identify distinct prompts and completions from data of the data repository 4804.

Referring further to FIG. 48, the system 4800 can include a training management system 4840. The training management system 4840 can include one or more rules, heuristics, logic, policies, algorithms, functions, machine learning models, neural networks, scripts, or various combinations thereof to perform operations including controlling training of machine learning models, including performing fine tuning and/or transfer learning operations.

The training management system 4840 can include a training manager 4844. The training manager 4844 can incorporate features of at least one of the model updater 4708 or the feedback trainer 4728 described with reference to FIG. 47. For example, the training manager 4844 can provide training data including a plurality of training data elements (e.g., prompts and corresponding completions) to the model system 4860 as described further herein to facilitate training machine learning models.

In some implementations, the training management system 4840 includes a prompts database 4848. For example, the training management system 4840 can store one or more training data elements from the prompt management system 4828, such as to facilitate asynchronous and/or batched training processes.

The training manager 4844 can control the training of machine learning models using information or instructions maintained in a model tuning database 4856. For example, the training manager 4844 can store, in the model tuning database 4856, various parameters or hyperparameters for models and/or model training.

In some implementations, the training manager 4844 stores a record of training operations in a jobs database 4852. For example, the training manager 4844 can maintain data such as a queue of training jobs, parameters or hyperparameters to be used for training jobs, or information regarding performance of training.

Referring further to FIG. 48, the system 4800 can include at least one model system 4860 (e.g., one or more language model systems). The model system 4860 can include one or more rules, heuristics, logic, policies, algorithms, functions, machine learning models, neural networks, scripts, or various combinations thereof to perform operations including configuring one or more machine learning models 4868 based on instructions from the training management system 4840. In some implementations, the training management system 4840 implements the model system 4860. In some implementations, the training management system 4840 can access the model system 4860 using one or more APIs, such as to provide training data and/or instructions for configuring machine learning models 4868 via the one or more APIs. The model system 4860 can operate as a service layer for configuring the machine learning models 4868 responsive to instructions from the training management system 4840. The machine learning models 4868 can be or include the first model 4704 and/or second model 4716 described with reference to FIG. 47.

The model system 4860 can include a model configuration processor 4864. The model configuration processor 4864 can incorporate features of the model updater 4708 and/or the feedback trainer 4728 described with reference to FIG. 47. For example, the model configuration processor 4864 can apply training data (e.g., prompts database 4848 and corresponding completions) to the machine learning models 4868 to configure (e.g., train, modify, update, fine-tune, etc.) the machine learning models 4868. The training manager 4844 can control training by the model configuration processor 4864 based on model tuning parameters in the model tuning database 4856, such as to control various hyperparameters for training. In various implementations, the system 4800 can use the training management system 4840 to configure the machine learning models 4868 in a similar manner as described with reference to the second model 4716 of FIG. 47, such as to train the machine learning models 4868 using any of various data or combinations of data from the data repository 4804.

### Application Session Management

FIG. 49 depicts an example of the system 4800, in which the system 4800 can perform operations to implement at least one application session 4908 for a client device 4904. For example, responsive to configuring the machine learning models 4868, the system 4800 can generate data for presentation by the client device 4904 (including generating data responsive to information received from the client device 4904) using the at least one application session 4908 and the one or more machine learning models 4868.

The client device 4904 can be a device of a user, such as a technician or building manager. The client device 4904 can include any of various wireless or wired communication interfaces to communicate data with the model system 4860, such as to provide requests to the model system 4860 indicative of data for the machine learning models 4868 to generate, and to receive outputs from the model system 4860. The client device 4904 can include various user input and output devices to facilitate receiving and presenting inputs and outputs.

In some implementations, the system 4800 provides data to the client device 4904 for the client device 4904 to operate the at least one application session 4908. The application session 4908 can include a session corresponding to any of the applications 4720 described with reference to FIG. 47. For example, the client device 4904 can launch the application session 4908 and provide an interface to request one or more prompts. Responsive to receiving the one or more prompts, the application session 4908 can provide the one or more prompts as input to the machine learning model 4868. The machine learning model 4868 can process the input to generate a completion, and provide the completion to the application session 4908 to present via the client device 4904. In some implementations, the application session 4908 can iteratively generate completions using the machine learning models 4868. For example, the machine learning models 4868 can receive a first prompt from the application session 4908, determine a first completion based on the first prompt and provide the first completion to the application session 4908, receive a second prompt from the application session 4908, determine a second completion based on the second prompt (which may include at least one of the first prompt or the first completion concatenated to the second prompt), and provide the second completion to the application session 4908.

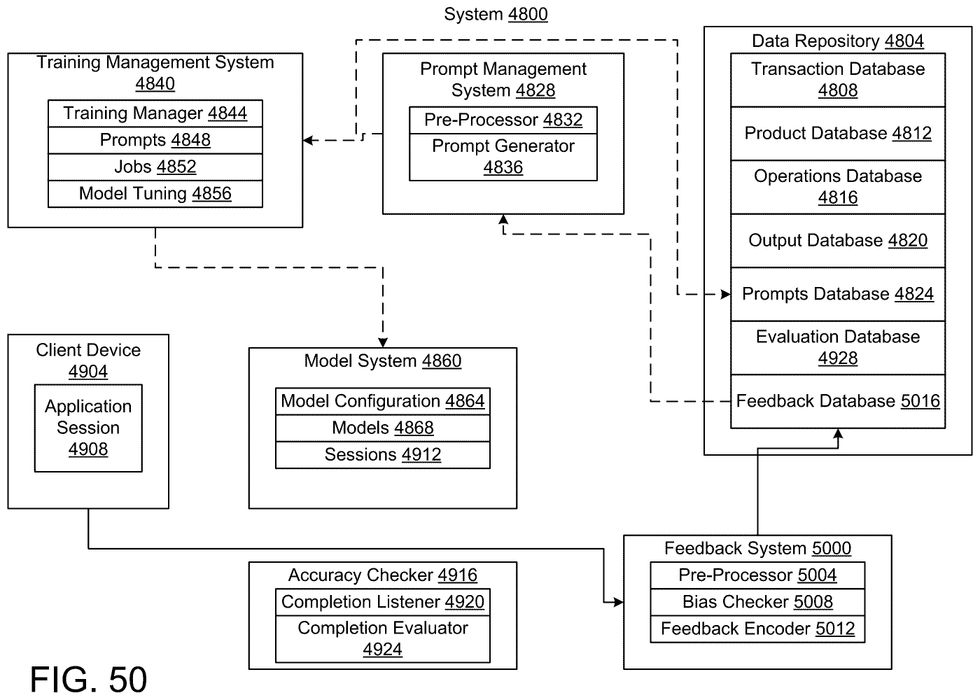

In some implementations, the model system 4860 includes at least one sessions database 4912. The sessions database 4912 can maintain records of application session 4908 implemented by client devices 4904. For example, the sessions database 4912 can include records of prompts provided to the machine learning models 4868 and completions generated by the machine learning models 4868. As described further with reference to FIG. 50, the system 4800 can use the data in the sessions database 4912 to fine-tune or otherwise update the machine learning models 4868.

### Completion Checking

In some implementations, the system 4800 includes an accuracy checker 4916. The accuracy checker 4916 can include one or more rules, heuristics, logic, policies, algorithms, functions, machine learning models, neural networks, scripts, or various combinations thereof to perform operations including evaluating performance criteria regarding the completions determined by the model system 4860. For example, the accuracy checker 4916 can include at least one completion listener 4920. The completion listener 4920 can receive the completions determined by the model system 4860 (e.g., responsive to the completions being generated by the machine learning model 4868 and/or by retrieving the completions from the sessions database 4912).

The accuracy checker 4916 can include at least one completion evaluator 4924. The completion evaluator 4924 can evaluate the completions (e.g., as received or retrieved by the completion listener 4920) according to various criteria. In some implementations, the completion evaluator 4924 evaluates the completions by comparing the completions with corresponding data from the data repository 4804. For example, the completion evaluator 4924 can identify data of the data repository 4804 having similar text as the prompts and/or completions (e.g., using any of various natural language processing algorithms), and determine whether the data of the completions is within a range of expected data represented by the data of the data repository 4804.

In some implementations, the accuracy checker 4916 can store an output from evaluating the completion (e.g., an indication of whether the completion satisfies the criteria) in an evaluation database 4928. For example, the accuracy checker 4916 can assign the output (which may indicate at least one of a binary indication of whether the completion satisfied the criteria or an indication of a portion of the completion that did not satisfy the criteria) to the completion for storage in the evaluation database 4928, which can facilitate further training of the machine learning models 4868 using the completions and output.

### Feedback Training

FIG. 50 depicts an example of the system 4800 that includes a feedback system 5000, such as a feedback aggregator. The feedback system 5000 can include one or more rules, heuristics, logic, policies, algorithms, functions, machine learning models, neural networks, scripts, or various combinations thereof to perform operations including preparing data for updating and/or updating the machine learning models 4868 using feedback corresponding to the application sessions 4908, such as feedback received as user input associated with outputs presented by the application sessions 4908. The feedback system 5000 can incorporate features of the feedback repository 124 and/or feedback trainer 128 described with reference to FIG. 1.

The feedback system 5000 can receive feedback (e.g., from the client device 4904) in various formats. For example, the feedback can include any of text, speech, audio, image, and/or video data. The feedback can be associated (e.g., in a data structure generated by the application session 4908) with the outputs of the machine learning models 4868 for which the feedback is provided. The feedback can be received or extracted from various forms of data, including external data sources such as manuals, service reports, or Wikipedia-type documentation.

In some implementations, the feedback system 5000 includes a pre-processor 5004. The pre-processor 5004 can perform any of various operations to modify the feedback for further processing. For example, the pre-processor 5004 can incorporate features of, or be implemented by, the pre-processor 4832, such as to perform operations including filtering, compression, tokenizing, or translation operations (e.g., translation into a common language of the data of the data repository 4804).

The feedback system 5000 can include a bias checker 5008. The bias checker 5008 can evaluate the feedback using various bias criteria, and control inclusion of the feedback in a feedback database 5016 (e.g., a feedback database 5016 of the data repository 4804 as depicted in FIG. 50) according to the evaluation. The bias criteria can include, for example and without limitation, criteria regarding qualitative and/or quantitative differences between a range or statistic measure of the feedback relative to actual, expected, or validated values.

The feedback system 5000 can include a feedback encoder 5012. The feedback encoder 5012 can process the feedback (e.g., responsive to bias checking by the bias checker 5008) for inclusion in the feedback database 5016. For example, the feedback encoder 5012 can encode the feedback as values corresponding to outputs scoring determined by the model system 4860 while generating completions (e.g., where the feedback indicates that the completion presented via the application session 4908 was acceptable, the feedback encoder 5012 can encode the feedback by associating the feedback with the completion and assigning a relatively high score to the completion).

As indicated by the dashed arrows in FIG. 50, the feedback can be used by the prompt management system 4828 and training management system 4840 to further update one or more machine learning models 4868. For example, the prompt management system 4828 can retrieve at least one feedback (and corresponding prompt and completion data) from the feedback database 5016, and process the at least one feedback to determine a feedback prompt and feedback completion to provide to the training management system 4840 (e.g., using pre-processor 4832 and/or prompt generator 4836, and assigning a score corresponding to the feedback to the feedback completion). The training manager 4844 can provide instructions to the model system 4860 to update the machine learning models 4868 using the feedback prompt and the feedback completion, such as to perform a fine-tuning process using the feedback prompt and the feedback completion. In some implementations, the training management system 4840 performs a batch process of feedback-based fine tuning by using the prompt management system 4828 to generate a plurality of feedback prompts and a plurality of feedback completion, and providing instructions to the model system 4860 to perform the fine-tuning process using the plurality of feedback prompts and the plurality of feedback completions.

### Data Filtering and Validation Systems

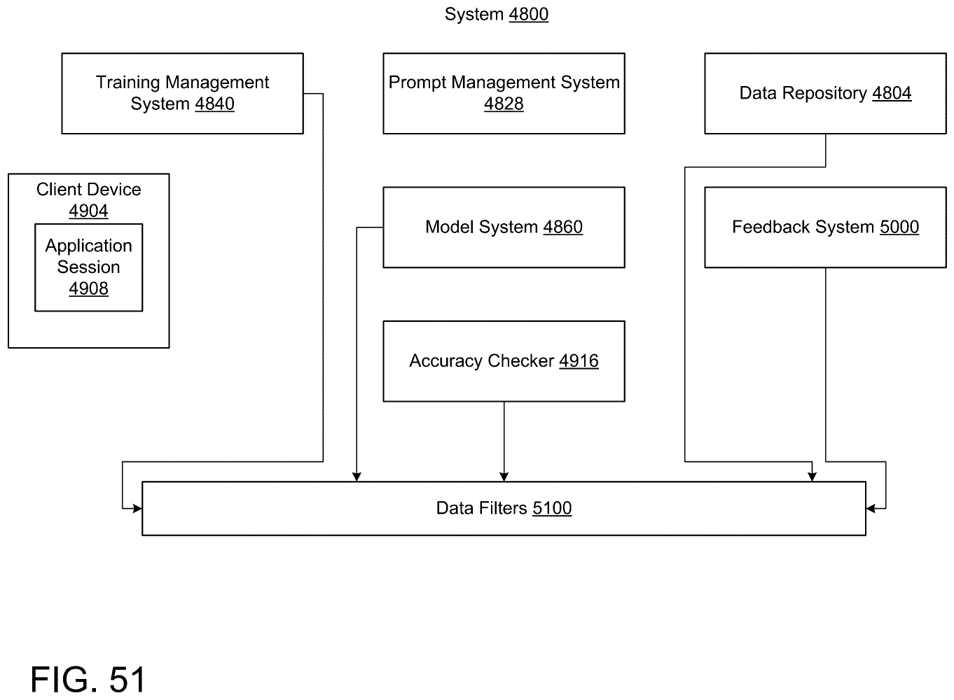

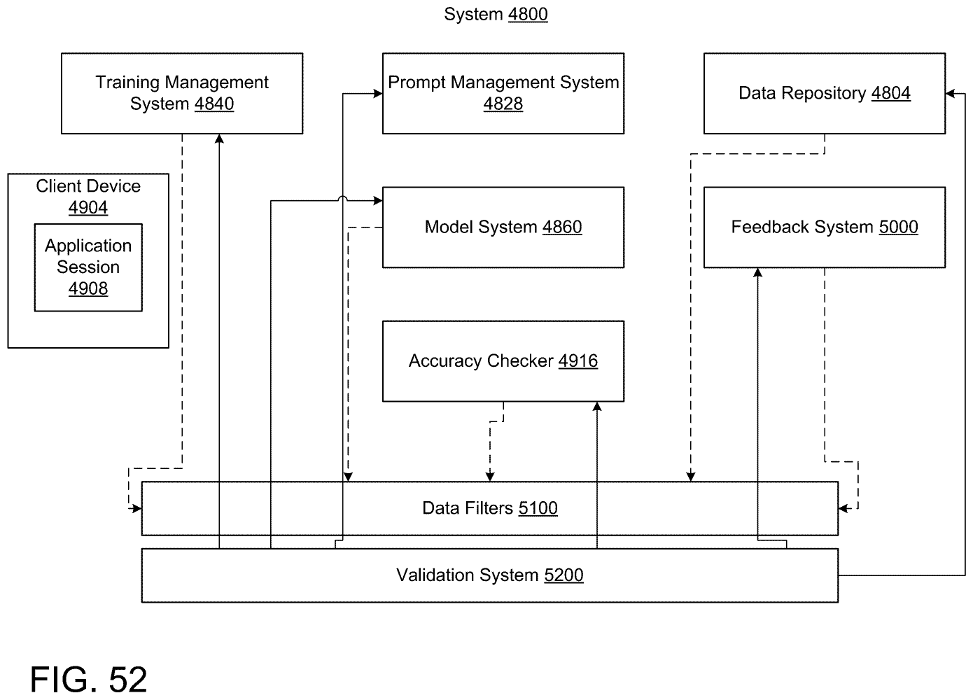

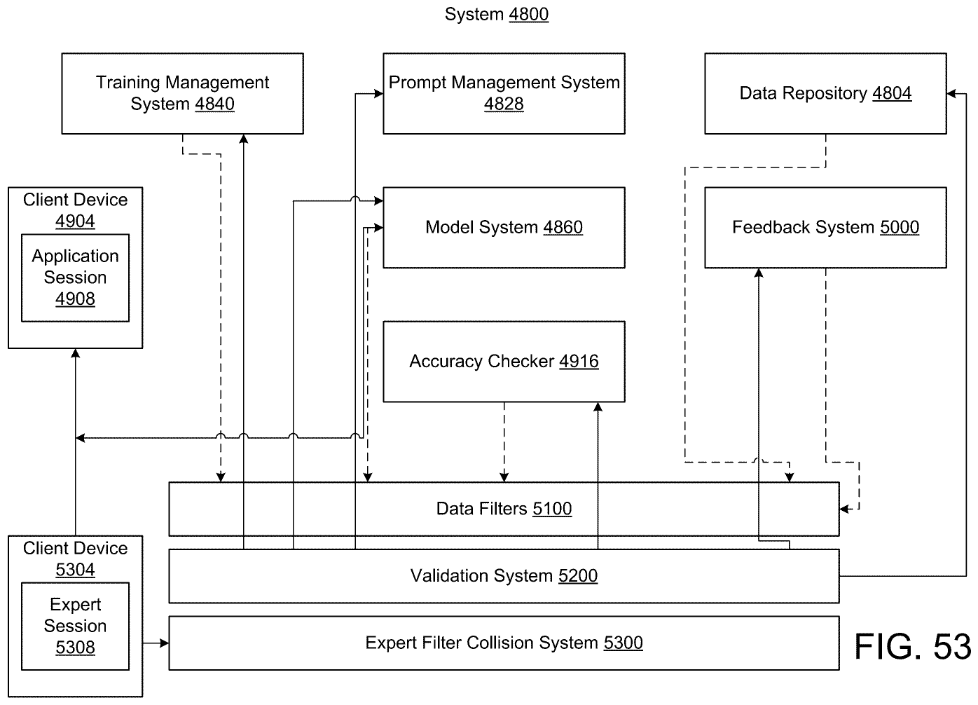

FIG. 51 depicts an example of the system 4800, where the system 4800 can include one or more data filters 5100 (e.g., data validators). The data filters 5100 can include any one or more rules, heuristics, logic, policies, algorithms, functions, machine learning models, neural networks, scripts, or various combinations thereof to perform operations including modifying data processed by the system 4800 and/or triggering alerts responsive to the data not satisfying corresponding criteria, such as thresholds for values of data. Various data filtering processes described with reference to FIG. 51 (as well as FIGS. 52 and 53) can enable the system 4800 to implement timely operations for improving the precision and/or accuracy of completions or other information generated by the system 4800 (e.g., including improving the accuracy of feedback data used for fine-tuning the machine learning models 4868). The data filters 5100 can allow for interactions between various algorithms, models, and computational processes.

For example, the data filters 5100 can be used to evaluate data relative to thresholds relating to data including, for example and without limitation, acceptable data ranges, setpoints, temperatures, pressures, flow rates (e.g., mass flow rates), or vibration rates for an item of equipment. The threshold can include any of various thresholds, such as one or more of minimum, maximum, absolute, relative, fixed band, and/or floating band thresholds.

The data filters 5100 can enable the system 4800 to detect when data, such as prompts, completions, or other inputs and/or outputs of the system 4800, collide with thresholds that represent realistic behavior or operation or other limits of items of equipment. For example, the thresholds of the data filters 5100 can correspond to values of data that are within feasible or recommended operating ranges. In some implementations, the system 4800 determines or receives the thresholds using models or simulations of items of equipment, such as plant or equipment simulators, chiller models, HVAC-R models, refrigeration cycle models, etc. The system 4800 can receive the thresholds as user input (e.g., from experts, technicians, or other users). The thresholds of the data filters 5100 can be based on information from various data sources. The thresholds can include, for example and without limitation, thresholds based on information such as equipment limitations, safety margins, physics, expert teaching, etc. For example, the data filters 5100 can include thresholds determined from various models, functions, or data structures (e.g., tables) representing physical properties and processes, such as physics of psychometrics, thermodynamics, and/or fluid dynamics information.

The system 4800 can determine the thresholds using the feedback system 5000 and/or the client device 4904, such as by providing a request for feedback that includes a request for a corresponding threshold associated with the completion and/or prompt presented by the application session 4908. For example, the system 4800 can use the feedback to identify realistic thresholds, such as by using feedback regarding data generated by the machine learning models 4868 for ranges, setpoints, and/or start-up or operating sequences regarding items of equipment (and which can thus be validated by human experts). In some implementations, the system 4800 selectively requests feedback indicative of thresholds based on an identifier of a user of the application session 4908, such as to selectively request feedback from users having predetermined levels of expertise and/or assign weights to feedback according to criteria such as levels of expertise.

In some implementations, one or more data filters 5100 correspond to a given setup. For example, the setup can represent a configuration of a corresponding item of equipment (e.g., configuration of a chiller, etc.). The data filters 5100 can represent various thresholds or conditions with respect to values for the configuration, such as feasible or recommendation operating ranges for the values. In some implementations, one or more data filters 5100 correspond to a given situation. For example, the situation can represent at least one of an operating mode or a condition of a corresponding item of equipment.

FIG. 51 depicts some examples of data (e.g., inputs, outputs, and/or data communicated between nodes of machine learning models 4868) to which the data filters 5100 can be applied to evaluate data processed by the system 4800 including various inputs and outputs of the system 4800 and components thereof. This can include, for example and without limitation, filtering data such as data communicated between one or more of the data repository 4804, prompt management system 4828, training management system 4840, model system 4860, client device 4904, accuracy checker 4916, and/or feedback system 5000. For example, the data filters 5100 (as well as validation system 5200 described with reference to FIG. 52 and/or expert filter collision system 5300 described with reference to FIG. 53) can receive data outputted from a source (e.g., source component) of the system 4800 for receipt by a destination (e.g., destination component) of the system 4800, and filter, modify, or otherwise process the outputted data prior to the system 4800 providing the outputted data to the destination. The sources and destinations can include any of various combinations of components and systems of the system 4800.

The system 4800 can perform various actions responsive to the processing of data by the data filters 5100. In some implementations, the system 4800 can pass data to a destination without modifying the data (e.g., retaining a value of the data prior to evaluation by the data filter 5100) responsive to the data satisfying the criteria of the respective data filter(s) 500. In some implementations, the system 4800 can at least one of (i) modify the data or (ii) output an alert responsive to the data not satisfying the criteria of the respective data filter(s) 500. For example, the system 4800 can modify the data by modifying one or more values of the data to be within the criteria of the data filters 5100.

In some implementations, the system 4800 modifies the data by causing the machine learning models 4868 to regenerate the completion corresponding to the data (e.g., for up to a predetermined threshold number of regeneration attempts before triggering the alert). This can enable the data filters 5100 and the system 4800 selectively trigger alerts responsive to determining that the data (e.g., the collision between the data and the thresholds of the data filters 5100) may not be repairable by the machine learning model 4868 aspects of the system 4800.

The system 4800 can output the alert to the client device 4904. The system 4800 can assign a flag corresponding to the alert to at least one of the prompt (e.g., in prompts database 4824) or the completion having the data that triggered the alert.

FIG. 52 depicts an example of the system 4800, in which a validation system 5200 is coupled with one or more components of the system 4800, such as to process and/or modify data communicated between the components of the system 4800. For example, the validation system 5200 can provide a validation interface for human users (e.g., expert supervisors, checkers) and/or expert systems (e.g., data validation systems that can implement processes analogous to those described with reference to the data filters 5100) to receive data of the system 4800 and modify, validate, or otherwise process the data. For example, the validation system 5200 can provide to human expert supervisors, human checkers, and/or expert systems various data of the system 4800, receive responses to the provided data indicating requested modifications to the data or validations of the data, and modify (or validate) the provided data according to the responses.

For example, the validation system 5200 can receive data such as data retrieved from the data repository 4804, prompts outputted by the prompt management system 4828, completions outputted by the model system 4860, indications of accuracy outputted by the accuracy checker 4916, etc., and provide the received data to at least one of an expert system or a user interface. In some implementations, the validation system 5200 receives a given item of data prior to the given item of data being processed by the model system 4860, such as to validate inputs to the machine learning models 4868 prior to the inputs being processed by the machine learning models 4868 to generate outputs, such as completions.

In some implementations, the validation system 5200 validates data by at least one of (i) assigning a label (e.g., a flag, etc.) to the data indicating that the data is validated or (ii) passing the data to a destination without modifying the data. For example, responsive to receiving at least one of a user input (e.g., from a human validator/supervisor/expert) that the data is valid or an indication from an expert system that the data is valid, the validation system 5200 can assign the label and/or provide the data to the destination.

The validation system 5200 can selectively provide data from the system 4800 to the validation interface responsive to operation of the data filters 5100. This can enable the validation system 5200 to trigger validation of the data responsive to collision of the data with the criteria of the data filters 5100. For example, responsive to the data filters 5100 determining that an item of data does not satisfy a corresponding criteria, the data filters 5100 can provide the item of data to the validation system 5200. The data filters 5100 can assign various labels to the item of data, such as indications of the values of the thresholds that the data filters 5100 used to determine that the item of data did not satisfy the thresholds. Responsive to receiving the item of data from the data filters 5100, the validation system 5200 can provide the item of data to the validation interface (e.g., to a user interface of client device 4904 and/or application session 4908; for comparison with a model, simulation, algorithm, or other operation of an expert system) for validation. In some implementations, the validation system 5200 can receive an indication that the item of data is valid (e.g., even if the item of data did not satisfy the criteria of the data filters 5100) and can provide the indication to the data filters 5100 to cause the data filters 5100 to at least partially modify the respective thresholds according to the indication.

In some implementations, the validation system 5200 selectively retrieves data for validation where (i) the data is determined or outputted prior to use by the machine learning models 4868, such as data from the data repository 4804 or the prompt management system 4828, or (ii) the data does not satisfy a respective data filter 5100 that processes the data. This can enable the system 4800, the data filters 5100, and the validation system 5200 to update the machine learning models 4868 and other machine learning aspects (e.g., generative AI aspects) of the system 4800 to more accurately generate data and completions (e.g., enabling the data filters 5100 to generate alerts that are received by the human experts/expert systems that may be repairable by adjustments to one or more components of the system 4800).

FIG. 53 depicts an example of the system 4800, in which an expert filter collision system 5300 (“expert system” 5300) can facilitate providing feedback and providing more accurate and/or precise data and completions to a user via the application session 4908. For example, the expert system 5300 can interface with various points and/or data flows of the system 4800, as depicted in FIG. 53, where the system 4800 can provide data to the expert filter collision system 5300, such as to transmit the data to a user interface and/or present the data via a user interface of the expert filter collision system 5300 that can accessed via an expert session 5308 of a client device 5304. For example, via the expert session 5308, the expert system 5300 can enable functions such as receiving inputs for a human expert to provide feedback to a user of the client device 4904; a human expert to guide the user through the data (e.g., completions) provided to the client device 4904, such as reports, insights, and action items; a human expert to review and/or provide feedback for revising insights, guidance, and recommendations before being presented by the application session 4908; a human expert to adjust and/or validate insights or recommendations before they are viewed or used for actions by the user; or various combinations thereof. In some implementations, the expert system 5300 can use feedback received via the expert session as inputs to update the machine learning models 4868 (e.g., to perform fine-tuning).

In some implementations, the expert system 5300 retrieves data to be provided to the application session 4908, such as completions generated by the machine learning models 4868. The expert system 5300 can present the data via the expert session 5308, such as to request feedback regarding the data from the client device 5304. For example, the expert system 5300 can receive feedback regarding the data for modifying or validating the data (e.g., editing or validating completions). In some implementations, the expert system 5300 requests at least one of an identifier or a credential of a user of the client device 5304 prior to providing the data to the client device 5304 and/or requesting feedback regarding the data from the expert session 5308. For example, the expert system 5300 can request the feedback responsive to determining that the at least one of the identifier or the credential satisfies a target value for the data. This can allow the expert session 5308 to selectively identify experts to use for monitoring and validating the data.

In some implementations, the expert system 5300 facilitates a communication session regarding the data, between the application session 4908 and the expert session 5308. For example, the expert system 5300, responsive to detecting presentation of the data via the application session 4908, can request feedback regarding the data (e.g., user input via the application session 4908 for feedback regarding the data), and provide the feedback to the client device 5304 to present via the expert session 5308. The expert session 5308 can receive expert feedback regarding at least one of the data or the feedback from the user to provide to the application session 4908. In some implementations, the expert system 5300 can facilitate any of various real-time or asynchronous messaging protocols between the application session 4908 and expert session 5308 regarding the data, such as any of text, speech, audio, image, and/or video communications or combinations thereof. This can allow the expert system 5300 to provide a platform for a user receiving the data (e.g., customer or field technician) to receive expert feedback from a user of the client device 5304 (e.g., expert technician). In some implementations, the expert system 5300 stores a record of one or more messages or other communications between the sessions 4908, 5308 in the data repository 4804 to facilitate further configuration of the machine learning models 4868 based on the interactions between the users of the sessions 4908, 5308.

### Building Data Platforms and Digital Twin Architectures

Referring further to FIGS. 47-53, various systems and methods described herein can be executed by and/or communicate with building data platforms, including data platforms of building management systems. For example, the data repository 4804 can include or be coupled with one or more building data platforms, such as to ingest data from building data platforms and/or digital twins. The client device 4904 can communicate with the system 4800 via the building data platform, and can feedback, reports, and other data to the building data platform. In some implementations, the data repository 4804 maintains building data platform-specific databases, such as to enable the system 4800 to configure the machine learning models 4868 on a building data platform-specific basis (or on an entity-specific basis using data from one or more building data platforms maintained by the entity).

For example, in some implementations, various data discussed herein may be stored in, retrieved from, or processed in the context of building data platforms and/or digital twins; processed at (e.g., processed using models executed at) a cloud or other off-premises computing system/device or group of systems/devices, an edge or other on-premises system/device or group of systems/devices, or a hybrid thereof in which some processing occurs off-premises and some occurs on-premises; and/or implemented using one or more gateways for communication and data management amongst various such systems/devices. In some such implementations, the building data platforms and/or digital twins may be provided within an infrastructure such as those described in U.S. patent application Ser. No. 17/134,661 filed Dec. 28, 2020, Ser. No. 18/080,360, filed Dec. 13, 2022, Ser. No. 17/537,046 filed Nov. 29, 2021, and Ser. No. 18/096,965, filed Jan. 13, 2023, and Indian Patent Application No. 202341008712, filed Feb. 10, 2023, the disclosures of which are incorporated herein by reference in their entireties.

### Artificial Intelligence Based Systems and Methods for Sustainability Improvements

As described above, systems and methods in accordance with the present disclosure can use machine learning models, including, but not limited to, LLMs and other generative AI models, to ingest data regarding building management systems and equipment in various unstructured and structured formats, and generate completions and other outputs targeted to provide useful information to users. Various systems and methods described herein can use machine learning models to support applications for presenting data with high accuracy and relevance.

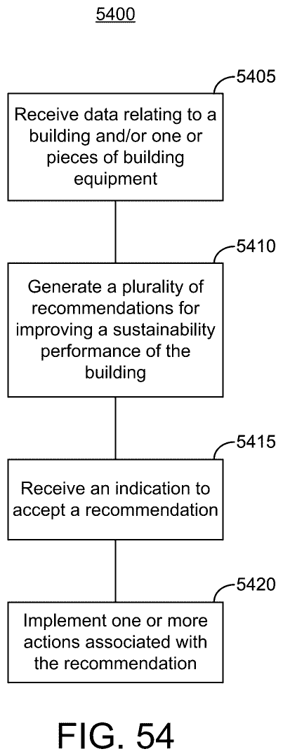

FIG. 54 depicts an example of a process 5400. The process 5400 can be performed using various devices and systems described herein, including by not limited to the system 4700, the system 4800, and/or one or more components thereof. Various aspects of the process 5400 can be implemented using one or more devices or systems that are communicatively coupled with one another, including client-server, cloud-based, or other network architectures. Additionally, at least one step of the process 5400 can be performed and/or executed by a ML model utilizing functionality similar to the ECM manager 305.

At step 5405, data relating to a building and/or one or pieces of building equipment can be received. The data can be received from a data source. For example, the data can be received from at least one of the data sources 4712 or the data source 310. In some embodiments, the data can be received by at least one of the models described herein. For example, the models 4716 can receive the data as an input. The data can relate to a sustainability performance of a building. For example, the data can include emission metrics for the building 10.

The data can also include records, files, and/or among other possible information that indicate a plurality of pieces of building equipment included in and/or otherwise servicing the building 10. In some embodiments, the plurality of pieces of building equipment can control an indoor environment of the building. In some embodiments, the data can include unstructured data that may conform to a plurality of different predetermined formats and/or the data may include unstructured not conforming to a predetermined format. The data can also include one or more of a building information model (BIM) of the building, a building specification for the building, specifications of building materials of the building. For example, the data can include building metrics and/or floor layouts that can be used to provide an overall layout of the building.

In some embodiments, the models 4716 can extract, from the data received in step 5405, correlations between the sustainability performances of the building and the plurality of pieces of building equipment. For example, the models 4716 can perform and/or execute steps similar to the ECM manager 305 to determine impacts of the plurality of pieces of building equipment on the sustainability performance of the building. For example, the models 4716 can determine a percent contribution for one or more of the plurality of pieces of building equipment. The models 4716 can identify, using the percent contributions, one or more pieces of building equipment having one or more attributes that, if adjusted, may provide an improvement to the sustainability performance of the building. For example, the models 4716 can identify attributes for the pieces of building equipment that, if adjusted, may result in a carbon emissions reduction.

At step 5410, a plurality of recommendations for improving a sustainability performance of the building can be generated. For example, the plurality of recommendations generated in step 5410 can improve the sustainability performance of the building indicated by the data received in step 5405. In some embodiments, the plurality of recommendations can be generated using an AI model. For example, the models 4716 can generate the plurality of recommendations. The recommendations can include new recommendations that were not preexisting prior to the generation of the recommendations by the AI model in step 5410. For example, the AI model did not just retrieve the recommendations from a database but rather the AI model generated the recommendations by identify correlations between the pieces of building equipment and the sustainability performance of the building. In some implementations, the AI model can autonomously generate at least a portion of the recommendations without manual user intervention. For example, the models 4716 can receive the data in step 5405 and the models 4716 can then automatically generate recommendations without a request from a user. In some embodiments, the AI model can generate the plurality of recommendations from the unstructured data that may have been included in the data received in step 5405.

In some embodiments, generating the plurality of recommendation can include determining a plurality of improvements to the sustainability performance of the building. The plurality of improvements can be predicted by the AI model to be achievable for the building based on the data. For example, the AI model can predict that a 2% improvement in the sustainability performance of the building can be achieved by adjusting a setpoint for a piece of building equipment.

At step 5415, an indication to accept a recommendation can be received. The indication can be to accept a first recommendation of the plurality of recommendations generated in step 5410. For example, a user may be interacting with and/or otherwise interfacing with the AI model (e.g., the user is engaging with the ECM Manager application 4720). The recommendations can be provided, via the ECM Manager application 4720, to the user. For example, the recommendations can be displayed on a user interface. The user can select, via the user interface, the first recommendation of the plurality of recommendation. The user selecting the first recommendation may result in the AI model receiving the indication to accept the first recommendation of the plurality of recommendations.

At step 5420, one or more actions associated with the recommendation can be implemented. The one or more actions can be associated with the recommendation pertaining to the indication received in step 5415. The one or more actions may include FIMs and/or ECMs pertaining to given pieces of building equipment. The implementation of the one or more actions may include the AI model automatically scheduling a technician to address a repetitive fault that the AI model detected. The implementation of the one or more actions may include the AI model ordering and/or scheduling an appointment to have a piece of equipment replaced with a subsequent piece of equipment. The implementation of the one or more actions may include the AI model modifying, adjusting, and/or otherwise changing setpoints for the pieces of building equipment.

In some embodiments, the AI model described herein can include a generative large language model (LLM). For example, the AI model can provide responses that are text based responses that provide useful and relevant information. In some embodiments, the AI model can include a generative pretrained transformer (GPT) model. For example, the AI model can be trained to covert an input sequence (e.g., a prompt provided by the user via the ECM Manager Application 4720) into a modified input sequence. To continue this example, the AI model may receive a prompt including the sequence “I want to reduce” and the AI model can generate probability scores for what the rest of the prompt may include (e.g., 95% that the prompt will be “I want to reduce carbon emissions”).

In some embodiments, the AI model can generate a natural language summary of the plurality of recommendations. The natural language summary may be for presentation to a user. For example, the natural language summary can be provided to the user via the ECM Manager application 4720. In some embodiments, the generative LLM can dynamically generate the natural language summary without requiring manual intervention. For example, the AI model and/or the generative LLM can generate the natural language summary in conjunction with and/or along with generating the plurality of recommendations for the building without receiving information from the user regarding the natural language summary.

In some embodiments, the generative LLM can dynamically generate the natural language summary based on one or more of an identify of the user, a role of the user, the building equipment, the recommendations, or other data and/or characteristics pertaining to the building and/or the building equipment. For example, the AI model can determine that the user, based on credential provided during the initialization of a session with the ECM Manager application 4720, is the building manager. In this example, the AI Model may generate the natural language summary to include information that identifies actual numbers associated with the improvement in the sustainability performance of the building. For example, the natural language summary may identify for the recommendations a carbon reduction that is associated with each recommendation. The inclusion of the carbon reductions for the recommendation may allow the building manager to understand, fairly easily, which recommendation may have the largest impact.

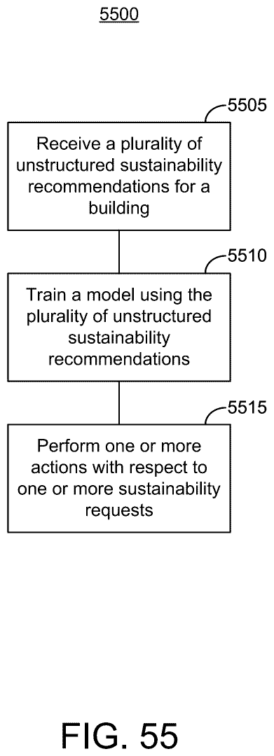

FIG. 55 depicts an example of a process 5500. The process 5500 can be performed using various devices and systems described herein, including by not limited to the system 4700, the system 4800, and/or one or more components thereof. Various aspects of the process 5500 can be implemented using one or more devices or systems that are communicatively coupled with one another, including client-server, cloud-based, or other network architectures. Additionally, at least one step of the process 5500 can be performed and/or executed to generate and/or otherwise train a ML model to perform functionality similar to the ECM manager 305. For example, the process 5500 can be used to generate ML models and the ML models may then perform one or more steps of the process 5400.

At step 5505, a plurality of unstructured sustainability recommendations for a building can be received. The plurality of unstructured sustainability recommendation can be training data. For example, the plurality of unstructured sustainability recommendations can be provided as training data to a model (e.g., the training data is inputted into the model). For example, the plurality of unstructured sustainability recommendations can be inputted into the model 4704. The plurality of unstructured sustainability recommendations can include data similar to the multiple types of data described herein. The plurality of unstructured sustainability recommendations can be received from at least one of the data sources described herein. For example, the plurality of unstructured sustainability reports can be received from the sustainability data sources 4712. The unstructured sustainability reports can include and/or be received with at least one of one or more BIMs, one or more actions that have been taken to improve the sustainability of buildings corresponding to the one or more BIMs, the impacts associated with the one or more actions, among other possible combinations of training data. The unstructured sustainability recommendations can also include the ECM savings categories described herein.

The plurality of unstructured sustainability recommendations can correspond to a plurality of sustainability requests for improving a sustainability performance of a building. For example, the unstructured sustainability recommendations can include actions (e.g., FIMs, ECMs, energy conservation protocols, etc.) that were generated based on the plurality of sustainability requests. The unstructured sustainability recommendations can include indications of the determined impacts in improving the sustainability performance of the building. For example, an unstructured sustainability recommendation may be replacing an AHU and the sustainability recommendation may also include the impact that replacing the AHU had on the carbon emissions of the building. The unstructured sustainability recommendations may confirm to a plurality of different predetermined formats. The predetermined formats of the unstructured sustainability recommendations may include at least one of the multiple data formats described herein. The unstructured sustainability recommendation may also include unstructured data that does not conform to a predetermined format. For example, the unstructured data may include handwritten notes that include a list of FIMs and a predicted impact associated with the list of FIMs.

At step 5510, a model can be trained using the plurality of unstructured sustainability recommendations. For example, the plurality of unstructured sustainability recommendations received in step 5505 can be provided to and/or otherwise input into the model. The model can be and/or include at least one of the models described herein. For example, the model can be the model 4704. The model updater 4708 can provide the training data (e.g., the plurality of unstructured sustainability recommendations and/or other types of data described herein) to the model 4704. The model updater 4708 can train the model using at least one of the techniques described herein. For example, the model updater 4708 can provide sustainability data included with the unstructured sustainability recommendations received in step 5505 to cause the model to generate an output (e.g., a recommendation to improve the sustainability of a building). The model can also be a generative AI model and the generative AI model can be trained using the plurality of first unstructured sustainability improvement recommendations.

At step 5515, one or more actions with respect to one or more sustainability requests can be performed. The actions can be performed with respect to one or more sustainability requests that are subsequent to training the model in step 5510. For example, the actions can be performed responsive to a sustainability request being provided to the model after the model has been trained. The sustainability request can be provided via the ECM Manager application 4720. The sustainability request can include a prompt from the user indicating that the user would like to see actions that can be taken to improve the sustainability of a building. For example, the prompt may include the user indicating that they would like to decrease the carbon emissions for a building that they manage. The model can generate, responsive to receiving the sustainability request, a plurality of recommendations. The plurality of recommendations can include one or more actions (e.g., FIMs, ECMs, etc.) and at least one action included in the plurality of recommendation can be performed responsive to the model receiving the sustainability request. For example, a setpoint to piece of building equipment may be automatically adjusted and/or calculated responsive to the model receiving the sustainability request.

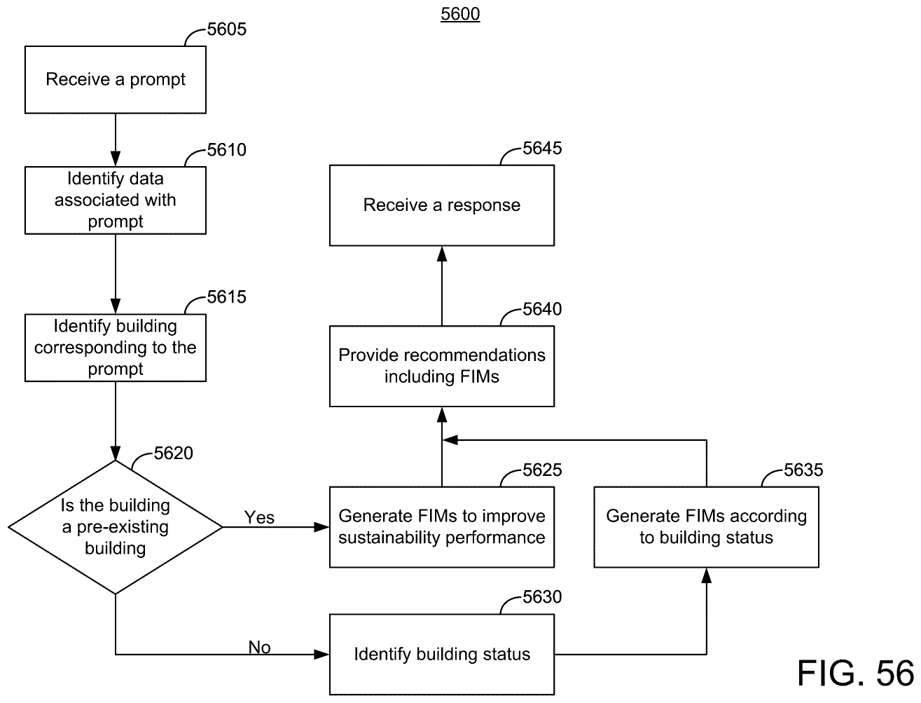

FIG. 56 depicts a flow chart of a process 5600 for generating sustainability improvements for a building. At least one step of the process 5600 can be performed by and/or executed using at least one of the models described herein. For example, the model 4704 can perform at least one step of the process 5600. In some embodiments, the model 4704 can be trained using data to configure the model 4704 to perform functionality similar to that of the ECM manager 305. In some embodiments, at least one step of the process 5600 can be performed by at least one of the systems described herein. For example, at least one step can be performed by the system 4700 and/or a component thereof.

At step 5605, a prompt can be received. For example, the prompt can be received from a user that is interacting with and/or otherwise interfacing with the ECM Manager application 4720. The prompt can be received by the system 4700. The prompt can be provided to the model 4704. The prompt may include a request for sustainability improvements that can be implemented. The prompt may also include a request to generate a sustainability goal that can reasonable be achieved in a given amount of time. For example, the prompt may be “what is a reasonable carbon reduction goal to reach in 5 years?” and the system 4700 can provide the prompt to the model 4704. In some embodiments, the system 4700 may generate one or more follow up questions to provide as responses. For example, the system 4700 may ask the user for information pertaining to the building (e.g., how much square footage, how may floors, when was the building built, etc.). The user may then provide additional information responsive to the system 4700 providing the responses.

At step 5610, data associated with the prompt can be identified. The data associated with the prompt can include at least one of additional information included in the prompt, a context of the prompt, a format of the prompt, and/or data that can be used to generate a response to the prompt. For example, the system 4700 can identify a prompt type (e.g., requests for sustainability improvements, requests for sustainability goals, requests for sustainability evaluations, etc.). The system 4700 can use the prompt type to determine what information can be included in the responses.

At step 5615, a building corresponding to the prompt can be identified. For example, the system 4700 can determine that the prompt corresponds to the building 10. The system 4700 can retrieve, access, and/or otherwise obtain data associated with the building 10. For example, the system 4700 can ask the user to input and/or provide the data associated with the building. The system 4700 may also be able to retrieve the information from at least one of the data sources described herein. For example, the system 4700 may be to retrieve utility data from the data sources 310.

At step 5620, a determination can be made as to if the building is a pre-existing building. For example, the system 4700 can use the information retrieved in step 5615 to determine that the building 10 includes operational data and the operational data can indicate that the building is pre-existing (e.g., the building was previous built and/or the building is operational). In some embodiments, the system 4700 can provide a response to the user asking them to provide a status of the building (e.g., the building is pre-existing, the building is undergoing construction, and/or the building is a planned building scheduled for construction). The process 5600 can move to step 5625 responsive to a determination that the building is a pre-existing building. The process 5600 can move to step 5630 responsive to a determination that the building is not a pre-existing building.

At step 5625, one or more FIMs can be generated to improve the sustainability performance of the building. In some embodiments, the FIMs can be generated by an AI model. For example, the model 4704 can generate the FIMs. In some embodiments, the model 4704 can generate the FIMs by performing functionality similar to the ECM Manager 305. In some embodiments, the model 4704 can generate the FIMs by identifying correlations between the building data (e.g., operational data, weather data, service records, occupancy metrics, and/or among other possible types of data described herein) and previous sustainability performances for one or more additional building. The FIMS can include replacing currently installed pieces of the equipment. The FIMs can also include adjusting operational parameters and/or setpoints for currently installed pieces of equipment. In some embodiments, the process 5600 can move to step 5640 responsive to the generation of the FIMs.

At step 5630, a building status can be identified. The building status can be at least one of a planned building, a pre-construction building, a building undergoing construction, and/or among other possible combinations. The system 4700 can identify the building status. For example, the system 4700 can determine that the building is a planned building. The system 4700 can identify the building status based on information that can be provided by the user. The system 4700 can also identify the building status via online resources (e.g., news, publications, magazine articles, blog posts, social media, websites, etc.).

At step 5635, FIMs can be generated according to building status. The FIMs can be generated based on the building status that was determined in step 5630. For example, the FIMs can be generated responsive to determining that the building is a planned building. The FIMs can also be generated responsive to determining that the building is under construction.

In some embodiments, the FIMS generated according to the building being a planned building can include actions, recommendations, and/or improvements that can be made to the building plans. For example, a FIM can be to install AHU's that are different from the AHU's currently scheduled to be installed. The FIMs can also include adjusting a height of a given floor to improve the natural air flow of the building which may result in a decrease in building equipment runtime, installing higher insulated windows, relative to the windows set to be installed, on a portion of the building that receives the highest amount of sunlight, and/or among other FIMs described herein. In some embodiments, the FIMs generated according to the building being under construction can include actions, recommendations, and/or improvements that can be made to aspects of the building still under construction. For example, if the building is going to include six floors and floors 1-4 are completed the FIMs generated can pertain to floors five and six.

In some embodiments, the FIMs can include one or more parts recommendations that are generated based on simulations performed by at least one of the models described herein. For example, the parts recommendations can be based on simulations performed by a GAI model. The parts recommendations can include replacing, supplementing, and/or retrofitting building equipment that was determined to have the greatest impact in improving the sustainability of the building.

In some embodiments, the FIMs can include one or more service recommendations that are generated based on simulations performed by at least one of the models described herein. For example, the service recommendations can be based on simulations performed by the GAI model. The service recommendations can include maintenance schedules, fault preventions, service requests, maintenance improvements for pieces of building equipment that were indicated to be impacted the sustainability performance of the building.

In some embodiments, the FIMs can be based on recommendations from the GAI model responsive to the model receiving operational characteristics for a pre-existing building and/or planned occupant characteristics for a planned building and/or a building under construction. For example, the FIMs can include recommendations generated by the GAI model to improve the operational characteristics of the pre-existing building by adjusting at least one occupancy metric associated with the operational characteristics.

At step 5640, recommendations including the FIMs can be provided. For example, the recommendations can include the FIMs generated in at least one of the step 5625 and/or the step 5635. The recommendations can be provided to the user associated with the prompt received in step 5605. For example, the recommendations that can be provided via the ECM Manager application 4720.

At step 5645, a response can be received. The response can be received responsive to the user selected at least one recommendation included in the recommendations provided in the step 5640. For example, the recommendations may be provided to the user, via a user interface, and the user may select an icon, on the user interface, associated with a given recommendation, to indicate that user accepts the given recommendation. In some embodiments, the receipt of the response in step 5645 can result in implementation of one or more actions (e.g., FIMs, ECMs, etc.) being implemented automatically by the system 4700.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method, comprising:
receiving, by one or more processors, data relating to a sustainability performance of a building, the building comprising a plurality of pieces of building equipment configured to control an indoor environment of the building;
generating, by the one or more processors, a plurality of recommendations for improving the sustainability performance of the building using an AI model, the plurality of recommendations comprising new recommendations not preexisting prior to generation of the plurality of recommendations by the AI model, and the AI model configured to autonomously generate at least a portion of the plurality of recommendations without manual user intervention;
receiving, by the one or more processors, an indication to accept a first recommendation of the plurality of recommendations; and
implementing, responsive to receiving the indication to accept the first recommendation of the plurality of recommendations, by the one or more processors, one or more actions associated with the first recommendation of the plurality of recommendations.

2. The method of claim 1, wherein the AI model comprises a generative large language model (LLM).

3. The method of claim 2, wherein the generative LLM comprises a generative pretrained transformer model.

4. The method of claim 2, wherein the data comprises unstructured data conforming to a plurality of different predetermined formats and/or not conforming to a predetermined format, and wherein the generative LLM is configured to generate the plurality of recommendations from the unstructured data.

5. The method of claim 2, comprising:
generating, by the one or more processors, a natural language summary of the plurality of recommendations for presentation to a user, and wherein the generative LLM is configured to dynamically generate the natural language summary without requiring manual user intervention.

6. The method of claim 5, wherein the generative LLM is configured to dynamically generate the natural language summary based on one or more of an identity of the user, a role of the user, the plurality of pieces of building equipment, the plurality of recommendations, or other data and/or characteristics pertaining to the building and/or the plurality of pieces of building equipment.

7. The method of claim 2, wherein the data comprises one or more of a building information model (BIM) of the building, a building specification for the building, or specifications of building materials of the building.

8. The method of claim 2, wherein generating the plurality of recommendations comprises:
determining, by the one or more processors using the generative LLM, a plurality of improvements to the sustainability performance of the building that are predicted by the generative LLM to be achievable for the building based on the data.

9. The method of claim 2, wherein the building includes a planned building, wherein at least one recommendation of the plurality of recommendations provides an adjustment to a construction plan for the planned building, and wherein implementation of the adjustment to the construction plan for the planned building results in a sustainability improvement for the planned building.

10. The method of claim 2, wherein at least a portion of the building is under construction, wherein at least one recommendation of the plurality of recommendations provides an adjustment to the at least a portion of the building, and wherein implementation of the adjustment results in a sustainability improvement for the at least a portion of the building.

11. The method of claim 2, wherein the building includes operational data, wherein at least one recommendation of the plurality of recommendations provides an adjustment to at least one operation of the building included in the operational data, and wherein implementation of the adjustment results in a sustainability improvement for the at least one operation of the building.

12. The method of claim 2, comprising:
receiving, by the one or more processors, a plurality of first unstructured sustainability improvement recommendations corresponding to a plurality of first sustainability requests for improving sustainability performances of one or more buildings, the unstructured sustainability improvement recommendations conforming to a plurality of different predetermined formats and/or comprising unstructured data not conforming to a predetermined format; and
training, by the one or more processors, the generative LLM using the plurality of first unstructured sustainability improvement recommendations.

13. One or more computer-readable storage media having instructions stored thereon that, when executed by one or more processors, cause the one or more processors to perform operations comprising:
receiving a plurality of first unstructured sustainability improvement recommendations corresponding to a plurality of first sustainability requests for improving a sustainability performance of one or more buildings, the unstructured sustainability improvement recommendations conforming to a plurality of different predetermined formats and/or comprising unstructured data not conforming to a predetermined format;
training a generative AI model using the plurality of first unstructured sustainability improvement recommendations; and
performing, using the generative AI model, one or more actions with respect to one or more sustainability requests subsequent to training the generative AI model.

14. The one or more computer-readable storage media of claim 13, wherein the operations further comprise:
receiving data relating to a sustainability request for a building, the building comprising a plurality of pieces of building equipment configured to control an indoor environment of the building;
generating, using the generative AI model, a plurality of recommendations corresponding to the sustainability request, the plurality of recommendations comprising new recommendations not preexisting prior to generation of the plurality of recommendations by the generative AI model, and the generative AI model configured to autonomously generate at least a portion of the plurality of recommendations without manual user intervention;
receiving an indication to accept a first recommendation of the plurality of recommendations; and
implementing, responsive to receiving the indication to accept the first recommendation of the plurality of recommendations, one or more actions associated with the first recommendation of the plurality of recommendations.

15. The one or more computer-readable storage media of claim 14, wherein the operations further comprise:
detecting, responsive to implementing the one or more actions associated with the first recommendation, a change to a carbon emission level of the building; and
retraining the generative AI model based on the change to the carbon emission level of the building.

16. The one or more computer-readable storage media of claim 13, wherein the operations further comprise:
generating a natural language summary of the plurality of recommendations for presentation to a user, and wherein the generative AI model is configured to dynamically generate the natural language summary without requiring manual user intervention.

17. The one or more computer-readable storage media of claim 16, wherein the generative AI model is configured to dynamically generate the natural language summary based on one or more of an identity of the user, a role of the user, a plurality of pieces of building equipment, the plurality of recommendations, or other data and/or characteristics pertaining to a building and/or the plurality of pieces of building equipment.

18. A system comprising one or more memory devices storing instructions thereon that, when executed by one or more processors, cause the one or more processors to:
receive data relating to a sustainability performance of a building, the building comprising a plurality of pieces of building equipment configured to control an indoor environment of the building;
generate a plurality of recommendations for improving the sustainability performance of the building using an AI model, the plurality of recommendations comprising new recommendations not preexisting prior to generation of the plurality of recommendations by the AI model, and the AI model configured to autonomously generate at least a portion of the plurality of recommendations without manual user intervention;
receive an indication to accept a first recommendation of the plurality of recommendations; and
implement, responsive to receiving the indication to accept the first recommendation of the plurality of recommendations, one or more actions associated with the first recommendation of the plurality of recommendations.

19. The system of claim 18, wherein the AI model comprises a generative large language model (LLM), and wherein the generative LLM comprises a generative pretrained transformer model.

20. The system of claim 19, wherein the instructions cause the one or more processors to:
generate a natural language summary of the plurality of recommendations for presentation to a user;
wherein the generative LLM is configured to dynamically generate the natural language summary without requiring manual user intervention; and
wherein the generative LLM is configured to dynamically generate the natural language summary based on one or more of an identity of the user, a role of the user, the plurality of pieces of building equipment, the plurality of recommendations, or other data and/or characteristics pertaining to the building and/or the plurality of pieces of building equipment.
